(19) United States
(12) Patent Application Publication
(10) Pub. No.: US 2019/0035364 A1
(43) Pub. Date: Jan. 31, 2019

(54) DISPLAY APPARATUS, METHOD OF DRIVING DISPLAY APPARATUS, AND ELECTRONIC APPARATUS

(71) Applicant: SONY CORPORATION, TOKYO (JP)

(72) Inventor: MASANORI IWASAKI, KANAGAWA (JP)

(21) Appl. No.: 16/077,139

(22) PCT Filed: Jan. 19, 2017
(86) PCT No.: PCT/JP2017/001704

§ 371 Date: Aug. 10, 2018

(30) Foreign Application Priority Data
Feb. 26, 2016 (JP) 2016-035266

(51) Int. Cl. G09G 5/373; G02B 27/00; G02F 1/1335; G02F 1/157; G02B 27/22; G02F 1/163; G02F 1/137; G09G 3/36

(52) U.S. Cl. CPC G09G 5/373; G02B 27/0093; G02F 1/133504; G02F 1/157; G09G 2354/00; G02F 1/163; G02F 1/137; G09G 3/36; G09G 2340/04; G02B 27/2228

(57) ABSTRACT

A display apparatus according to the present disclosure includes: a display unit in which apertures are arranged in units of a plurality of adjacent pixels including a left-eye pixel and a right-eye pixel; a signal processing unit that generates image information items with respect to the left-eye pixel and the right-eye pixel, respectively, such that an image is presented with an aspect ratio different from an aspect ratio of a display surface of the display unit; and a display control unit that drives the left-eye pixel and the right-eye pixel on the basis of the image information items generated by the signal processing unit.

### TECHNICAL FIELD

The present disclosure relates to a display apparatus, a method of driving the display apparatus, and an electronic apparatus.

### BACKGROUND ART

There may be a case where it is desired to change a size of a display image on, for example, a display apparatus installed in a mobile electronic apparatus so as to easily view the display image. As an example of technologies for changing the size of the display image, there is a technology described in Patent Document 1.

According to the technology described in Patent Literature 1, an information communication terminal contains, within its casing, a part of a flexible display that has substantially rectangular sheet-like shape and is bendable and flexible. According to this technology, a size of a display surface is changed when necessary by exposing the part contained within the casing to the outside of the casing.

### CITATION LIST

### Patent Literature

Patent Literature 1: Japanese Patent Application Laid-open No. 2010-178188

### DISCLOSURE OF INVENTION

### Technical Problem

In a configuration employed in this related art described in Patent Document 1, a display unit is formed of the flexible display, and the size of the display unit (display screen) itself is mechanically changed. Thus, a mechanism for changing the size of the display surface is needed, resulting in structural complications.

In view of such circumstances, the present technology has been made to achieve an object to provide a display apparatus capable of changing a size of a display image without mechanically changing a display surface itself, a method of driving the display apparatus, and an electronic apparatus including the display apparatus.

### Solution to Problem

In order to achieve this object, according to the present disclosure, there is provided a display apparatus including:

a display unit in which apertures are arranged in units of a plurality of adjacent pixels including a left-eye pixel and a right-eye pixel;

a signal processing unit that generates image information items with respect to the left-eye pixel and the right-eye pixel, respectively, such that an image is presented with an aspect ratio different from an aspect ratio of a display surface of the display unit; and

a display control unit that drives the left-eye pixel and the right-eye pixel on a basis of the image information items generated by the signal processing unit. Further, in order to achieve the above-mentioned object, according to the present disclosure, there is provided an electronic apparatus including the display apparatus having the above-described configuration.

In order to achieve the above-described object, according to the present disclosure, there is provided a method of driving a display apparatus, the display apparatus including a display unit in which apertures are arranged in units of a plurality of adjacent pixels including a left-eye pixel and a right-eye pixel, the method including:

generating image information items with respect to the left-eye pixel and the right-eye pixel, respectively, such that an image is presented with an aspect ratio different from an aspect ratio of a display surface of the display unit; and

driving the left-eye pixel and the right-eye pixel on a basis of the generated image information items.

In the display apparatus having the above-described configuration, the method of driving the same, and the electronic apparatus, the left-eye pixel displays a left-eye image, and the right-eye pixel display a right-eye image. Under this display state, the apertures arranged in the units of the plurality of adjacent pixels limit traveling directions of light beams emitted from the pixels so as to control a light beam that enters a left eye of the observer and a light beam that enters a right eye of the observer. With this, it is possible to separate an image that is visible only to the left eye, and an image that is visible only to the right eye from each other. In this way, when the observer views the display unit under a state in which a line of sight of the left eye and a line of sight of the right eye are parallel to each other, the observer can recognize, in his/her brain, the left-eye image and the right-eye image as two adjacent images, that is, as a display image larger than the display surface of the display unit (display image with the aspect ratio different from the aspect ratio of the display surface of the display unit).

### Advantageous Effects of Invention

According to the present disclosure, it is possible to change the size of the display image with a configuration simpler than the configuration in the case where the size of the display surface itself is mechanically changed. Note that, the advantages disclosed herein are not necessarily limited to those described hereinabove, and all of the advantages disclosed herein can be obtained. Further, the advantages disclosed herein are merely examples and not limited thereto, and other advantages may be additionally obtained.

### BRIEF DESCRIPTION OF DRAWINGS

FIG. 1 is a block diagram showing an example of a system configuration of a display apparatus according to a first embodiment of the present disclosure.

FIG. 2A and FIG. 2B are explanatory views each illustrating a calculation example of positional information and orientation information of left and right eyes of an observer with respect to the display unit.

FIG. 3A includes views illustrating a configuration of a main part of a display unit according to Example 1 in the display apparatus according to the first embodiment. FIG. 3B is a view illustrating specific examples of a pixel configuration with respect to one aperture.

FIG. 4 is a schematic view illustrating image recognition in a case where a stereoscopic image is displayed.

FIG. 5 is a schematic view illustrating image recognition with the display apparatus according to the first embodiment.

FIG. 6A is a cross-sectional view of a display unit according to Example 2. FIG. 6B is a cross-sectional view of a display unit according to Example 3.

FIG. 7A is a cross-sectional view of a display unit according to Example 4. FIG. 7B is a cross-sectional view of a display unit according to Example 5.

FIG. 8A, FIG. 8B, and FIG. 8C are process views illustrating a procedure of a method of forming separators according to Example 6.

FIG. 9 is a block diagram showing an example of a system configuration of a display apparatus according to Example 7.

FIG. 10A is a cross-sectional view of a display unit according to Example 8. FIG. 10B is a cross-sectional view of a display unit according to Example 9.

FIG. 11A and FIG. 11B are explanatory views illustrating display pixels with respect to the left and right eyes of the observer. FIG. 11A illustrates a pixel array of left-eye pixels and right-eye pixels of the display unit. FIG. 11B illustrates pixel arrays of a left-eye screen and a right-eye screen.

FIG. 12A and FIG. 12B are a table and an explanatory view showing resolution limits of human eyes with respect to a gap corresponding to one pixel between pixel columns of the left-eye screen and the right-eye screen, and pixel dimensions. FIG. 12A shows an example of numerical values of a viewing distance from the observer to the display unit, an eyesight, and the pixel dimension. FIG. 12B illustrates relationships between the resolution (resolution limit) of the human eyes and the pixel dimension.

FIG. 13 is a block diagram showing an example of a system configuration of a display apparatus according to a second embodiment of the present disclosure.

FIG. 14 includes views illustrating a configuration of a main part of a display unit in the display apparatus according to the second embodiment.

FIG. 15A and FIG. 15B are flowcharts showing flows of operations of the display apparatus according to the second embodiment of the present disclosure. FIG. 15A shows a flow of operations in a case where virtual image lenses are each formed of a fixed focus lens. FIG. 15B shows a flow of operations in a case where the virtual image lenses are each formed of a variable focus lens.

FIG. 16 is an explanatory view illustrating a virtual image presented by a display apparatus according to Embodiment A of the second embodiment.

FIG. 17 is an explanatory view illustrating a virtual image presented by a display apparatus according to Example 10.

FIG. 18 is an explanatory view illustrating a case where the viewing distance with respect to the display apparatus according to Example 10 is changed.

FIG. 19 is an explanatory view illustrating a virtual image presented by a display apparatus according to Example 11.

FIG. 20A and FIG. 20B are explanatory views each illustrating a case where a virtual image distance or a viewing distance with respect to a display apparatus according to a modification example of Example 10 is changed. FIG. 20A illustrates a case of changing the virtual image distance. FIG. 20B illustrates a case where the viewing distance is 40 [cm].

FIG. 21 is an explanatory view illustrating a virtual image presented by a display apparatus according to Example 12.

FIG. 22 is an explanatory view illustrating a virtual image presented by a display apparatus according to Example 13.

FIG. 23A and FIG. 23B are explanatory views each illustrating a virtual image presented by a display apparatus according to Example 14. FIG. 23A illustrates a case where the viewing distance is 20 [cm]. FIG. 23B illustrates a case where the viewing distance is 10 [cm].

FIG. 24A and FIG. 24B are explanatory views each illustrating a virtual image presented by a display apparatus according to Example 15. FIG. 24A illustrates a case where the viewing distance is 20 [cm]. FIG. 24B illustrates a case where the viewing distance is 10 [cm].

FIG. 25A and FIG. 25B are explanatory views each illustrating an image display range in a case where the virtual image size is fixed regardless of the viewing distance in Example 15. FIG. 25A illustrates a case where the viewing distance is 20 [cm]. FIG. 25B illustrates a case where the viewing distance is 10 [cm].

FIG. 26A and FIG. 26B are explanatory views each illustrating a virtual image presented by a display apparatus according to Example 16. FIG. 26A illustrates a case where the viewing distance is 20 [cm]. FIG. 26B illustrates a case where the viewing distance is 10 [cm].

FIG. 27A and FIG. 27B are explanatory views each illustrating a virtual image presented by a display apparatus according to Example 17. FIG. 27A illustrates a case where the viewing distance is 20 [cm]. FIG. 27B illustrates a case where the viewing distance is 10 [cm].

FIG. 28A and FIG. 28B are explanatory views each illustrating an image display range in a case where the virtual image size is fixed regardless of the viewing distance in Example 17. FIG. 28A illustrates a case where the viewing distance is 20 [cm]. FIG. 28B illustrates a case where the viewing distance is 10 [cm].

FIG. 29A, FIG. 29B, and FIG. 29C are explanatory views each illustrating a virtual image presented by a display apparatus according to Example 18. FIG. 29A illustrates a case where the viewing distance is 20 [cm]. FIG. 29B illustrates a case where the viewing distance is 16 [cm]. FIG. 29C illustrates a case where the viewing distance is 24 [cm].

FIG. 30A, FIG. 30B, and FIG. 30C are explanatory views each illustrating a virtual image presented by a display apparatus according to Example 19. FIG. 30A illustrates a case where the virtual image distance is 10 [cm]. FIG. 30B illustrates a case where the virtual image distance is 8 [cm]. FIG. 30C illustrates a case where the virtual image distance is 12 [cm].

FIG. 31 is an explanatory view illustrating a focus distance at the time of looking in a mirror.

FIG. 32 is an explanatory view illustrating a virtual image presented by a display apparatus according to Example 20.

FIG. 33 is a view illustrating a configuration of an optical system of a display apparatus according to Example 21.

FIG. 34A and FIG. 34B are views illustrating an example of a configuration of a display unit in the display apparatus according to Example 21. FIG. 34A illustrates a configuration of a display-element array unit. FIG. 34B illustrates a configuration of a lens array unit.

FIG. 35 is an explanatory view illustrating focusing on a retina.

FIG. 36 is a cross-sectional view illustrating a relationship between light beams emitted from display elements, and lenses.

FIG. 37 is an explanatory view illustrating a virtual-image optical system of the display apparatus according to Example 21.

FIG. 38 is an explanatory view illustrating an image configuration in the virtual-image optical system.

FIG. 39 is an explanatory view illustrating an aspect-ratio change amount Δ_{aspect} at the time when a virtual image is presented.

FIG. 40 is a graph showing an example of relationships between a viewing distance L_{D} and the aspect-ratio change amount Δ_{aspect} for each virtual image distance L_{V}.

### MODE(S) FOR CARRYING OUT THE INVENTION

Now, embodiments for carrying out the technology of the present disclosure (hereinafter, abbreviated as “embodiments”) are described in detail with reference to the drawings. The technology of the present disclosure is not limited to the embodiments, and various numerical values or the like of the embodiment are examples. In the following description, the same components or components having the same function are denoted by the same reference symbols, and redundant description thereof is omitted. Note that, the description is made in the following order.

### 1. General Description of Display Apparatus, Method of Driving Display Apparatus, and Electronic Apparatus According to Present Disclosure

### 2. First Embodiment [Example of Using Apertures Alone]

Example 1 (Basic Configuration of Display Unit)

Example 2 (Modification Example of Example 1/Example in Which Separators Are Provided in Pixel Units in Diffusion Layer)

Example 3 (Modification Example of Example 2/Example in Which Surfaces of Parts on Pixel Side of Diffusion Layer Are Larger than Surfaces of Parts on Aperture Side of The Same)

Example 4 (Modification Example of Example 3/Example in Which Transparent Pad Is Provided over Layer of Apertures)

Example 5 (Modification Example of Example 1/Example in Which Diffraction Grating is Provided between Pixels And Diffusion Layer)

Example 6 (Method of Forming Separators in Display Unit According to Example 1)

Example 7 (Modification Example of Display Apparatus According to First Embodiment)

Example 8 (Modification Example of Example 1 to Example 5/Example of Using Liquid-Crystal Layer)

Example 9 (Modification Example of Example 1 to Example 5/Example of Using Electrochromic Element)

### 3. Second Embodiment (Example of Using Apertures and Virtual Image Lenses Together)

3-1. Embodiment A [Example in Which Virtual-Image Presentation Position with Respect to Observer Is More Distant than Display Unit Is Distant]

Example 10 (Example of Display Apparatus on Wristwatch-Type Terminal)

Example 11 (Modification Example of Example 10)

Example 12 (Example of Display Apparatus on Mobile Terminal)

Example 13 (Example of Display Apparatus on Camera Apparatus)

Example 14 (Example in Which Virtual Image Lenses Are Formed of Fixed Focus Lenses)

Example 15 (Modification Example of Example 14)

Example 16 (Example in Which Virtual Image Lenses Are Formed of Variable Focus Lenses)

Example 17 (Modification Example of Example 16)

3-2. Embodiment B [Example in Which Virtual-Image Presentation Position with Respect to Observer Is on Side Nearer than Display Unit is Near]

Example 18 (Example in Which Virtual Image Lenses Are Formed of Fixed Focus Lenses)

Example 19 (Example in Which Virtual Image Lenses Are Formed of Variable Focus Lenses)

### 4. Third Embodiment [Example of Electronic Mirror]

Example 20 (Example of Using Virtual-Image Optical System According to Second Embodiment)

Example 21 (Example of Using Virtual-Image Optical System on Basis of Principle of Reconstruction of Parallax Rays)

### 5. Aspect Ratio of Virtual Image

### 6. Modification Example

<General Description of Display Apparatus, Method of Driving Display Apparatus, and Electronic Apparatus According to Present Disclosure>

In the display apparatus, the method of driving the display apparatus, and the electronic apparatus according to the present disclosure, a dimension of each of the apertures may be set equivalent to or smaller than a dimension of each of the pixels. Further, the display unit may include a spacer between the apertures and the pixels. Still further, the display unit may include a diffusion layer between the apertures and the pixels.

In the display apparatus, the method of driving the display apparatus, and the electronic apparatus according to the present disclosure, which have the above-described preferred configurations, the display unit may include separators provided in pixel units in the diffusion layer. It is preferred that the separators be made of a material that absorbs visible light. Further, it is preferred that an interface between the separators and the diffusion layer be formed of an interface that reflects visible light. The diffusion layer may be partitioned into separate parts by the separators, and surfaces on the pixel side of the separate parts of the diffusion layer may be larger than surfaces on the aperture side of the separate parts of the diffusion layer.

Further, in the display apparatus, the method of driving the display apparatus, and the electronic apparatus according to the present disclosure, which have the above-described preferred configurations, the display unit may include a transparent pad over a layer through which the apertures are provided. Further, the display unit may include a diffraction grating between the pixels and the diffusion layer. Alternatively, the display unit may include a liquid-crystal layer that adjusts an intensity of light to transmit through the apertures.

Still further, in the display apparatus, the method of driving the display apparatus, and the electronic apparatus according to the present disclosure, which have the above-described preferred configurations, the display unit may be capable of selectively forming the apertures with use of an element that is capable of controlling an intensity of light to transmit therethrough. With this, it is possible to present, when forming the apertures, an image with the aspect ratio different from the aspect ratio of the display surface of the display unit, and to present, when not forming the apertures, an image with an aspect ratio equal to the aspect ratio of the display surface of the display unit. As examples of the element capable of controlling the intensity of the light to transmit therethrough, there may be mentioned an electrochromic element and a liquid-crystal element.

Alternatively, in the display apparatus, the method of driving the display apparatus, and the electronic apparatus according to the present disclosure, which have the above-described preferred configurations, the display unit may include lenses arranged in the units of the plurality of adjacent pixels including the left-eye pixel and the right-eye pixel. In addition, the signal processing unit may generate image information items with respect to the left-eye pixel and the right-eye pixel, respectively, such that a virtual image is presented with the aspect ratio different from the aspect ratio of the display surface of the display unit.

Further, in the display apparatus, the method of driving the display apparatus, and the electronic apparatus according to the present disclosure, which have the above-described preferred configurations, there may be provided a detection unit that detects positional information and orientation information of eyes of an observer with respect to the display surface of the display unit. At this time, the signal processing unit may generate the image information items with respect to the left-eye pixel and the right-eye pixel, respectively, on the basis of a result of the detection by the detection unit.

Still further, in the display apparatus, the method of driving the display apparatus, and the electronic apparatus according to the present disclosure, which have the above-described preferred configurations, the detection unit may include an imaging unit that captures an observer. In addition, the signal processing unit may constitute the detection unit cooperatively with the imaging unit, and calculate the positional information and the orientation information of the eyes of the observer with respect to the display surface of the display unit on the basis of an image of the observer captured by the imaging unit.

Yet further, in the display apparatus, the method of driving the display apparatus, and the electronic apparatus according to the present disclosure, which have the above-described preferred configurations, the detection unit may include a distance measurement unit that measures a distance between the display surface of the display unit and the eyes of the observer. At this time, the signal processing unit may use the distance measured by the distance measurement unit in the calculation of the positional information of the eyes of the observer with respect to the display surface of the display unit.

Yet further, in the display apparatus, the method of driving the display apparatus, and the electronic apparatus according to the present disclosure, which have the above-described preferred configurations, the lenses arranged in the units of the plurality of adjacent pixels may be fixed focus lenses or variable focus lenses. When the lenses arranged in the units of the plurality of adjacent pixels are the variable focus lenses, the display control unit may control focal lengths of the variable focus lenses.

### First Embodiment

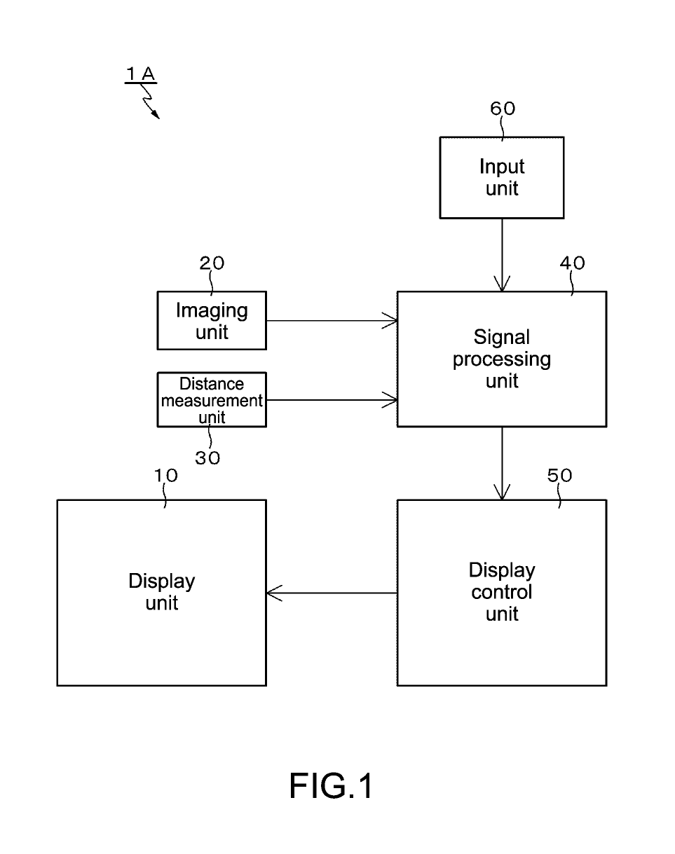

FIG. 1 is a block diagram showing an example of a system configuration of a display apparatus according to a first embodiment of the present disclosure. As shown in FIG. 1, a display apparatus 1A according to the first embodiment includes a display unit 10, an imaging unit 20, a distance measurement unit 30, a signal processing unit 40, a display control unit 50, and an input unit 60. Specific examples of the display unit 10 are described below.

The imaging unit 20 and the distance measurement unit 30 are attached integrally with the display unit 10, and constitute a part of a detection unit that detects positional information and orientation information of eyes of an observer with respect to a display surface of the display unit 10. The imaging unit 20 is constituted by a camera capable of capturing a face of the observer who observes a display image on the display unit 10, and supplies information of taken images to the signal processing unit 40.

The distance measurement unit 30 measures a distance between the display surface of the display unit 10 and the eyes of the observer, and outputs a result of the measurement as information of the distance from the display surface of the display unit 10 to the eyes of the observer. As the distance measurement unit 30, there may be used a unit configured to measure the distance between the display surface of the display unit 10 and the eyes of the observer by a time-of-flight (TOF) method of using, for example, infrared rays. Alternatively, there may be used a unit having a configuration in which another camera is provided in addition to the camera constituting the imaging unit 20 so as to measure the distance between the display surface of the display unit 10 and the eyes of the observer by a triangulation method of using the images taken by the two cameras.

The signal processing unit 40 receives the information of the image taken by the imaging unit 20, and the information of the distance measured by the distance measurement unit 30. Then, on the basis of the information of the image taken by the imaging unit 20 and the information of the distance measured by the distance measurement unit 30, the signal processing unit 40 detects the positional information and the orientation information of the eyes of the observer with respect to the display surface of the display unit 10. The positional information of the eyes of the observer include the distance between the display surface of the display unit 10 and the eyes of the observer, and a distance between a left eye and a right eye (interocular). The orientation information of the eyes of the observer includes inclination of the eyes with respect to the display unit 10, that is, inclination of a line connecting the left eye and the right eye with respect to the display unit 10.

The signal processing unit 40 performs face detection on the observer on the basis of the image information supplied from the imaging unit 20, and then specifies positions of the left eye and the right eye (hereinafter, also referred to as “left and right eyes”) on the basis of the face detection, thereby obtaining coordinate information of the left and right eyes (left-eye position (XL, YL), right-eye position (XR, YR)) in the image. After obtaining the coordinate information of the left and right eyes, the signal processing unit 40 determines a positional relationship of the left and right eyes of the observer with respect to the display unit 10 by using the coordinate information of the left and right eyes and the distance information supplied from the distance measurement unit 30.

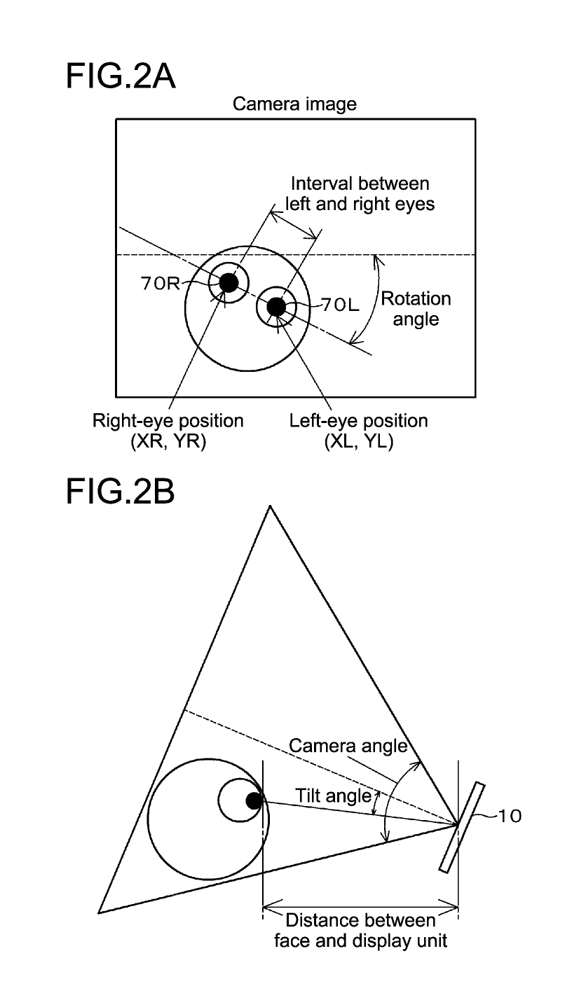

For example, in a plane orthogonal to an axis connecting the display unit 10 and the face of the observer to each other, a relative positional relationship between the display unit 10 and the face of the observer is assumed to be inclined with respect to the axis. In this case, as illustrated in FIG. 2A, it is possible to obtain, as the orientation information of the eyes of the observer with respect to the display surface of the display unit 10, the inclination (positional relationship) of the left and right eyes 70L and 70R of the observer on the basis of a rotation angle (rotation amount) of the image (camera image). Further, it is possible to obtain, as the positional information of the eyes of the observer with respect to the display surface of the display unit 10, the distance between the left and right eyes 70L and 70R of the observer on the basis of the information of the distance measured by the distance measurement unit 30 and the distance between the left and right eyes 70L and 70R with respect to a whole image acquired by the imaging unit 20. The distance between the left and right eyes 70L and 70R with respect to the whole image can be calculated on the basis of, for example, the number of pixels and a pixel pitch of the camera.

Further, as illustrated in FIG. 2B, in a case where the relative positional relationship between the display unit 10 and the face of the observer is inclined in a front-back direction (tilt direction) with respect to the axis connecting the display unit 10 and the face of the observer to each other, it is possible to obtain the positional relationship between the left and right eyes 70L and 70R of the observer on the basis of the positional information of the left and right eyes 70L and 70R within the camera image acquired by the imaging unit 20.

Subsequently, it is possible to obtain spatial relative coordinates of the display unit 10 and the face of the observer on the basis of the positional information and the orientation information of the left and right eyes 70L and 70R within the camera image acquired by the imaging unit 20, and on the basis of the information of the distance (positional information) measured by the distance measurement unit 30.

The above-described functions of the signal processing unit 40, such as the detection of the face of the observer, the detection of the left and right eyes, the determination of the positional relationship between the left and right eyes constitute, cooperatively with the functions of the imaging unit 20 and the distance measurement unit 30, the detection unit that detects the positional information and the orientation information of the eyes of the observer with respect to the display surface of the display unit 10. Note that, even without using the distance measurement unit 30, it is possible to detect the distance between the display surface of the display unit 10 and the eyes of the observer on the basis of, for example, the distance between the left and right eyes, which is obtained from the image information from the imaging unit 20. In addition, it is possible to detect the distance between the display surface of the display unit 10 and the eyes of the observer on the basis of a lens angle and the distance between the left and right eyes of the observer. Thus, the distance measurement unit 30 is not an indispensable component. Note that, the distance between the left and right eyes differs from observer to observer, and hence it is difficult to detect the distance with high accuracy on the basis of the distance between the left and right eyes. For this reason, by using the distance measurement unit 30, it is possible to increase accuracy in the distance detection.

The signal processing unit 40 also performs calculation of image information items with respect respectively to a left-eye pixel 13L and a right-eye pixel 13R on the basis of the positional information and the orientation information of the eyes of the observer, and on the basis of the image information to be displayed such that a display image is presented with an aspect ratio different from an aspect ratio of the display surface of the display unit 10. Then, the signal processing unit 40 supplies the calculated information to the display control unit 50.

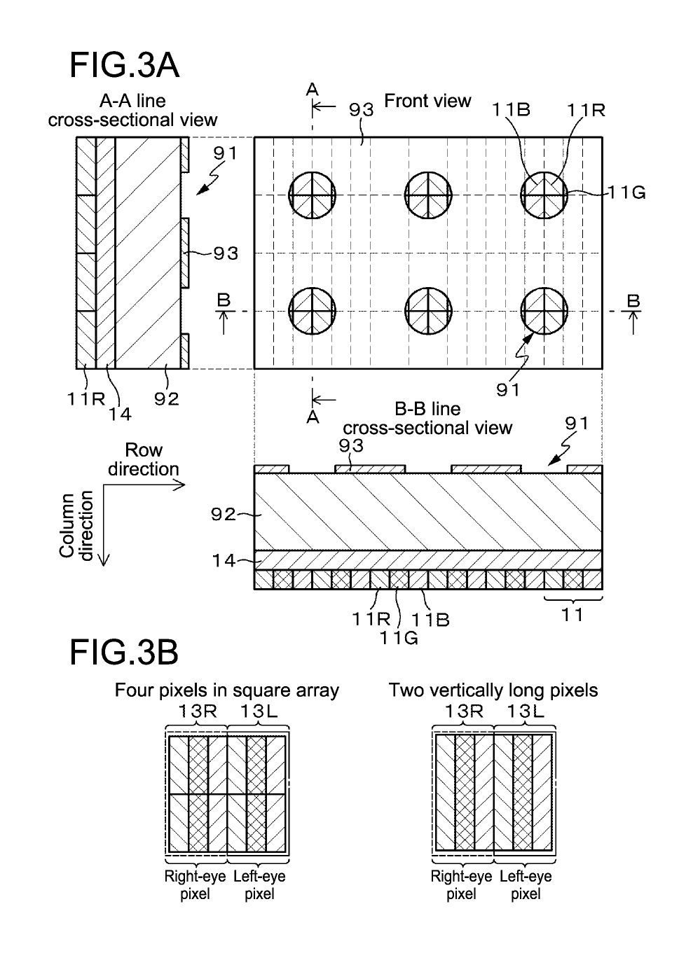

The display control unit 50 drives the left-eye pixel 13L and the right-eye pixel 13R to be described below (refer to FIG. 3B) of the display unit 10 on the basis of the image information items supplied from the signal processing unit 40. By being driven by this display control unit 50, the left-eye pixel 13L displays a left-eye image, and the right-eye pixel 13R displays a right-eye image. The signal processing unit 40 and the display control unit 50 may be provided as processing program modules on a computer, or parts or entireties of these units may be constituted by dedicated hardware. The input unit 60 receives various information to be input to the signal processing unit 40 through operations by the observer (user).

Now, the specific examples of the display unit 10 in the display apparatus 1A according to the first embodiment are described.

### Example 1

FIG. 3A illustrates a configuration of a main part of the display unit 10 according to Example 1 in the display apparatus 1A according to the first embodiment. The display unit 10 according to Example 1 is constituted by an organic EL display apparatus using, for example, organic electro luminescence (EL) elements as a light emitting portion. Note that, the display unit 10 is not limited to the organic EL display apparatus, and it is possible to use other flat surface type (flat panel type) display apparatuses such as a liquid-crystal display apparatus, and a field emission (FE) display apparatus.

On the display unit 10, a single pixel (pixel) 11 as a unit of forming a color image is formed, for example, of three sub-pixels. The single pixel 11 includes a plurality of pixels 11 arrayed in a two-dimensional matrix in a row direction and a column direction. For example, the single pixel 11 is formed of sub-pixels in three primary colors, that is, a sub-pixel 11R including an organic EL element that emits red (R) light, a sub-pixel 11G including an organic EL element that emits green (G) light, and a sub-pixel 11B including an organic EL element that emits blue (B) light.

Note that, formation of the single pixel 11 is not limited to a combination of the sub-pixels in the three primary colors of RGB, and it is possible to form a single pixel by adding another sub-pixel in another color or other sub-pixels in a plurality of colors to the sub-pixels in the three primary colors. More specifically, it is possible, for example, to form a single pixel by adding a sub-pixel that emits white (W) light so as to increase luminance, or to form a single pixel by adding at least one sub-pixel that emits complementary color light so as to expand a color reproduction range.

The display unit 10 has a configuration in which apertures 91 are arranged in an array in units of a plurality of adjacent pixels including the left-eye pixel and the right-eye pixel, or preferably, in units of even-number pixels. FIG. 3A illustrates a front view of an aperture array of, for example, 2×3, a cross-sectional view as viewed in a direction of arrows A-A in the front view (A-A line cross-sectional view), and a cross-sectional view as viewed in a direction of arrows B-B in the front view (B-B line cross-sectional view). A dimension of each of the apertures 91 is set equivalent to or smaller than a dimension of each of the pixels 11 each formed of the plurality of sub-pixels. Further, a diameter of each of the apertures 91 may be fixed or variable.

FIG. 3B illustrates two specific examples of the even-number pixels as a unit corresponding to one of the arranged apertures 91. In one of the examples, the unit is formed of four pixels adjacent in an up/down direction and a right/left direction in a two-by-two matrix, that is, four pixels in a square array. Two left-side pixels in a pair in the up/down direction are defined as the right-eye pixel 13R, and two right-side pixels in another pair in the up/down direction are defined as the left-eye pixel 13L. In the other example, the unit is formed of two vertically long pixels, and a left-side pixel is defined as the right-eye pixel 13R, and a right-side pixel is defined as the left-eye pixel 13L.

The pixel configuration according to the former specific example has an advantage of being applicable to a case where the display unit 10 is rotated within a plane including its display surface. Specifically, in a case where the display unit 10 is rotated at 90 degrees, two left-right pixels in a pair in FIG. 3B (up-down pixels under the rotated state) can be used as the right-eye pixel 13R and the left-eye pixel 13L. Further, in another case where the display unit is rotated obliquely at 45 degrees, it is possible to use two pixels located right and left respectively as the right-eye pixel 13R and the left-eye pixel 13L while invalidating other two pixels located up and down under the state after the 45-degree rotation. Also at other rotation angles, it is possible to perform weighting to pixels corresponding to the right eye and the left eye, thereby using these pixels respectively as the right-eye pixel 13R and the left-eye pixel 13L. Although the pixel configuration in the latter specific example is incompatible with the rotation of the display unit 10, the pixel configuration in the latter specific example has an advantage of being capable of reducing the number of pixels to be smaller than the number of pixels in the pixel configuration in the former specific example.

A diffusion layer 14 for mixing the colors of the light beams that the sub-pixels 11R, 11G, and 11B respectively emit is laminated over the sub-pixels 11R, 11G, and 11B. A spacer 92, which is made of a transparent material, for securing an interval between the sub-pixels 11R, 11G, and 11B and the apertures 91 is laminated over the diffusion layer 14. Further, the apertures 91 are formed in the units of adjacent even-number pixels including the left-eye pixel 13L and the right-eye pixel 13R through a light blocking layer 93 laminated over the sub-pixels 11R, 11G, and 11B through intermediation of the diffusion layer 14 and the spacer 92. The apertures 91 limit traveling directions of the light beams emitted from the left-eye pixel 13L and the right-eye pixel 13R so as to control a light beam that enters the left eye of the observer and a light beam that enters the right eye of the observer. With this, it is possible to separate an image that is visible only to the left eye, and an image that is visible only to the right eye from each other.

In the display apparatus 1A according to the first embodiment, which includes the above-described display unit 10 according to Example 1, by the display drive by the display control unit 50, the left-eye pixel 13L displays the left-eye image, and the right-eye pixel 13R displays the right-eye image. At this time, the signal processing unit 40 that supplies the image information to the display control unit 50 generates the image information items respectively to the left-eye pixel 13L and the right-eye pixel 13R such that an image is presented with the aspect ratio different from the aspect ratio of the display surface of the display unit 10. The display image to be presented by the display apparatus 1A according to the first embodiment, which has the aspect ratio different from the aspect ratio of the display surface of the display unit 10, is an image different from a stereoscopic image (three-dimensional image) with an aspect ratio equal to the aspect ratio of the display surface of the display unit 10.

Herein, the case where “aspect ratios are equal to each other” encompasses not only a case where the aspect ratios are exactly equal to each other, but also a case where the aspect ratios are substantially equal to each other. Therefore, a case where the aspect ratio of the stereoscopic image differs from the aspect ratio of the display surface of the display unit 10 due to presence of various types of variations generated in design or in production is encompassed in the concept of the case where “aspect ratios are equal to each other.”

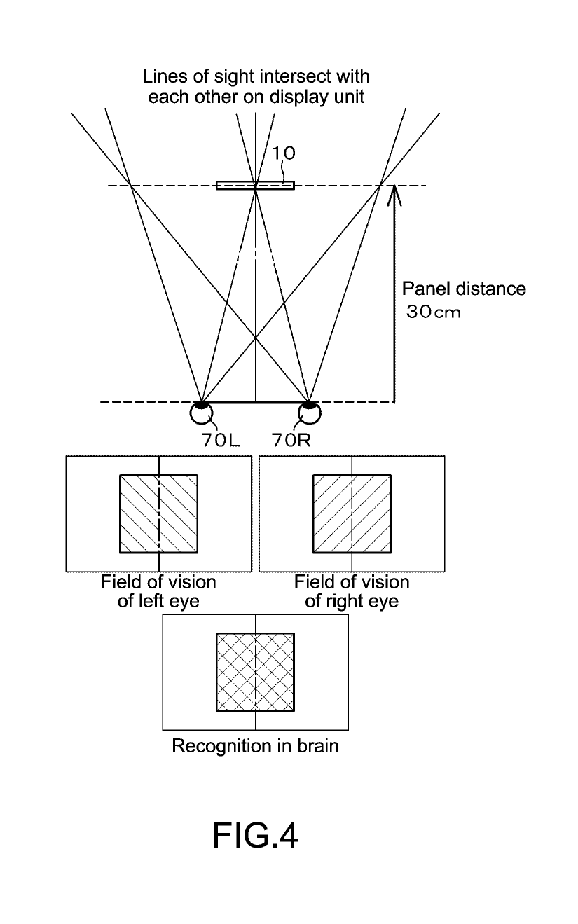

When the observer views the stereoscopic image, eye lenses of the observer are focused on a position on the display surface of the display unit 10. Specifically, as illustrated in FIG. 4, when a line of sight of the left eye 70L and a line of sight of the right eye 70R of the observer intersect with each other on the display surface of the display unit 10, an image in a field of vision of the left eye 70L and an image in a field of vision of the right eye 70R are combined in the brain of the observer, and recognized as the stereoscopic image. In the case of FIG. 4, a distance between the left eye 70L and the right eye 70R and the display surface of the display unit 10 (panel distance) is 30 cm.

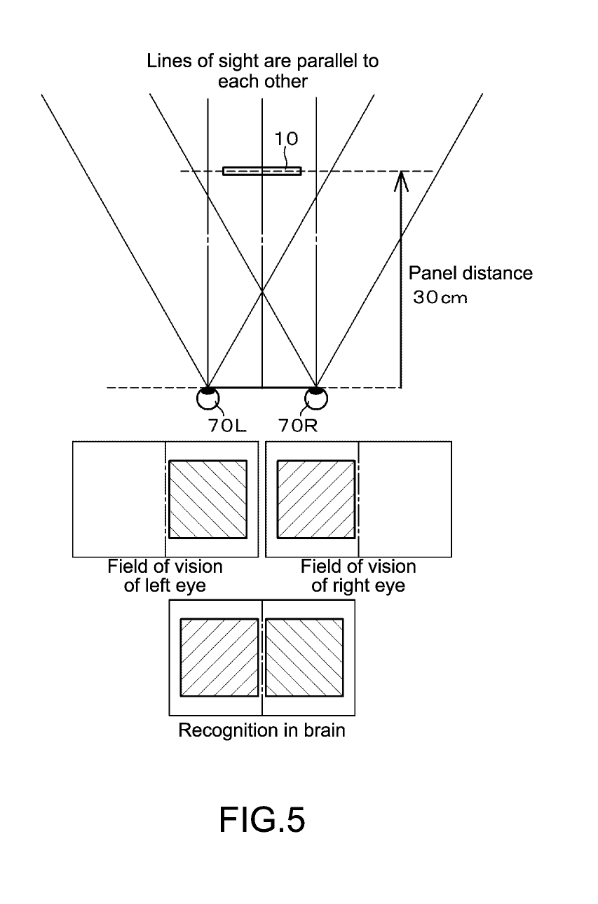

In contrast, in the display apparatus 1A according to the first embodiment, when the observer views the display image with the aspect ratio different from the aspect ratio of the display surface of the display unit 10, as illustrated in FIG. 5, the observer views the display unit 10 side in a manner that the line of sight of the left eye 70L and the line of sight of the right eye 70R are parallel to each other (perpendicular to the display surface of the display unit 10). At this time, the line of sight of the left eye 70L and the line of sight of the right eye 70R are perpendicular to the display surface of the display unit 10. Also in the case of FIG. 5, the panel distance is 30 cm.

Under a state in which the left-eye pixel 13L displays the left-eye image and the right-eye pixel 13R displays the right-eye image, the apertures 91 provided in the units of the plurality of pixels limit the traveling directions of the light beams emitted from the pixels 13L and 13R so as to control light beams from ones of the pixels 11, which enter the left eye 70L of the observer, and to control light beams from other ones of the pixels 11, which enter the right eye 70R of the observer. With this, a display image from the left-eye pixel 13L and a display image from the right-eye pixel 13R are separated into the image that is visible only to the left eye 70L, and the image that is visible only to the right eye 70R.

In this way, when the observer views the display unit 10 side in the manner that the line of sight of the left eye 70L and the line of sight of the right eye 70R are parallel to each other, the observer can recognize, in his/her brain, a display image larger than the display surface of the display unit 10, which is separated into the left-eye image and the right-eye image. In other words, in the display apparatus 1A according to the first embodiment, the display image from the left-eye pixel 13L and the display image from the right-eye pixel 13R can be separately displayed on two left and right screens by the function of the apertures 91, and hence can be presented to the observer as a display image that is enlarged in a left-right direction to be larger than (up to twice as large as) a physical screen size of the display unit 10. With this, larger amount of information can be presented to the observer.

Further, in the configuration of the display unit 10 according to Embodiment 1, the diffusion layer 14 is provided between the sub-pixels 11R, 11G, and 11B and the diffusion layer 14. This diffusion layer 14 has the function to mix the colors of the light beams that the sub-pixels 11R, 11G, and 11B respectively emit. By the function of the diffusion layer 14, the sub-pixels 11R, 11G, and 11B can be prevented from visually recognized by the observer. With this, a display image clearer than that in the case where the sub-pixels 11R, 11G, and 11B are visually recognized can be presented to the observer.

### Example 2

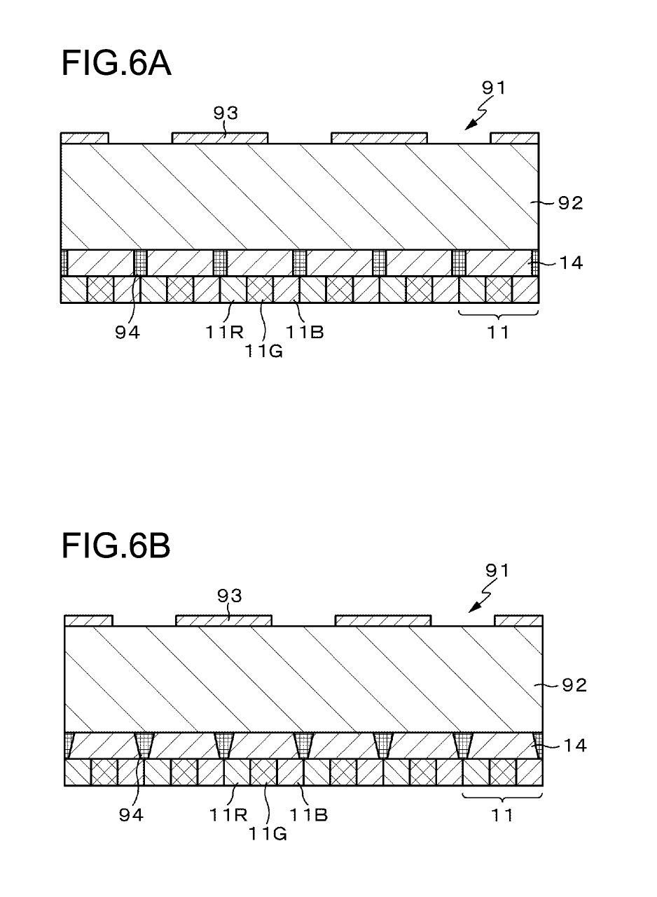

Example 2 is a modification example of Example 1. FIG. 6A is a cross-sectional view of the display unit 10 according to Example 2. A configuration of the display unit 10 according to Example 2 is different from the configuration of the display unit 10 according to Example 1 in that separators 94 are provided in pixel units (in this example, units of the three sub-pixels 11R, 11G, and 11B) in the diffusion layer 14. In this case, it is preferred that the separators 94 be made of a material that absorbs visible light. Further, it is preferred that an interface between the separators 94 and the diffusion layer 14 be formed of an interface that reflects the visible light.

When the separators 94 made of the material that absorbs the visible light are provided in the pixel units within the diffusion layer 14 in this way, the colors of the pixels 11 can be prevented from being mixed with each other. Further, when the interface between the separators 94 and the diffusion layer 14 is formed of the interface that reflects the visible light, an effect of preventing the colors of the pixels 11 from being mixed with each other can be further increased.

### Example 3

Example 3 is a modification example of Example 2. FIG. 6B is a cross-sectional view of the display unit 10 according to Example 3. A configuration of the display unit 10 according to Example 3 is different from the configuration of the display unit 10 according to Example 2 in that the diffusion layer 14 is partitioned into separate parts by the separators 94, and that surfaces on the pixel 11 side of the separate parts of the diffusion layer 14 are larger than surfaces on the aperture 91 side of the separate parts of the diffusion layer 14. In other words, the separators 94 are each formed into an inverted trapezoidal shape smaller in dimension on the pixel 11 side than on the aperture 91 side in their cross-section.

Also in the display unit 10 according to Example 3, as in the display unit 10 according to Example 2, it is preferred that the separators 94 be made of the material that absorbs the visible light, and that the interface between the separators 94 and the diffusion layer 14 be formed of the interface that reflects the visible light. When the surfaces on the pixel 11 side of the separate parts of the diffusion layer 14 are formed to be larger than the surfaces on the aperture 91 side of the separate parts of the diffusion layer 14, the effect of preventing the colors of the pixels 11 from being mixed with each other can be further increased by the separators 94.

### Example 4

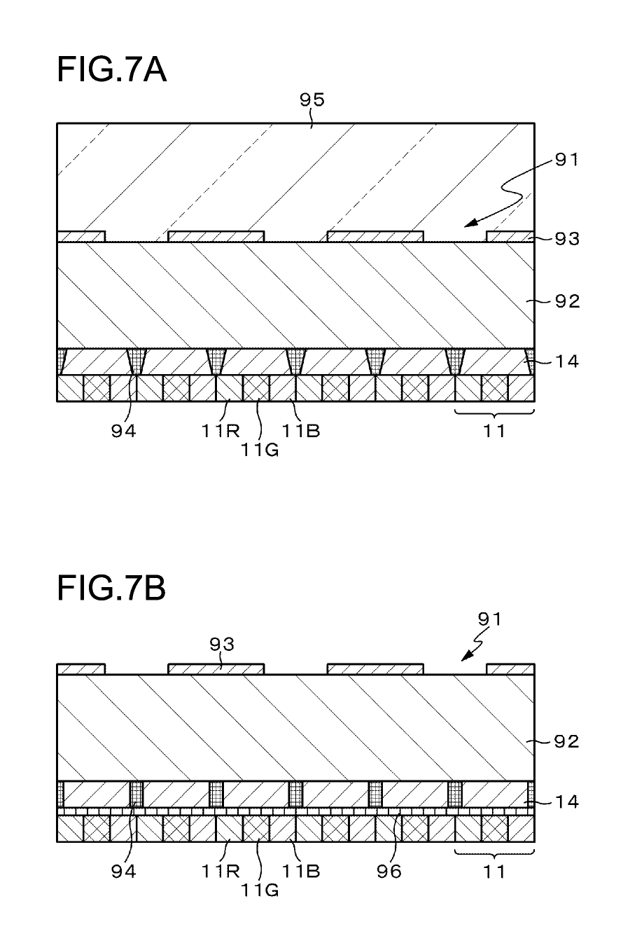

Example 4 is a modification example of Example 3. FIG. 7A is a cross-sectional view of the display unit 10 according to Example 4. A configuration of the display unit 10 according to Example 4 is different from the configuration of the display unit 10 according to Example 3 in that a transparent pad (film) 95 made, for example, of glass is provided over the layer (light blocking layer 93) through which the apertures 91 are provided.

When the transparent pad 95 is provided in this way over the layer through which the apertures 91 are provided, the display unit 10 according to Example 4 can be provided as a display unit having a touchscreen structure that allows input via a screen to be touched with a fingertip or a dedicated pen similar to display apparatuses of mobile terminals such as a smartphone. Note that, although, in the configuration of this example, the touchscreen structure is provided to the display unit 10 according to Example 3, it is similarly possible to provide the touchscreen structure to the display unit 10 according to Example 1 or to the display unit 10 according to Example 2. Further, when the touchscreen structure to be used is of an in-cell type, the transparent pad 95 may be a protective layer that does not have the touchscreen structure.

### Example 5

Example 5 is a modification example of Example 1. FIG. 7B is a cross-sectional view of the display unit 10 according to Example 5. A configuration of the display unit 10 according to Example 5 is different from the configuration of the display unit 10 according to Example 1 in that a diffraction grating 96 is provided between the pixels 11 (sub-pixels 11R, 11G, and 11B) and the diffusion layer 14. The diffraction grating 96 has a structure in which, for example, a large number of parallel slits are arrayed at equal intervals.

The diffraction grating 96 has a function to scatter, by diffraction, the light beams in the respective colors, which are emitted from the sub-pixels 11R, 11G, and 11B. Thus, when the diffraction grating 96 is provided between the pixels 11 (sub-pixels 11R, 11G, and 11B) and the diffusion layer 14, by the function of the diffraction grating 96, uneven color mixture in the diffusion layer 14 can be reduced. Note that, although, in the configuration of this example, the diffraction grating 96 is provided with respect to the display unit 10 according to Example 1, it is similarly possible to provide the diffraction grating 96 to the display units 10 according to Examples 2 to Examples 4.

### Example 6

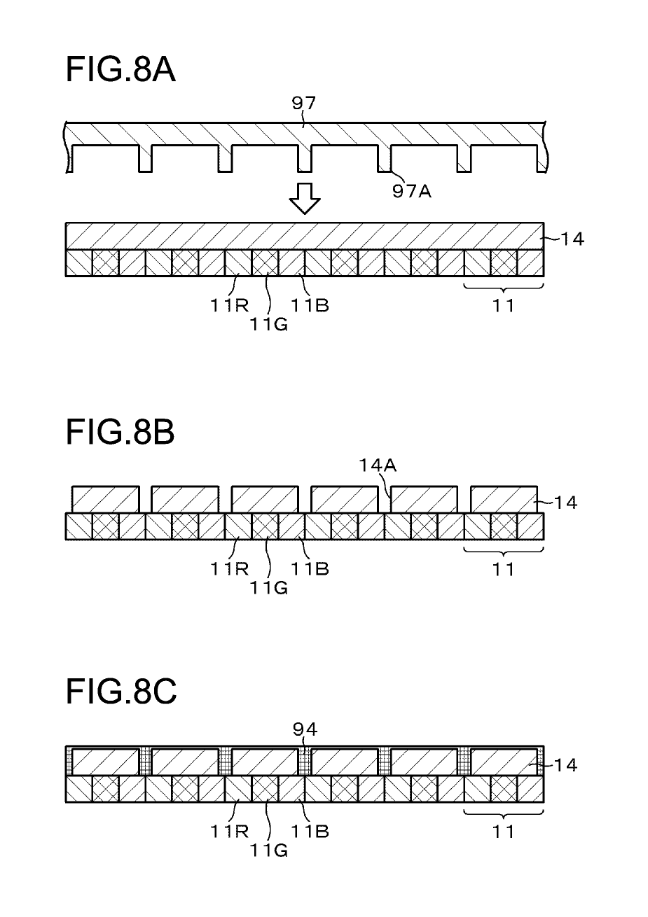

Example 6 relates to a method of forming the separators 94 in the display unit 10 according to Example 1. FIG. 8A, FIG. 8B, and FIG. 8C are process views illustrating the method of forming the separators 94 according to Example 6. First, the diffusion layer 14 made, for example, of an acrylic material is formed with a thickness of, for example, approximately 35 μm over the pixels 11 (sub-pixels 11R, 11G, and 11B). Under a state in which the diffusion layer 14 has not yet been hardened, a die 97 having protruding portions 97A conforming to a shape of the separators 94 is pressed onto the diffusion layer 14 (step in FIG. 8A).

In this example, intervals between the protruding portions 97A of the die 97 are each set, for example, to approximately 30 μm to 100 μm, and a thickness of each of the protruding portions 97A is set, for example, to 10 μm or less. With this, in the diffusion layer 14, recessed portions 14A each having a width of 10 μm or less for forming the separators 94 are formed at the intervals of approximately 30 μm to 100 μm (step in FIG. 8B). Then, a visible-light absorbing material is applied over the diffusion layer 14 in which the recessed portions 14A are formed (step in FIG. 8C). At the time of applying the visible-light absorbing material, it is possible to use well-known coating methods such as a screen printing method, a slit-die coating method, a drop casting method, and a spin coating method.

After the application of the visible-light absorbing material, residual parts of the visible-light absorbing material on a top surface of the diffusion layer 14 are removed. Note that, when a width of each of the separators 94 is set, for example, to approximately 5 μm, and a thickness of the coating over the top surface of the diffusion layer 14 is set smaller than, for example, 1 μm at a density at which the visible light can be absorbed, the visible-light absorbing material need not necessarily be removed. Further, as in the case of Example 3, in order to secure gaps between the pixels 11 such that the mixture of the colors of adjacent pixels is reduced, the separators 94 may each be formed into the inverted trapezoidal shape smaller in dimension on the pixel 11 side than on the aperture 91 side.

### Example 7

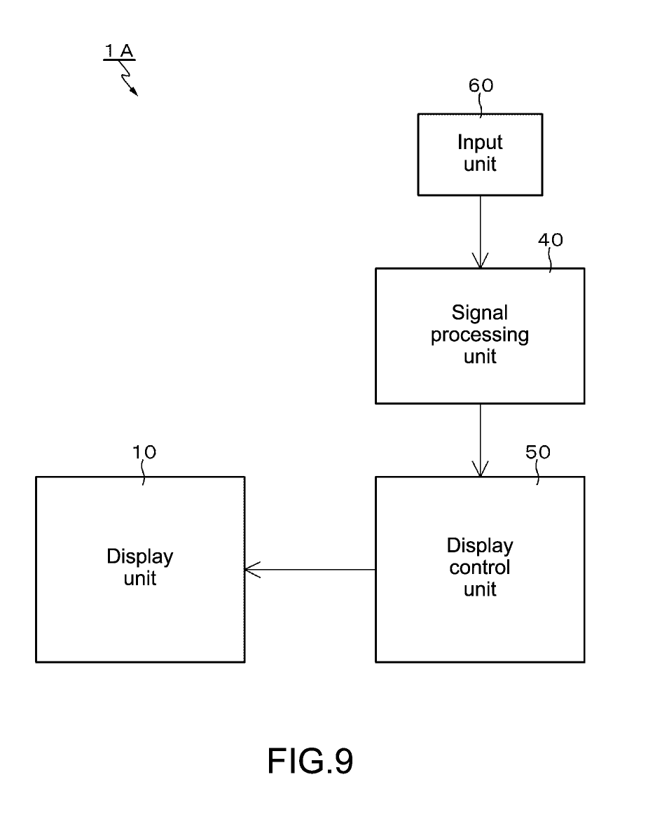

Example 7 is a modification example of the display apparatus 1A according to the first embodiment. FIG. 9 shows a system configuration of the display apparatus 1A according to Example 7. The system configuration of the display apparatus 1A according to the first embodiment includes the display unit 10, the imaging unit 20, the distance measurement unit 30, the signal processing unit 40, the display control unit 50, and the input unit 60. In contrast, the system configuration of the display apparatus 1A according to Example 7 does not have the functions constituting the part of the detection unit that detects the positional information and the orientation information of the eyes of the observer with respect to the display surface of the display unit 10, that is, does not include the imaging unit 20 and the distance measurement unit 30.

Even without the function to detect the positional information and the orientation information of the eyes of the observer with respect to the display surface of the display unit 10, the display apparatuses capable of displaying images on an enlarged scale with the function of the apertures 91 are capable of presenting the images as the display image that is enlarged in the left-right direction to be larger than the physical screen size of the display unit 10. However, when the positional information and the orientation information of the eyes of the observer are detected, and the image calculation process in the signal processing unit 40 is executed on the basis of results of the detection, more preferred display image can be presented to the observer.

### Example 8

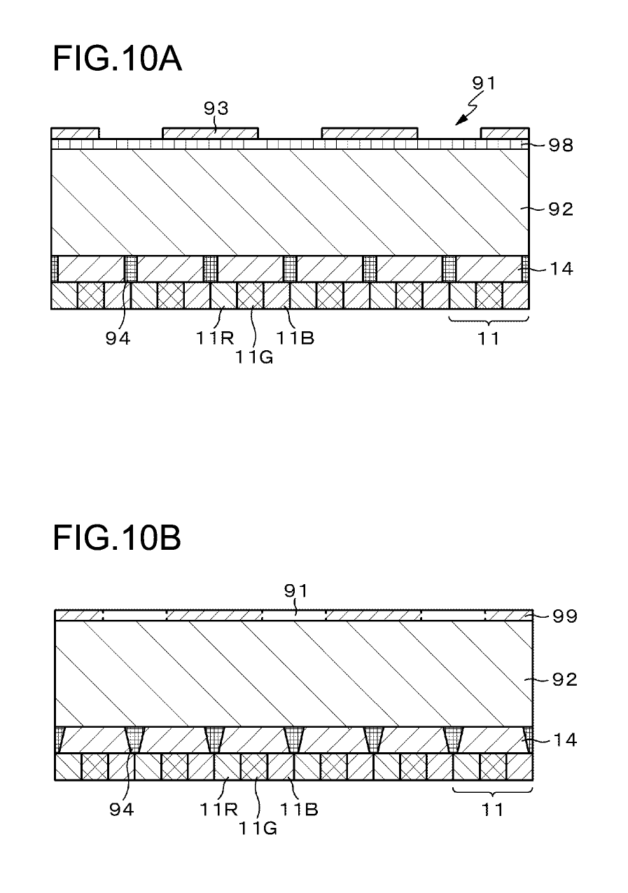

Example 8 is a modification example of Example 1 to Example 5. FIG. 10A is a cross-sectional view of the display unit 10 according to Example 8. The display unit 10 according to Example 8 has a configuration in which a liquid-crystal layer 98 is provided between the apertures 91 and the spacer 92. Although, in the configuration of this example, the liquid-crystal layer 98 is provided between the apertures 91 and the spacer 92, the liquid-crystal layer 98 may be provided over the apertures 91. In the display unit 10 according to Example 8, which includes such a liquid-crystal layer 98, an intensity of the light at a time of transmitting through the liquid-crystal layer 98 can be controlled. With this, an intensity of the light at a time of passing through the apertures 91 can be adjusted.

### Example 9

Example 9 is a modification example of Example 1 to Example 5. FIG. 10B is a cross-sectional view of the display unit 10 according to Example 9. In the configuration of each of the display units 10 according to Example 1 to Example 5, the apertures 91 are fixedly formed through the light blocking layer 93. In contrast, in a configuration of the display unit 10 according to Example 9, the layer in which the apertures 91 are formed is formed of elements capable of controlling the intensity of the light that transmits therethrough, such as an electrochromic element 99. The electrochromic element 99 is a substance in which, by application of an electric field or current, a color absorption band is generated, and a color reversibly changes only thereat. Thus, when the layer in which the apertures 91 are formed is formed of the electrochromic element 99, the apertures 91 can be selectively formed. Note that, as examples of the element capable of controlling the intensity of the light to transmit therethrough other than the electrochromic element 99, there may be mentioned a liquid-crystal element.

Whether or not to form the apertures 91 can be selected by, for example, instructions from the observer via the input unit 60 shown in FIG. 1. With this, by the instructions from the observer, it is possible to present a display image with the aspect ratio different from the aspect ratio of the display surface of the display unit 10 when the apertures 91 are formed, and to present a display image with the aspect ratio equal to the aspect ratio of the display surface of the display unit 10 when the apertures 91 are not formed.

In this way, when necessary, the observer can switch the image display with the aspect ratio different from the aspect ratio of the display surface of the display unit 10, and the image display with the aspect ratio equal to the aspect ratio of the display surface to each other. Note that, when the apertures 91 are not formed, images are not displayed separately for the left and right eyes. Thus, the images are displayed in a normal display mode.

Further, when the apertures 91 are formed, the images are recognized as illustrated in the schematic view of FIG. 4. In the schematic view of FIG. 4, the case of displaying a stereoscopic image is assumed. Specifically, the image in the field of vision of the left eye 70L and the image in the field of vision of the right eye 70R are combined in the brain of the observer, and recognized as the stereoscopic image. In the case of displaying the stereoscopic image, parallax images, which are presented to the left-eye pixel 13L and the right-eye pixel 13R of the display unit 10, are recognized as the stereoscopic image. Also in the case of the display unit 10 according to Example 9, when the apertures 91 are not formed, all the pixels are presented to the left and right eyes.

Also in the display apparatus 1A according to the first embodiment, which includes the display unit 10 according to Example 2, Example 3, Example 4, Example 5, Example 8, or Example 9 described hereinabove, it is possible to obtain the same functions and the same advantages as those of the display apparatus 1A according to the first embodiment, which includes the display unit 10 according to Example 1. In other words, the display image from the left-eye pixel 13L and the display image from the right-eye pixel 13R can be separately displayed on the two left and right screens by the function of the apertures 91, and hence can be presented to the observer as the display image that is enlarged in the left-right direction to be larger than (up to twice as large as) the physical screen size of the display unit 10.

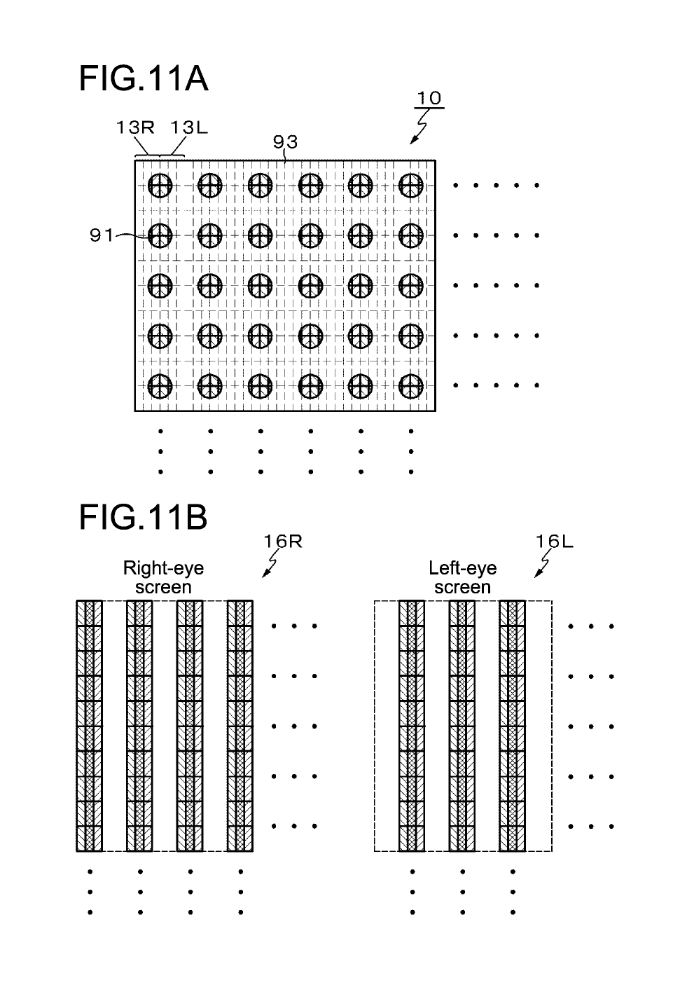

Now, display pixels with respect to the left eye 70L and the right eye 70R of the observer are described with reference to FIG. 11A and FIG. 11B. FIG. 11A illustrates a pixel array of the left-eye pixels 13L and the right-eye pixels 13R of the display unit 10. FIG. 11B illustrates pixel arrays of a left-eye screen 16L and a right-eye screen 16R.

As an example of device specifications of the display unit 10, the number of the pixels is assumed to be 2160×3840, and each of the apertures 91 is arranged with respect to four pixels, with the number of the apertures being 540×960. The four pixels as a unit for the arrangement of the apertures 91 are formed of two vertically arranged pixels, that is, the right-eye pixels 13R, and two vertically arranged pixels, that is, the left-eye pixels 13L. In other words, in the pixel array in the display unit 10, the right-eye pixel 13R and the left-eye pixel 13L are provided alternately as the pixels in the horizontal direction (row direction).

In contrast, as for the left-eye screen 16L and the right-eye screen 16R, as illustrated in FIG. 11B, the display images are formed under a state in which pixel columns of the left-eye screen 16L and the right-eye screen 16R are arrayed at intervals of one pixel column, that is, state in which pixels are arrayed at intervals of one pixel in the horizontal direction. In other words, the signal processing unit 40 generates the image information items with respect respectively to the left and right eyes 70L and 70R such that the number of pixels of each of the display images in the horizontal direction is half the number of the pixels of the display unit 10. This utilizes a phenomenon that something having a certain size or smaller cannot be visually recognized with human eyesight. In other words, even when the pixels of the left-eye screen 16L and the right-eye screen 16R are arrayed at the intervals of one pixel such that gaps corresponding to one pixel are secured, the gaps corresponding to one pixel are not visually recognized when the gaps are smaller than a resolution limit of the human eye. Note that, the signal processing unit 40 generates the image information items such that the number of pixels in the vertical direction is equal to the number of pixels of the display unit 10.

Thus, when a dimension of each of the pixels of the left-eye screen 16L and the right-eye screen 16R, that is, when a dimension of each of the pixels that form the images is set to a dimension smaller than the resolution limit of the human eye, preferably, to half (one-half) or less, the gaps corresponding to one pixel between the pixel columns are not visually recognized. Note that, the resolution limit of the human eye is eyesight resolution. A visual angle of a human with an eyesight of 1.0 corresponds to an angle of one minute of arc. This means that an ability to check the visual angle of one minute of arc corresponds to the eyesight of 1.0.

By arraying the pixels of the left-eye screen 16L and the right-eye screen 16R, which display the images, at the intervals of one pixel in the direction corresponding to a direction of alignment of the left and right eyes 70L and 70R (horizontal direction/row direction), the number of pixels in the horizontal direction is half the number of the pixels of the display unit 10 with respect to each of the left and right eyes 70L and 70R. The number of pixels in the vertical direction is equal to the number of the pixels of the display unit 10. Note that, although, in the case exemplified here, the pixel array with the intervals of one pixel in the horizontal direction is employed in each of the left-eye screen 16L and the right-eye screen 16R that display the images, the pixel array is not limited to the pixel array at the intervals of one pixel. For example, it is possible to employ a pixel array at intervals of two pixels.

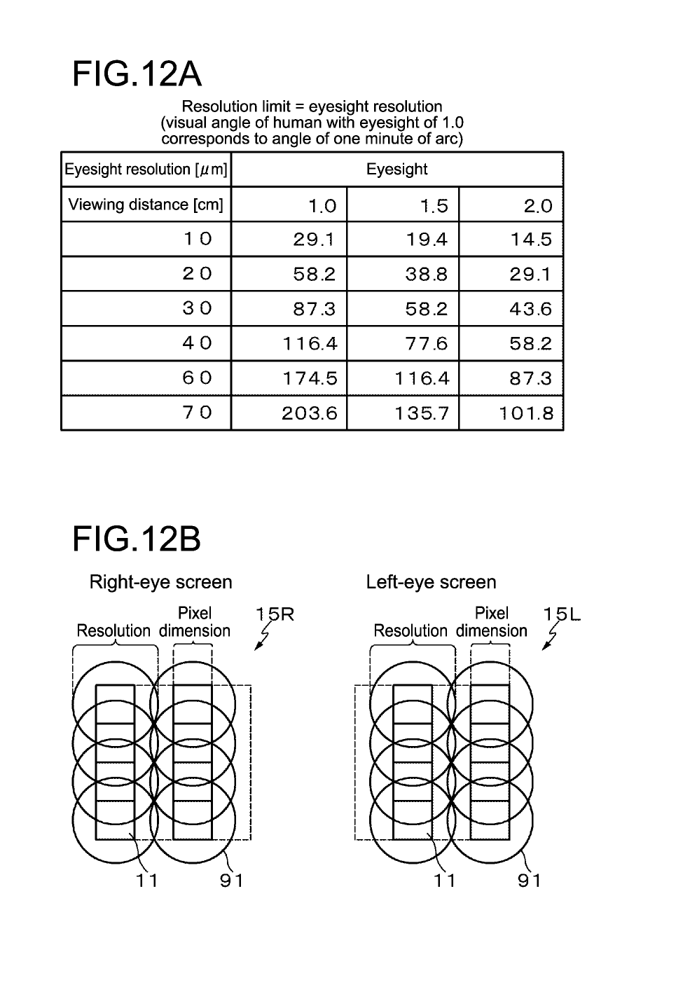

The resolution limit of the human eye with respect to the gaps corresponding to one pixel between the pixel columns of the left-eye screen 16L and the right-eye screen 16R, and the pixel dimension of each of the pixels of the left-eye screen 16L and the right-eye screen 16R are described in further detail with reference to FIG. 12A and FIG. 12B. FIG. 12A shows an example of numerical values of a viewing distance from the observer to the display unit 10, an eyesight, and the pixel dimension. FIG. 12B illustrates relationships between a resolution (resolution limit) of the human eyes and the pixel dimension.

As an example, in a case where the eyesight is 1.0 and the viewing distance is 20 [cm], when the pixel dimension (dimension in the horizontal direction) is 29.1 [um] or less, that is, half an eyesight resolution of 58.2 [um] or less, the gaps corresponding to one pixel dimension between the pixel columns are unnoticeable. On mobile electronic apparatuses such as a mobile phone, the observer generally performs visual recognition (observation) of the display screen at a viewing distance of approximately 70 [cm] or less. Thus, in a case where the eyesight is 1.0 and the viewing distance is 70 [cm], when the pixel dimension is 101.8 [um] or less, that is, half an eyesight resolution of 203.6 [um] or less, the gaps corresponding to one pixel dimension between the pixel columns are unnoticeable.

The display apparatus 1A according to the first embodiment enables images to be presented separately to the left and right eyes 70L and 70R, that is, the images to be presented side by side in the left-right direction. With this, it is possible to obtain a laterally wide display area. For example, it is possible to present different images that are independent of and do not overlap with each other with respect to the whole display image to the left and right eyes 70L and 70R. In addition, as is clear from the illustrations in FIG. 11A and FIG. 11B, the total number of pixels of the left-eye screen 16L and the right-eye screen 16R that display the images is equal to the number of pixels of the display unit 10. Thus, it is possible to present a display image having a laterally twice area of display. In other words, with respect to each of the left and right eyes 70L and 70R, the number of pixels in the horizontal direction is half the number of pixels of the display unit 10, and the number of pixels in the vertical direction is equal to the number of pixels of the display unit 10. With this, a vertical density is twice as high as a horizontal density in the images displayed on the left-eye screen 16L and the right-eye screen 16R. Thus, it is possible to smoothly display the image in the vertical direction and to double the luminance.

### Second Embodiment

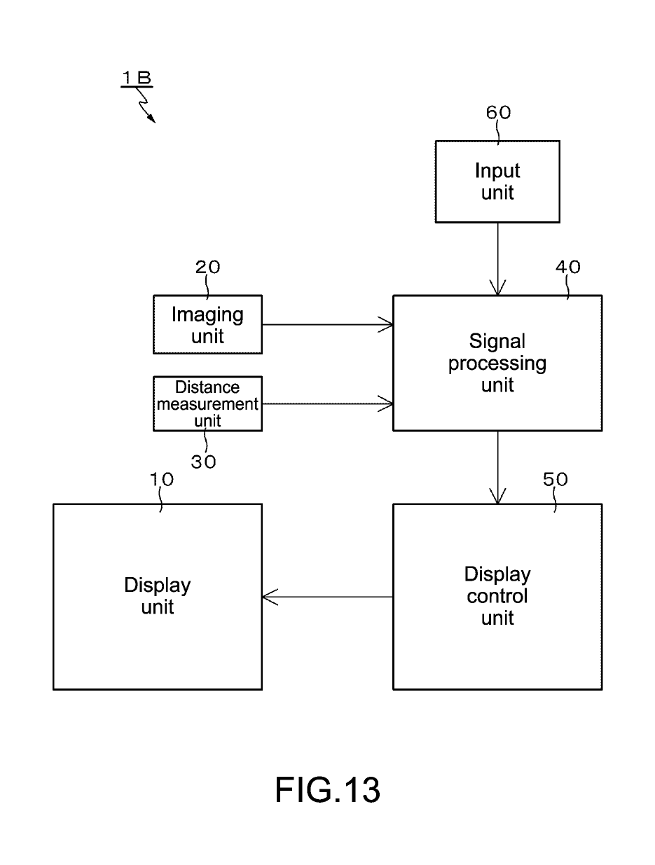

FIG. 13 is a block diagram showing an example of a system configuration of a display apparatus according to a second embodiment of the present disclosure. Similar to the display apparatus 1A according to the first embodiment, a display apparatus 1B according to the second embodiment includes the display unit 10, the imaging unit 20, the distance measurement unit 30, the signal processing unit 40, the display control unit 50, and the input unit 60. The signal processing unit 40 and the display control unit 50 may be constituted, for example, by a microcomputer. The functions of the imaging unit 20, the distance measurement unit 30, the signal processing unit 40, the display control unit 50, and the input unit 60 are basically the same as those of the display apparatus 1A according to the first embodiment.

The display apparatus 1B according to the second embodiment is a virtual-image display apparatus that enables an observer to view a virtual image with both the eyes on a screen of the single display unit 10. Note that, the display apparatus 1B according to the second embodiment does not exclude virtual image viewing with a single eye, and hence it is possible to view the virtual image with a single eye. In addition, the display apparatus 1B according to the second embodiment presents a virtual image with an aspect ratio different from the aspect ratio of the display surface of the display unit 10. The virtual image with the aspect ratio different from the aspect ratio of the display surface of the display unit 10 is an image different from a stereoscopic image (three-dimensional image) with the aspect ratio equal to the aspect ratio of the display surface of the display unit 10.

Herein, the case where “aspect ratios are equal to each other” encompasses not only the case where the aspect ratios are exactly equal to each other, but also the case where the aspect ratios are substantially equal to each other. Therefore, the case where the aspect ratio of the stereoscopic image differs from the aspect ratio of the display surface of the display unit 10 due to the presence of various types of variations generated in design or in production is encompassed in the concept of the case where “aspect ratios are equal to each other.” Further, when the observer views the stereoscopic image, the eye lenses of the observer are focused on a position on the display surface of the display unit 10. In contrast, when the observer views the virtual image, the eye lenses of the observer are focused on a position different from the position on the display surface of the display unit 10, that is, a position more distant than or less distant than the display surface is distant.

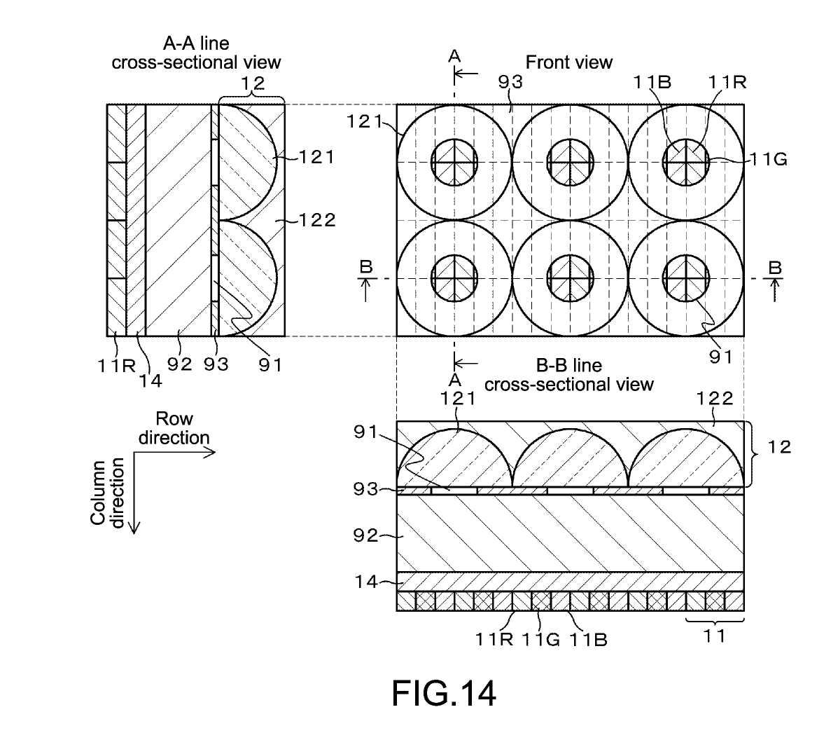

FIG. 14 includes views illustrating a configuration of a main part of a display unit in the display apparatus 1B according to the second embodiment. The display unit 10 in the display apparatus 1B according to the second embodiment has a configuration including, in addition to the components of the display unit 10 according to Example 1 (refer to FIG. 3A) in the display apparatus 1A according to the first embodiment, virtual image lenses 12 formed, for example, of microlenses arranged in an array corresponding to the apertures 91. In other words, similar to the apertures 91, the virtual image lenses 12 are arranged in the array in the units of the plurality of adjacent pixels including the left-eye pixel and the right-eye pixel, or preferably, in the units of even-number pixels. In this example, the virtual image lenses 12 are provided in the units of four pixels in the square array (refer to FIG. 3B), and a dimension of each of the virtual image lenses 12 is equivalent to a dimension of the four pixels. Also in this example, the dimension of each of the apertures 91 is set equivalent to or smaller than the dimension of each of the pixels 11 each formed of the plurality of sub-pixels. Note that, the apertures 91 may be omitted.

FIG. 14 illustrates a front view of a microlens array of, for example, 2×3, a cross-sectional view as viewed in a direction of arrows A-A in the front view (A-A line cross-sectional view), and a cross-sectional view as viewed in a direction of arrows B-B in the front view (B-B line cross-sectional view). The virtual image lenses 12 have a function to adjust a virtual-image presentation position in accordance with a focal length such that the focus position of the eye lenses of the observer, that is, the virtual-image presentation position is at the position different from the position on the display surface of the display unit 10 (that is, position more distant than or position less distant than the display surface is distant). In other words, the virtual image lenses 12 have a function to focus light of images from a plurality of corresponding pixels onto retinas of the eyes of the observer so as to allow the observer to visually recognize the focused images as a virtual image.

The virtual image lenses 12 include lens portions 121 made of a high-refractive-index material, and a low-refractive-index resin 122 covering the lens portions 121, and are formed in the units of adjacent even-number pixels including the left-eye pixel 13L and the right-eye pixel 13R each including the sub-pixels 11R, 11G, and 11B over which the diffusion layer 14, the spacer 92, and the apertures 91 are interposed. As each of the virtual image lenses 12, it is possible to use a fixed focus lens with a fixed focal length or a variable focus lens with a variable focal length. Alternatively, it is possible to use the fixed focus lens and the variable focus lens together. As the fixed focus lens, it is possible to use, for example, a gradient index lens (refer to Japanese Patent Application Laid-open No. 2015-225966). Moreover, as for the variable focus lens, a liquid-crystal lens and a liquid lens have been widely known.

The virtual image lenses 12 function to determine the virtual-image presentation position in accordance with its focal length. Thus, when the virtual image lenses 12 are each formed of the fixed focus lens, the virtual-image presentation position is fixed. When the virtual image lenses 12 are each formed of the variable focus lens, the virtual-image presentation position can be adjusted by changing the focal length of the variable focus lens under the drive control by the display control unit 50 to be described below.

In FIG. 13, the signal processing unit 40 not only executes the calculation process of detecting the positional information and the orientation information of the eyes of the observer with respect to the display surface of the display unit 10, but also executes a process of calculating a distance (hereinafter, referred to as “virtual image distance”) from the positions of the eyes of the observer to the virtual-image presentation position where the virtual image is presented (displayed). When the virtual image lenses 12 are each formed of the fixed focus lens, the virtual image distance is fixed. Thus, the signal processing unit 40 calculates the virtual image distance on the basis of a pre-registered focal length of the virtual image lenses 12, that is, the focal length of the fixed focus lens. When the virtual image lenses 12 are each formed of the variable focus lens, the focal length of the variable focus lens is determined by the instructions from the observer via the input unit 60. At this time, the signal processing unit 40 calculates the virtual image distance on the basis of a focal length of the variable focus lens, which is designated by the observer via the input unit 60. Further, the display control unit 50 adjusts the focal length of the variable focus lens to the focal length designated by the observer.

The signal processing unit 40 also performs calculation of virtual-image information items (image information items) with respect respectively to the left-eye pixel 13L and the right-eye pixel 13R on the basis of the positional information and the orientation information of the eyes of the observer, the virtual-image distance information, and on the basis of the image information to be displayed such that a virtual image is presented at a position at the virtual distance with the aspect ratio different from the aspect ratio of the display surface of the display unit 10 Then, the signal processing unit 40 supplies the calculated information items to the display control unit 50. The display control unit 50 drives the left-eye pixel 13L and the right-eye pixel 13R on the basis of the virtual image information supplied from the signal processing unit 40. When the virtual image lenses 12 are each formed of the variable focus lens, the display control unit 50 controls the focal length of the variable focus lens in accordance with the instructions from the observer via the input unit 60.

Under the drive control by the display control unit 50, the virtual image is presented (displayed) at the position at the virtual image distance, that is, the virtual-image presentation position. In other words, when light of the images from the left-eye pixel 13L and the right-eye pixel 13R is focused on the retina of the observer by the virtual image lenses 12, the observer can recognize the images as a virtual image displayed at the presentation position (virtual-image distance position) that is determined in accordance with the focal length of the virtual image lenses 12.

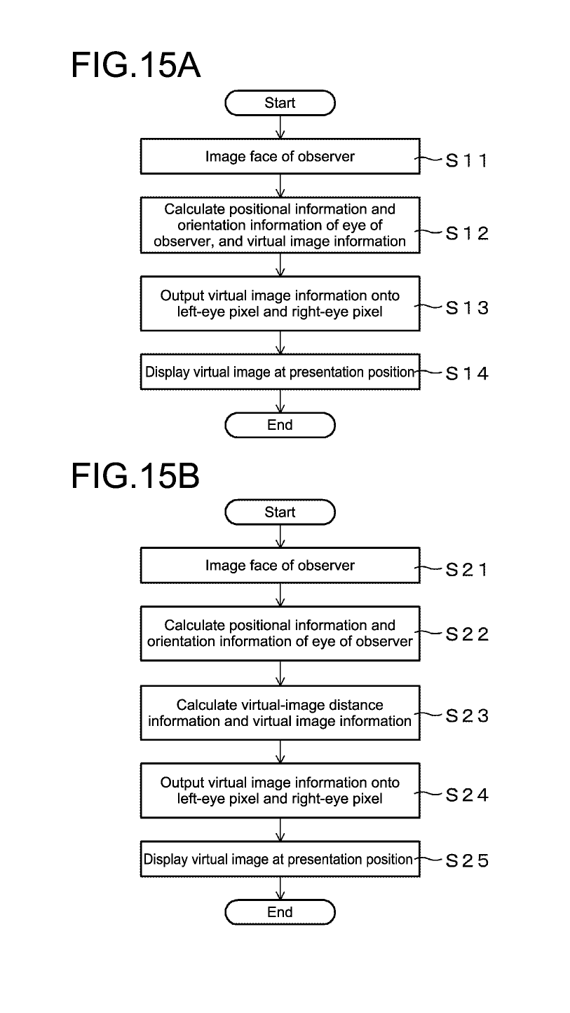

Now, a flow of operations of the display apparatus 1B according to the second embodiment in the case where the virtual image lenses 12 are each formed of the fixed focus lens, and a flow of operations of the same in a case where the virtual image lenses 12 are each formed of the variable focus lens, are described. FIG. 15A shows the flow of the operations in the case where the virtual image lenses 12 are each formed of the fixed focus lens. FIG. 15B shows the flow of the operations in the case where the virtual image lenses 12 are each formed of the variable focus lens. In either one of the cases, it is assumed that viewing of the display unit 10 by the observer is detected by the imaging unit 20, and in response thereto, the display apparatus 1B starts the operations for presenting a virtual image.

As shown in the flowchart of FIG. 15A, when the virtual image lenses 12 are each formed of the fixed focus lens, the viewing of the display unit 10 by the observer is detected by the imaging unit 20, and the imaging unit 20 captures the face of the observer (Step S11). At this time, the measurement of the distance between the display surface of the display unit 10 and the eyes of the observer is also performed directly or indirectly by the distance measurement unit 30.

Then, on the basis of information of the image taken by the imaging unit 20 and information of the distance measured by the distance measurement unit 30, the signal processing unit 40 calculates the positional information and the orientation information of the eyes of the observer (Step S12). At this time, by using the virtual image distance determined in accordance with the focal length of a known fixed focus lens, the signal processing unit 40 calculates the virtual-image information items (image information items) with respect respectively to the left-eye pixel 13L and the right-eye pixel 13R on the basis of the positional information and the orientation information of the eyes of the observer, and on the basis of the image information to be displayed. Next, the display control unit 50 outputs the virtual-image information items obtained by the signal processing unit 40 to the left-eye pixel 13L and the right-eye pixel 13R (Step S13), and drives the left-eye pixel 13L and the right-eye pixel 13R. With this, a virtual image is presented at the presentation position at the virtual image distance (Step S14).

As shown in the flowchart of FIG. 15B, when the virtual image lenses 12 are each formed of the variable focus lens, the viewing of the display unit 10 by the observer is detected by the imaging unit 20, and the imaging unit 20 captures the face of the observer (Step S21). At this time, the measurement of the distance between the display surface of the display unit 10 and the eyes of the observer is also performed directly or indirectly by the distance measurement unit 30.

Then, on the basis of the information of the image taken by the imaging unit 20 and the information of the distance measured by the distance measurement unit 30, the signal processing unit 40 calculates the positional information and the orientation information of the eyes of the observer (Step S22). Next, the signal processing unit 40 calculates virtual-image distance information on the basis of focal length information of the variable focus lens, which is designated by the observer via the input unit 60. In addition, by using the virtual-image distance information, the signal processing unit 40 calculates virtual-image information items with respect respectively to the left-eye pixel 13L and the right-eye pixel 13R on the basis of the positional information and the orientation information of the eyes of the observer, and on the basis of the image information to be displayed (Step S23). After that, the display control unit 50 outputs the virtual-image information items obtained by the signal processing unit 40 to the left-eye pixel 13L and the right-eye pixel 13R (Step S24), and drives the left-eye pixel 13L and the right-eye pixel 13R. With this, the virtual image is presented at the presentation position at the virtual image distance (Step S25).

As described above, the display apparatus 1B according to the second embodiment is a virtual-image display apparatus that enables the observer to view a virtual image with both the eyes on the single display unit 10, and that presents the virtual image with the aspect ratio different from the aspect ratio of the display surface of the display unit 10. Note that, presenting the virtual image with the aspect ratio different from the aspect ratio of the display surface of the display unit 10 means presenting (displaying) the virtual image not on the display surface of the display unit 10, but at the presentation position different from the position on the display surface of the display unit 10 in an observation direction (front-back direction of the display unit 10) for the observer.

Specifically, on the display apparatus 1B according to the second embodiment, the virtual-image presentation position with respect to the observer may be a position more distant from the observer than the display surface of the display unit 10 is distant, or a position less distant from the observer than the display surface of the display unit 10 is distant. The distance of the virtual image from the observer to the virtual-image presentation position, that is, the virtual image distance, is determined in accordance with the focal length of the virtual image lenses 12, and the distance from the observer to the display unit 10 (hereinafter, referred to as “viewing distance”).

Further, when the virtual image lenses 12 are each formed of the variable focus lens, the display apparatus 1B according to the second embodiment can be switched between virtual image display and real image display. In other words, when the virtual image lenses 12 are each formed of the variable focus lens, by providing a lens function to the variable focus lens, it is possible, as described above, to present a virtual image at the presentation position different from the position on the display surface of the display unit 10. Further, by omitting the lens function from the variable focus lens, it is possible to display a real image (two-dimensional image) on the display surface of the display unit 10. Whether or not to provide the lens function to the variable focus lens can be switched by collectively controlling focal lengths of all the microlenses forming the variable focus lenses under the control by the display control unit 50 on the basis of the instructions by the user via the input unit 60.

Further, on the display apparatus 1B according to the second embodiment, when the virtual image lenses 12 are each formed of the variable focus lens, it is also possible to individually control the focal lengths of the microlenses forming the variable focus lenses under the control by the display control unit 50. With this, the virtual image can be presented at distances different from position to position within the display screen, and depth perception can be partially produced with respect to the virtual image. In this way, the virtual image can be presented not as a two-dimensional image but as a three-dimensional image. This presentation differs from the case where the pupil of the observer is focused on the display unit 10 and a stereoscopic vision is produced by the left-right parallax. In other words, focusing in this presentation is performed not on the display unit 10 but on a three-dimensional position in a visible image.

Now, the display apparatus 1B according to the second embodiment is more specifically described. In the following description, a display apparatus according to the second embodiment, which presents a virtual image at a position more distant than the display surface of the display unit 10 is distant, is referred to as a display apparatus according to Embodiment A of the second embodiment. Another display apparatus according to the second embodiment, which presents a virtual image at a position less distant than the display surface of the display unit 10 is distant, is referred to as a display apparatus according to Embodiment B of the second embodiment.

(Display Apparatus According to Embodiment A of Second Embodiment)

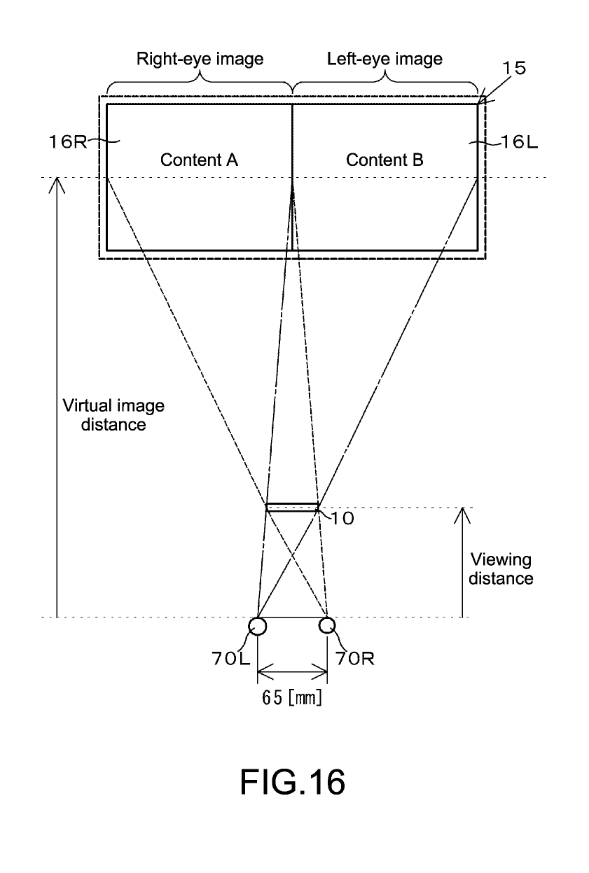

The display apparatus according to Embodiment A of the second embodiment is a virtual-image display apparatus that presents a virtual image at a position more distant than the display surface of the display unit 10 is distant. FIG. 16 is an explanatory view illustrating a virtual image presented by the display apparatus according to Embodiment A of the second embodiment. In FIG. 16, a light beam relating to the left eye 70L of the observer is indicated by one-dot chain lines, and a light beam relating to the right eye 70R of the observer is indicated by broken lines. Further, the distance between the left eye 70L and the right eye 70R of the observer (interocular) is assumed, for example, to be 65 [mm]. The same applies to Examples described below.

On the display apparatus according to Embodiment A of the second embodiment, the virtual image is presented by signal processes by the signal processing unit 40 in FIG. 13, and under the display control by the display control unit 50 in FIG. 13. In other words, the display control unit 50 drives the left-eye pixel 13L and the right-eye pixel 13R of the display unit 10 on the basis of the image information generated by the signal processing unit 40, thereby presenting, in accordance with the focal length and the viewing distance of the virtual image lenses 12, a virtual image 15 at a presentation position set as a position more distant than the display surface of the display unit 10 is distant.

More specifically, the signal processing unit 40 generates image information that causes a left side of the left-eye image and a right side of the right-eye image to be adjacent to each other. The display control unit 50 drives the left-eye pixel 13L and the right-eye pixel 13R on the basis of the image information generated by the signal processing unit 40, thereby presenting the virtual image 15 at the presentation position set as the position more distant than the display surface of the display unit 10 is distant. In other words, on the display apparatus according to Embodiment A of the second embodiment, the virtual image 15 is displayed on the left-eye screen 16L and the right-eye screen 16R being two screens adjacent to each other in the left-right direction.

It is possible to display an image of the same content on the two screens of the left-eye screen 16L and the right-eye screen 16R. Alternatively, it is possible to display images of different contents, for example, as illustrated in FIG. 16, display an image of a content A on the right-eye screen 16R, and display an image of a content B on the left-eye screen 16L. As a display example of the latter case, it is conceivable to display, on the left-eye screen 16L, image information such as map information including a designated point with highlighting, and to display, on the right-eye screen 16R, image information such as weather forecast for each time zone at the designated point, or image information such as dining/restaurant information at the designated point.

Display pixels of the virtual image 15 with respect to the left eye 70L and the right eye 70R of the observer, the resolution limit of the human eye with respect to the gaps corresponding to one pixel between the pixel columns of the left-eye screen and the right-eye screen, and the pixel dimension are basically the same as those in the case of the display apparatus 1A according to the first embodiment described with reference to FIG. 11A to FIG. 12B.

As described above, the display apparatus according to Embodiment A of the second embodiment is a virtual-image display apparatus that includes a distant-display optical system that presents the virtual image 15 at a position more distant from the observer than the display surface of the display unit 10 is distant, in which the apertures 91 and the virtual image lenses 12 are arranged in an array in the units of adjacent even-number pixels including the left-eye pixel and the right-eye pixel. Further, the display apparatus enables the observer to view, with both the eyes with respect to the screen of the single display unit 10, the virtual image 15 at a position more distant than the display surface of the display unit 10 is distant. With this, a need for wearing an eyeglass-type display such as a head-mounted display on one's head is eliminated, thereby making it possible to reduce burden and labor on the observer (user).

Further, although it is difficult for observers who are far-sighted or weak-sighted from aging to view a screen on hand, the display apparatus according to Embodiment A of the second embodiment enables even such observers who are far-sighted or weak-sighted from aging to focus on the display screen of the virtual image by virtual image viewing, specifically, by shifting the focus position formed by the lenses of the eyeballs to a position more distant than the display surface of the display unit 10 is distant.

Further, the display apparatus according to Embodiment A of the second embodiment enables the virtual image to be presented separately to the left and right eyes 70L and 70R, that is, the virtual images to be presented side by side in the left-right direction. With this, it is possible to laterally widen a display area. For example, different images that are independent of and do not overlap with each other with respect to the whole display image can be presented as the virtual images to the left and right eyes 70L and 70R. In addition, as is clear from the illustrations in FIG. 11A and FIG. 11B, the total number of the pixels of the left-eye screen 16L and the right-eye screen 16R that display the virtual image 15 is equal to the number of pixels of the display unit 10. Thus, it is possible to present a virtual image having the laterally twice area of display. In other words, with respect to each of the left and right eyes 70L and 70R, the number of pixels in the horizontal direction is half the number of pixels of the display unit 10, and the number of pixels in the vertical direction is equal to the number of pixels of the display unit 10. With this, the vertical density is twice as high as the horizontal density in the virtual image displayed on the left-eye screen 16L and the right-eye screen 16R. Thus, it is possible to smoothly display the image in the vertical direction and to double the luminance.

Meanwhile, on a display apparatus, even when the pixel dimension (pixel pitch) is miniaturized to the level of human eyesight resolution or higher, due to the human eyesight resolution, this level of miniaturization does not come into action. Thus, it is impossible to obtain high-definition information. In contrast, on the display apparatus according to Embodiment A of the second embodiment, the pixels of the display unit 10, which are presented to the left and right eyes 70L and 70R, are used alternately in the horizontal direction of the pixel array for the right eye and the left eye. Thus, the pixels of the display unit 10, which are observed exclusively with the right eye, do not include pixels for the left eye when being displayed. However, when a gap corresponding to the non-displayed pixel is approximately at the level of eyesight resolution, it is impossible to discern the gap between adjacent ones of the display pixels. Thus, the pixel dimension may be reduced to approximately a level of half the eyesight resolution. As a result, it is possible to increase the number of pixels that can be displayed as a virtual image even when the screen size of the display unit 10 is unchanged.

Now, specific examples of a case where the display apparatus according to Embodiment A of the second embodiment is used as a display apparatus of an electronic apparatus, specifically, as a display apparatus of the mobile electronic apparatus are described. On the display apparatus according to Embodiment A of the second embodiment, when the presentation position of a virtual image with respect to the observer is more distant than the display unit 10 is distant, the virtual image is presented at the virtual-image presentation position such that the left side of the left-eye image and the right side of the right-eye image are adjacent to or overlap with each other. The information of the virtual image is generated by the signal processing unit 40. Note that, the “adjacent” herein encompasses the case where there is a gap between the left side of the left-eye image and the right side of the right-eye image.

### Example 10

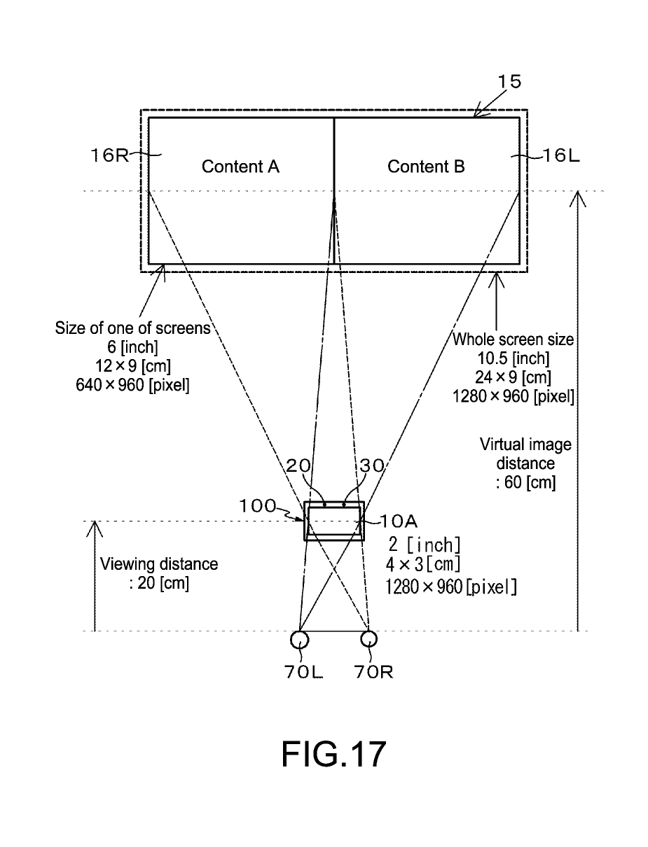

Example 10 is an example in which the display apparatus according to Embodiment A of the second embodiment is used as a display apparatus of a wristwatch-type terminal being an example of the electronic apparatuses. FIG. 17 is an explanatory view illustrating a virtual image presented by a display apparatus according to Example 10.

In FIG. 17, a display unit 10A of a wristwatch-type terminal 100 corresponds to the display unit 10 in FIG. 13. As illustrated in FIG. 17, the imaging unit 20 and the distance measurement unit 30 in FIG. 13 are arranged at a peripheral portion of the display unit 10A of the wristwatch-type terminal 100. The signal processing unit 40 and the display control unit 50 in FIG. 13 are incorporated, in a form of an IC, for example, into the wristwatch-type terminal 100.

The left-eye pixel 13L and the right-eye pixel 13R of the display unit 10A of the wristwatch-type terminal 100 are driven by the signal processes by the signal processing unit 40 and under the display control by the display control unit 50. With this, the virtual image 15 is presented at the virtual-image presentation position that is determined in accordance with the focal length and the viewing distance of the virtual image lenses 12. More specifically, on the display apparatus according to Example 10, the virtual image 15 is presented on the two screens of the left-eye screen 16L and the right-eye screen 16R. The left-eye screen 16L and the right-eye screen 16R are configured such that the two screens are in contact with each other at this time so as to be continuous in the left-right direction.

It is possible to present a virtual image of the same content on the two screens of the left-eye screen 16L and the right-eye screen 16R. Alternatively, it is possible to present virtual images of different contents, for example, as illustrated in FIG. 17, present a virtual image of the content A on the right-eye screen 16R, and present a virtual image of the content B on the left-eye screen 16L. As a display example of the latter case, it is conceivable to present, on the left-eye screen 16L, a virtual image of a map including a designated point with highlighting, and to present, on the right-eye screen 16R, a virtual image such as weather forecast for each time zone at the designated point, or a virtual image of, for example, dining/restaurant information at the designated point.

Now, an example of device specifications of the display unit 10A of the wristwatch-type terminal 100 is described. The display unit 10A of the wristwatch-type terminal 100 is assumed to have a screen size of 2 [inch], with 4 [cm] in width and 3 [cm] in height, with the number of pixels being 1280 [pixel] in width and 960 [pixel] in height. Further, the pixel pitch (pixel dimension) is assumed to be 31 [um], with the pitch of each of the virtual image lenses 12 being 61 [um].

Under this device specification, it is assumed that, when the viewing distance being the distance from the observer to the display unit 10A is, for example, 20 [cm], the virtual image distance being the distance from the observer to the presentation position of the virtual image 15 is set, for example, to 60 [cm]. In this case, at the presentation position at the virtual image distance of 60 [cm], the virtual image 15 is displayed on the two screens of the left-eye screen 16L and the right-eye screen 16R each having a screen size of 6 [inch], with 12 [cm] in width and 9 [cm] in height, with the number of pixels being 640 [pixel] in width and 960 [pixel] in height.

In other words, on each of the two screens that display the virtual image 15, with respect respectively to the left and right eyes 70L and 70R, the number of pixels in the horizontal direction is half the number of pixels of the display unit 10A, and the number of pixels in the vertical direction is equal to the number of pixels of the display unit 10A. Further, a screen size of a whole screen of the two screens is 10.5 [inch], with 24 [cm] in width and 9 [cm] in height, with the number of pixels being 1280 [pixel] in width and 960 [pixel] in height. In other words, the whole screen of the two screens uses all the pixels of the display unit 10A. A display resolution of the virtual image corresponds to a resolution four times as high as a resolution of a video graphics array (VGA).

As described above, with the display apparatus according to Example 10, the virtual image 15 can be displayed at a presentation position more distant than the display unit 10A of the wristwatch-type terminal 100 is distant. Thus, it is possible to reduce eye strain that is caused by observing a screen on hand at a short distance. The screen size of the display unit 10A of the wristwatch-type terminal 100 is physically restricted to the size up to approximately two inches in consideration of wearability, and in accordance therewith, contents to be displayed thereon are also restricted. Even under such restrictions, with the display apparatus according to Example 1, it is possible to display, by virtual image display, the image (virtual image) having an enlarged screen size at a position more distant than the display unit 10A is distant, and hence to present a large amount of information.

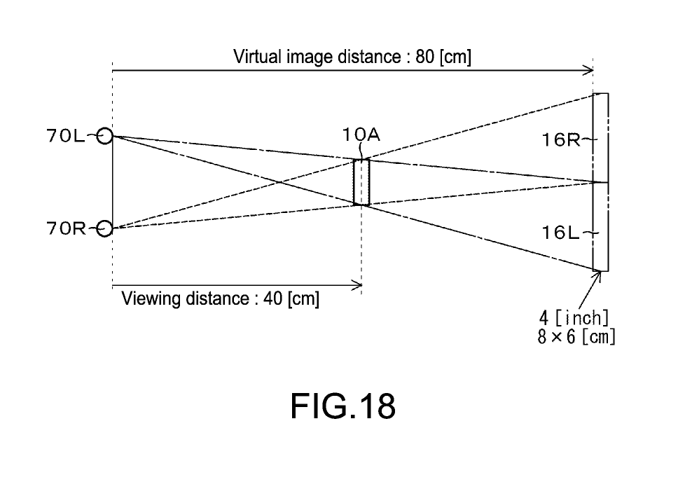

With the display apparatus according to Example 10, by changing the viewing distance from the observer to the display unit 10A, it is possible to change the virtual image distance up to the presentation position at which the virtual image 15 is presented, and to change the screen size of the two screens of the left-eye screen 16L and the right-eye screen 16R. As illustrated in FIG. 18, by setting the viewing distance to 40 [cm], it is possible to display, at a presentation position at a virtual image distance of 80 [cm], the virtual image 15 on the left-eye screen 16L and the right-eye screen 16R each having a screen size of 4 [inch], with 8 [cm] in width and 6 [cm] in height. In either one of the cases, the display unit 10A has the screen size of 2 [inch], with 4 [cm] in width and 3 [cm] in height.

### Example 11

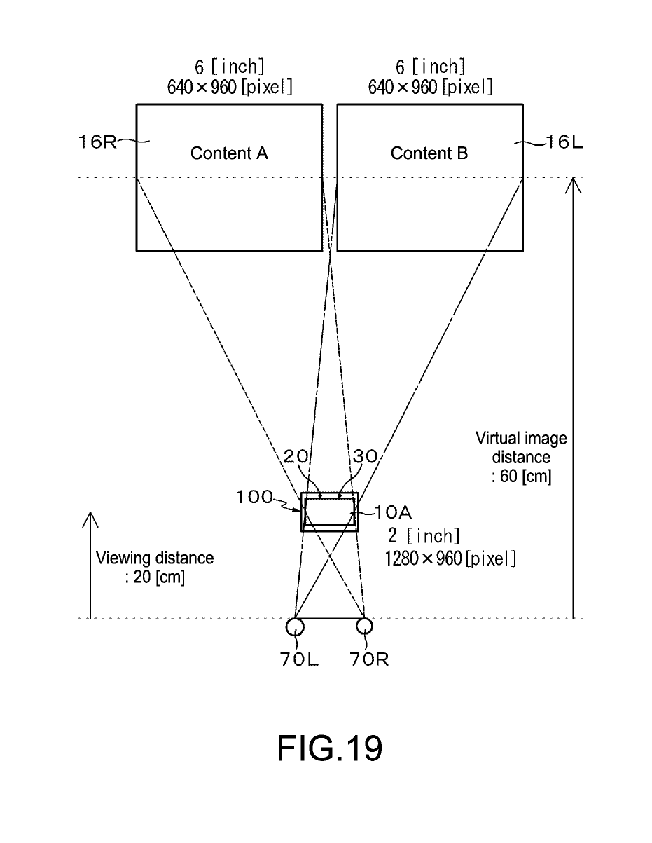

Example 11 is a modification example of Example 10. FIG. 19 is an explanatory view illustrating a virtual image presented by the display apparatus according to Example 11.

On the display apparatus according to Example 10, the left-eye screen 16L and the right-eye screen 16R are configured such that the two screens are in contact with each other so as to be continuous in the left-right direction. In contrast, as illustrated in FIG. 19, on the display apparatus according to Example 11, the left-eye screen 16L and the right-eye screen 16R are configured such that the two screens have a space therebetween so as to be divided in the left-right direction.

Now, another example of the device specifications of the display unit 10A of the wristwatch-type terminal 100 is described. The display unit 10A of the wristwatch-type terminal 100 is assumed to have the screen size of 2 [inch], with 4 [cm] in width and 3 [cm] in height, with the number of pixels being 1280 [pixel] in width and 960 [pixel] in height. Further, the pixel pitch (pixel dimension) is assumed to be 31 [um], with the pitch of each of the virtual image lenses 12 being 61 [um]. Under this device specification, when the viewing distance is, for example, 20 [cm], the virtual image distance is set, for example, to 60 [cm]. In this case, at the presentation position at the virtual image distance of 60 [cm], the virtual image 15 is displayed on the two screens each having the screen size of 6 [inch], with the number of pixels being 640 [pixel] in width and 960 [pixel] in height.

As described above, with the display apparatus according to Example 11, the virtual image can be presented on the two screens obtained by dividing the left-eye screen 16L and the right-eye screen 16R in the left-right direction. With this, although display of the same content on the two screens of the left-eye screen 16L and the right-eye screen 16R is not expected, information items of different (two types of) contents A and B can be simultaneously displayed thereon. Also in this case, all the pixels of the display unit 10A are used by the two screens.

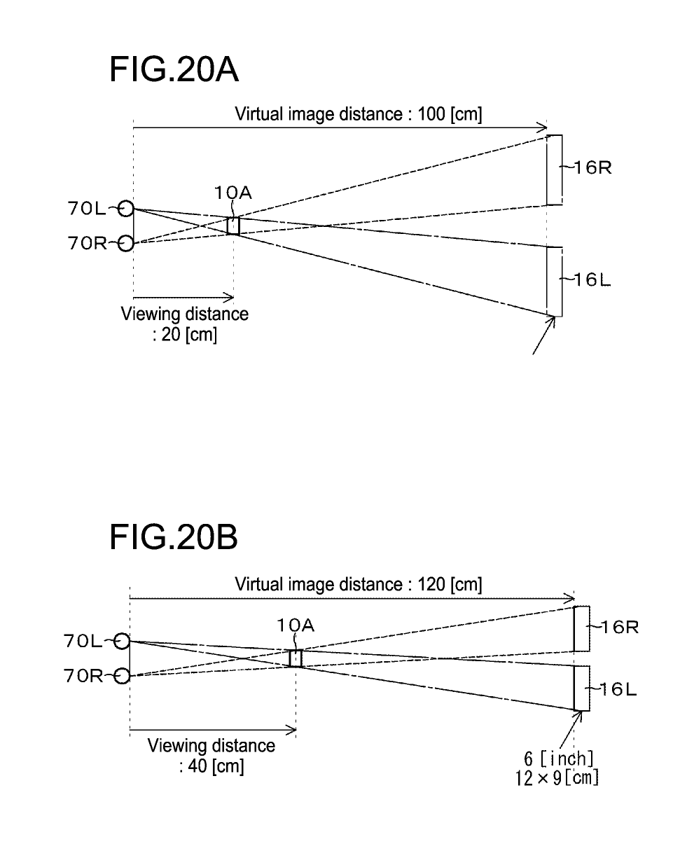

On the display apparatus according to the modification example of Example 11, even when the viewing distance is unchanged, it is possible to change the sizes of the two screens divided in the left-right direction by changing the virtual image distance through changing of the focal length of the virtual image lenses 12. For example, as illustrated in FIG. 20A, when the viewing distance is 20 [cm], by setting the virtual image distance to 100 [cm], it is possible to display the virtual image 15 on the left-eye screen 16L and the right-eye screen 16R having a screen size of 10 [inch], with 20 [cm] in width and 15 [cm] in height.

Further, by changing the viewing distance, it is possible to change the virtual image distance, and the screen size of the left-eye screen 16L and the right-eye screen 16R. For example, as illustrated in FIG. 20B, by setting the viewing distance to 40 [cm], it is possible to display, at a presentation position at a virtual image distance of 120 [cm], the virtual image 15 on the left-eye screen 16L and the right-eye screen 16R each having the screen size of 6 [inch], with 12 [cm] in width and 9 [cm] in height. In either one of the cases, the display unit 10A has the screen size of 2 [inch], with 4 [cm] in width and 3 [cm] in height.

### Example 12

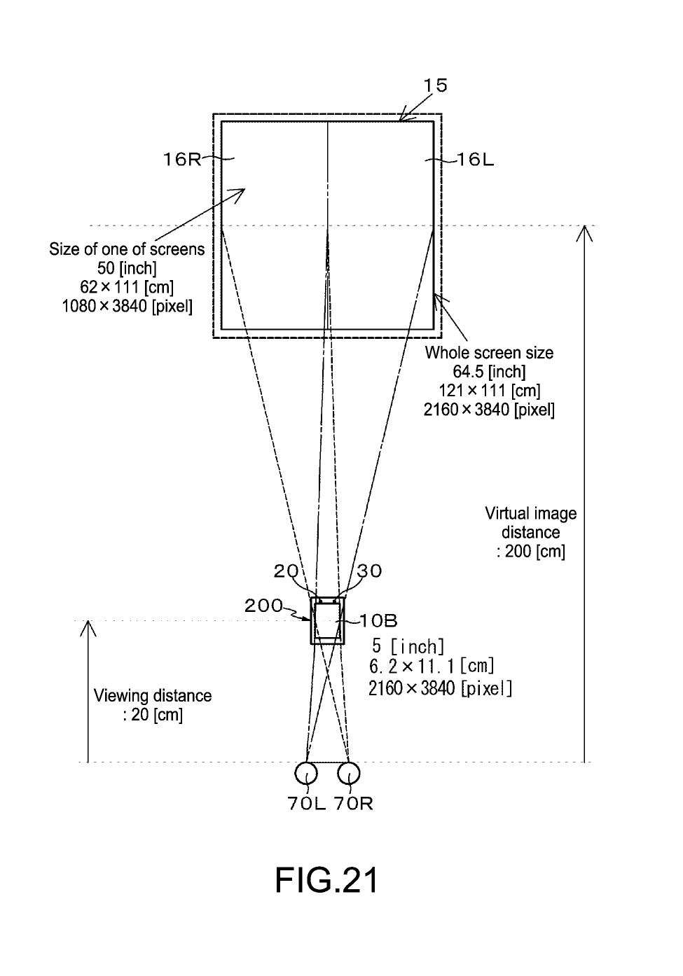

Example 12 is an example in which the display apparatus according to Embodiment A of the second embodiment is used as a display apparatus of mobile terminals such as a feature phone and a smartphone, which are examples of the electronic apparatuses. FIG. 21 is an explanatory view illustrating a virtual image presented by a display apparatus according to Example 12.

In FIG. 21, a display unit 10B of a mobile terminal 200 corresponds to the display unit 10 in FIG. 13. As illustrated in FIG. 21, the imaging unit 20 and the distance measurement unit 30 in FIG. 13 are arranged at a peripheral portion of the display unit 10B of the mobile terminal 200. The signal processing unit 40 and the display control unit 50 in FIG. 13 are incorporated, in a form of an IC, for example, into the mobile terminal 200.

Now, an example of device specifications of the display unit 10B of the mobile terminal 200 is described. The display unit 10B of the mobile terminal 200 is assumed to have a vertically long screen, having a screen size of 5 [inch], with 6.2 [cm] in width and 11.1 [cm] in height, with the number of pixels being 2160 [pixel] in width and 3840 [pixel] in height. Further, the pixel pitch (pixel dimension) is assumed to be 29 [um], with the pitch of each of the virtual image lenses 12 being 59 [um].

Under this device specification, it is assumed that, when the viewing distance being the distance from the observer to the display unit 10B is, for example, 20 [cm], the virtual image distance being the distance from the observer to the virtual-image presentation position is set, for example, to 200 [cm]. In this case, at the presentation position at the virtual image distance of 200 [cm], the virtual image 15 is displayed on the two screens of the left-eye screen 16L and the right-eye screen 16R each having a screen size of 50 [inch], with 62 [cm] in width and 111 [cm] in height, with the number of pixels being 1080 [pixel] in width and 3840 [pixel] in height.

In other words, on each of the two screens that display the virtual image 15, with respect respectively to the left and right eyes 70L and 70R, the number of pixels in the horizontal direction is half the number of pixels of the display unit 10B, and the number of pixels in the vertical direction is equal to the number of pixels of the display unit 10B. Further, a screen size of a whole screen of the two screens is 64.5 [inch], with 121 [cm] in width and 111 [cm] in height, with the number of pixels being 2160 [pixel] in width and 3840 [pixel] in height. In other words, the whole screen of the two screens uses all the pixels of the display unit 10B. A display resolution of the virtual image corresponds to a resolution of 4K.

Further, with respect to the viewing distance of 20 [cm], the virtual image (two screens) is enlarged when the screen of the display unit 10B of the mobile terminal 200 is brought closer to the observer, and in contrast, the virtual image is downsized when the screen is separated away from the observer. Under the above-described device specification, when the viewing distance is reduced, for example, to 15 [cm], the virtual image 15 is displayed at a presentation position at a virtual image distance of 195 [cm] on two screens each having a screen size of 65 [inch], with 81 [cm] in width and 144 [cm] in height. A screen size of a whole screen of the two screens is 84 [inch], with 159 [cm] in width and 144 [cm] in height. In contrast, when the viewing distance is increased, for example, to 30 [cm], the virtual image 15 is displayed at a presentation position at a virtual image distance of 210 [cm] on two screens each having a screen size of 35 [inch], with 44 [cm] in width and 78 [cm] in height. A screen size of a whole screen of the two screens is 45 [inch], with 83 [cm] in width and 78 [cm] in height.

As described above, with the display apparatus according to Example 12, the virtual image 15 can be displayed at a presentation position more distant than the display unit 10B of the mobile terminal 200 is distant. Thus, it is possible to reduce eye strain on the observer. Specifically, by virtual image viewing, that is, by shifting the focus position formed by the lenses of the eyeballs to a position more distant than the display surface of the display unit 10B is distant, it is possible to reduce eye strain on the observer, which is caused by observation of a screen on hand at a short distance, such as the display unit 10B of the mobile terminal 200.

In particular, in the case of the mobile terminal 200 such as a feature phone and a smartphone, when the observer in motion views the screen of the display unit 10B, the observer's focus shifts to his/her hand, and hence it is difficult for the observer to grasp a surrounding situation. In contrast, with the display apparatus according to Example 12, even when viewing the screen of the display unit 10B, the observer focuses on a distant position, and hence it is easy for the observer to grasp the surrounding situation.

Further, the screen size of the display unit 10B of the mobile terminal 200 is physically restricted to the size up to approximately five inches in consideration of portability, and in accordance therewith, contents to be displayed thereon are also restricted. Even under such restrictions, with the display apparatus according to Example 12, it is possible to display, by virtual image display, the image (virtual image) having an enlarged screen size at a position more distant than the display unit 10B is distant. In particular, it is possible to display the virtual image with a large number of pixels that exceeds the eyesight limitation (1920×1080), and hence to significantly increase the amount of information to be presented.

On the mobile terminal 200, the display unit 10B is typically used as a vertically long screen. Thus, information extending in the horizontal direction is wrapped to the next line. A horizontally long photograph is restricted in horizontal width, and hence is displayed with unusable black portions on its upper and lower sides. As a result, the photograph is viewed on a small screen. In contrast, with the display apparatus according to Example 12, by virtual image display, it is possible to display the image (virtual image) in a horizontally wide screen size at a position more distant than the display unit 10B is distant. Thus, it is possible to significantly increase a degree of freedom in displaying the contents.

### Example 13

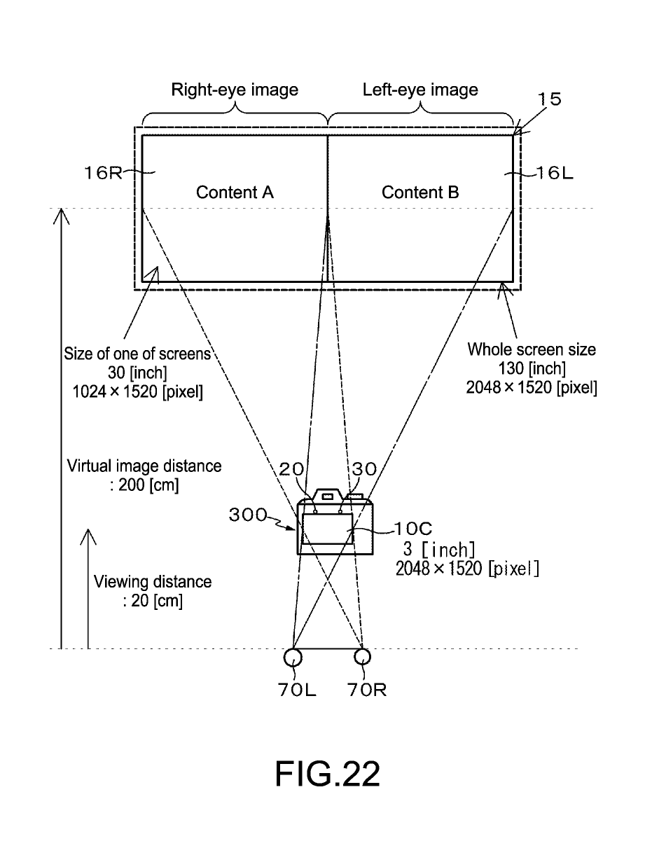

Example 13 is an example in which the display apparatus according to Embodiment A of the second embodiment is used as a display apparatus of camera apparatuses such as a still camera and a camcorder, which are examples of the electronic apparatuses. FIG. 22 is an explanatory view illustrating a virtual image presented by a display apparatus according to Example 13.

In FIG. 22, a display unit 10C of a camera apparatus 300 corresponds to the display unit 10 in FIG. 13. As illustrated in FIG. 22, the imaging unit 20 and the distance measurement unit 30 in FIG. 13 are arranged at a peripheral portion of the display unit 10C of the camera apparatus 300. The signal processing unit 40 and the display control unit 50 in FIG. 13 are incorporated, in a form of an IC, for example, into the camera apparatus 300.

Now, an example of device specifications of the display unit 10C of the camera apparatus 300 is described. The display unit 10C of the camera apparatus 300 is assumed to have a screen size of 3 [inch], with 6.1 [cm] in width and 4.6 [cm] in height, with the number of pixels being 2048 [pixel] in width and 1520 [pixel] in height. Further, the pixel pitch (pixel dimension) is assumed to be 30 [um], with the pitch of each of the virtual image lenses 12 being 60 [um].

Under this device specification, it is assumed that, when the viewing distance being the distance from the observer to the display unit 10C is, for example, 20 [cm], the virtual image distance being the distance from the observer to the virtual-image presentation position is set, for example, to 200 [cm]. In this case, at the presentation position at the virtual image distance of 200 [cm], the virtual image 15 is displayed on the two screens of the left-eye screen 16L and the right-eye screen 16R each having a screen size of 6 [inch], with 12 [cm] in width and 9 [cm] in height, with the number of pixels being 1024 [pixel] in width and 1520 [pixel] in height.

In other words, on each of the two screens that display the virtual image 15, with respect respectively to the left and right eyes 70L and 70R, the number of pixels in the horizontal direction is half the number of pixels of the display unit 10C, and the number of pixels in the vertical direction is equal to the number of pixels of the display unit 10C. Further, a screen size of a whole screen of the two screens is 51 [inch], with the number of pixels being 2480 [pixel] in width and 1520 [pixel] in height. In other words, the whole screen of the two screens uses all the pixels of the display unit 10C.

As described above, with the display apparatus according to Example 13, it is possible to present the virtual image on the left-eye screen 16L and the right-eye screen 16R as the two screens adjacent to each other in the left-right direction. With this, it is possible to simultaneously display information items of different (two types of) contents A and B on the two screens of the left-eye screen 16L and the right-eye screen 16R. It is preferred that the camera apparatus 300 such as a still camera and a camcorder display, for example, an image of a subject on the right-eye screen 16R, and display imaging conditions such as a shutter speed and a histogram on the left-eye screen 16L. By utilizing horizontally expanded two-screen display in this way, that is, by displaying the imaging conditions such as a shutter speed and a histogram in a vicinity of the image of the subject, a photographer can perform imaging under optimum conditions while checking the imaging conditions.

The camera apparatus 300 such as a still camera and a camcorder performs operation to determine composition of the subject in imaging. At this time, the eye focuses on a distant position when viewing the subject, and hence the screen of the display unit 10C of the camera apparatus 300 on a near side blurs. In contrast, when the composition is determined while the screen on the display unit 10C is viewed, the focus is on the display unit 10C, and hence the subject blurs. With the display apparatus according to Example 13, it is possible to focus on both the subject and the display unit 10C, and hence to easily determine the composition of the subject in imaging.

Further, with the display apparatus according to Example 13, the virtual image 15 can be displayed at a presentation position more distant than the display unit 10C of the camera apparatus 300 is distant. Thus, it is possible to reduce eye strain on the observer. Specifically, by virtual image viewing, that is, by shifting the focus position formed by the lenses of the eyeballs to a position more distant than the display surface of the display unit 10C is distant, it is possible to reduce eye strain on the observer, which is caused by observation of a screen on hand at a short distance, such as the display unit 10C of the camera apparatus 300.

Examples 10 to 13 described above are examples in which the left-eye screen 16L that presents the left-eye image (virtual image) and the right-eye screen 16R that presents the right-eye image (virtual image) are arranged as two adjacent (continuous) screens in the left-right direction, or two divided screens in the left-right direction. In other words, in Examples 10 to 13, the left-eye image and the right-eye image do not overlap with each other in the left-right direction. However, the display apparatus according to Embodiment A of the second embodiment is not limited to this configuration, and may cause the left-eye image and the right-eye image to overlap with each other in the left-right direction. Now, a specific example of the case where the left-eye image and the right-eye image overlap with each other in the left-right direction is described.

### Example 14

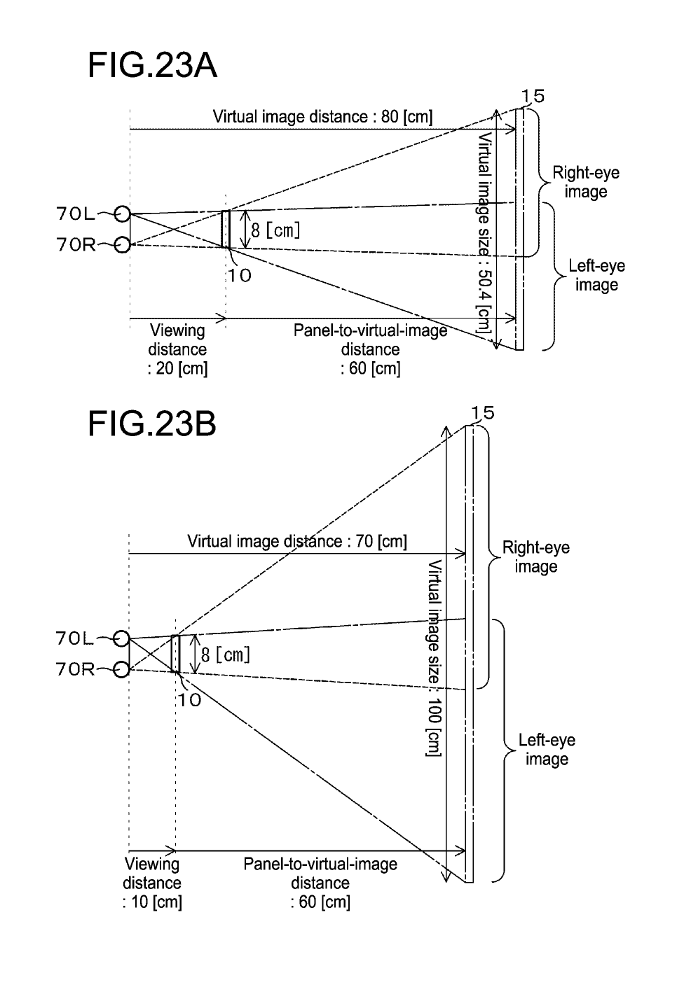

Example 14 is an example in which a distant-display optical system, which presents a virtual image at a position more distant than the display surface of the display unit 10 (refer to FIG. 16) is distant, uses a fixed focus, that is, an example in which the virtual image lenses 12 are each formed of a fixed focus lens. FIG. 23A and FIG. 23B are explanatory views each illustrating a virtual image presented by a display apparatus according to Example 14. FIG. 23A illustrates a case where the viewing distance is 20 [cm]. FIG. 23B illustrates a case where the viewing distance is 10 [cm]. The size of the screen of the display unit 10 in the horizontal direction (row direction) (hereinafter, referred to as “panel size”) is 8 [cm], for example. Further, the virtual image 15 is indicated by two-dot chain lines. The same applies to Examples described below.

First, the case of FIG. 23A where the viewing distance is 20 [cm] is described by way of an example in which the virtual image distance is set to 80 [cm]. This virtual image distance is determined in accordance with the focal length of the virtual image lenses 12, that is, the focal length of the fixed focus lenses. In this case, by the signal processes by the signal processing unit 40 shown in FIG. 13, and under the display control by the display control unit 50 shown in FIG. 13, the virtual image 15 is presented at the presentation position at the virtual image distance of 80 [cm]. More specifically, the signal processing unit 40 generates image information that allows a part of the left side of the left-eye image and a part of the right side of the right-eye image to overlap with each other, and the display control unit 50 drives the left-eye pixel 13L and the right-eye pixel 13R on the basis of the image information. With this, the virtual image 15 is presented at the presentation position at the virtual image distance of 80 [cm].

When the panel size is 8 [cm], under the setting conditions that the viewing distance is 20 [cm] and the virtual image distance is 80 [cm], a virtual image having a virtual image size of 50.4 [cm] is presented at the presentation position at this virtual image distance under the state in which the part of the left side of the left-eye image and the part of the right side of the right-eye image overlap with each other. The virtual image size herein refers to the size of the virtual image 15 in the left-right direction (horizontal direction/lateral direction). At this time, the distance from the display unit 10 to the virtual-image presentation position (hereinafter, referred to as “panel-to-virtual-image distance”) is 60 [cm] (=virtual image distance of 80 [cm]−viewing distance of 20 [cm]).

Note that, in a region where the part of the left side of the left-eye image and the part of the right side of the right-eye image overlap with each other, it is preferred that either one of the left-eye image and the right-eye image be displayed, or the left-eye image and the right-eye image be displayed after being subjected to interpolation processes. With this, it is possible to suppress occurrence of such phenomena that double images are displayed in the region where the part of the left side of the left-eye image and the part of the right side of the right-eye image overlap with each other, and that luminance becomes higher than those in other regions. The same applies to Examples described below.

Next, the case of FIG. 23B where the viewing distance is 10 [cm] is described. In contrast to the state of FIG. 23A in which the viewing distance is 20 [cm], under a state of FIG. 23B, the viewing distance is changed from 20 [cm] to 10 [cm]. By changing the viewing distance from 20 [cm] to 10 [cm], the virtual image 15 having a virtual image size of 100 [cm] is presented at a presentation position at a virtual image distance of 70 [cm]. The panel-to-virtual-image distance at this time is 60 [cm] (=virtual image distance of 70 [cm]−viewing distance of 10 [cm]), which is equal to that in the case where the viewing distance is 20 [cm].

With the above-described display apparatus according to Example 14, it is possible to change the virtual image size from that under the state of FIG. 23A to that under the state of FIG. 23B or vice versa merely by changing the viewing distance without adjusting the image information (display image information) for driving the display unit 10. Thus, when the display apparatus is used as a display apparatus of electronic apparatuses including a wristwatch-type terminal, mobile terminals such as a feature phone and a smartphone, or camera apparatuses such as a still camera and a camcorder, it is possible to change the virtual image size merely by changing at which distance the observer holds these terminals (apparatuses) in his/her hand, that is, a hand-holding distance. As a result, it is possible to display the virtual image in an easy-to-view size.

### Example 15

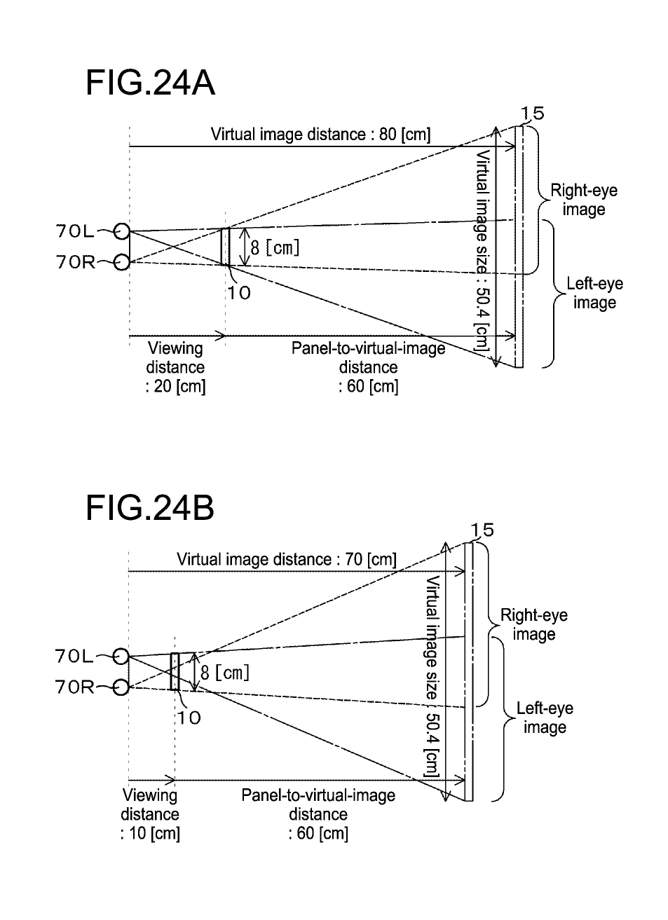

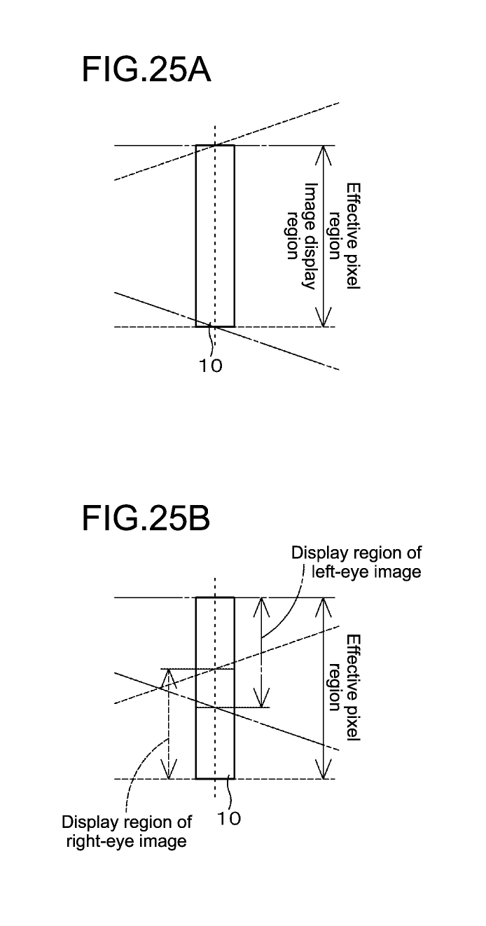

Example 15 is a modification example of Example 14. FIG. 24A and FIG. 24B are explanatory views each illustrating a virtual image presented by a display apparatus according to Example 15. Example 15 is an example in which the distant-display optical system uses a fixed focus and the virtual image size is fixed. FIG. 25A illustrates a case where the viewing distance is 20 [cm]. FIG. 24B illustrates a case where the viewing distance is 10 [cm].

The state of FIG. 24A is the same as the state of FIG. 23A. In other words, under the state of FIG. 24A, under the setting conditions that the viewing distance is 20 [cm] and the virtual image distance is 80 [cm], the virtual image 15 having the virtual image size of 50.4 [cm] is presented at the presentation position at this virtual image distance under the state in which the part of the left side of the left-eye image and the part of the right side of the right-eye image overlap with each other.

In contrast, under the state of FIG. 24B, that is, even under the state in which the viewing distance is changed from 20 [cm] to 10 [cm], the virtual image 15 having the same virtual image size of 50.4 [cm] is presented at the presentation position at the virtual image distance of 70 [cm]. In order to fix the virtual image size regardless of the viewing distance in this way, it is necessary to adjust, in accordance with the viewing distance, an image display range with respect to an effective pixel region in the left-right direction on the display unit 10. The “effective pixel region” herein represents a region of pixels that contribute to presentation (display) of the virtual image 15.

Specifically, under the state illustrated in FIG. 24A, as illustrated in FIG. 25A, the whole effective pixel region in the left-right direction on the display unit 10 is used as an image display range for both the left-eye image and the right-eye image. Under the state illustrated in FIG. 24B, as illustrated in FIG. 25B, a predetermined range from a left end of the effective pixel region on the display unit 10 is used as an image display range for the left-eye image, and a predetermined range from a right end of the effective pixel region on the display unit 10 is used as an image display range for the right-eye image. In other words, a non-image display region of the left-eye image is provided at a part on the right end side of the effective pixel region on the display unit 10, and a non-image display region of the right-eye image is provided at a part on the left end side of the effective pixel region on the display unit 10. Then, by adjusting the image display range in accordance with the viewing distance, the virtual image distance changes from 80 [cm] to 70 [cm] even when the distant-display optical system uses a fixed focus. Thus, it is possible to fix the virtual image size.

With the above-described display apparatus according to Example 15, even when the viewing distance is changed from that under the state of FIG. 24A to that under the state of FIG. 24B or vice versa, it is possible to present the virtual image 15 under the state in which the virtual image size is fixed. Thus, in the case where the display apparatus is used as the display apparatuses of a wristwatch-type terminal, mobile terminals such as a feature phone and a smartphone, or camera apparatuses such as a still camera and a camcorder, even when a hand-holding distance of these terminals (apparatuses) changes, the virtual image size is not changed. As a result, it is possible to avoid troubles such as becoming sick from blur at the hand-holding distance.

### Example 16

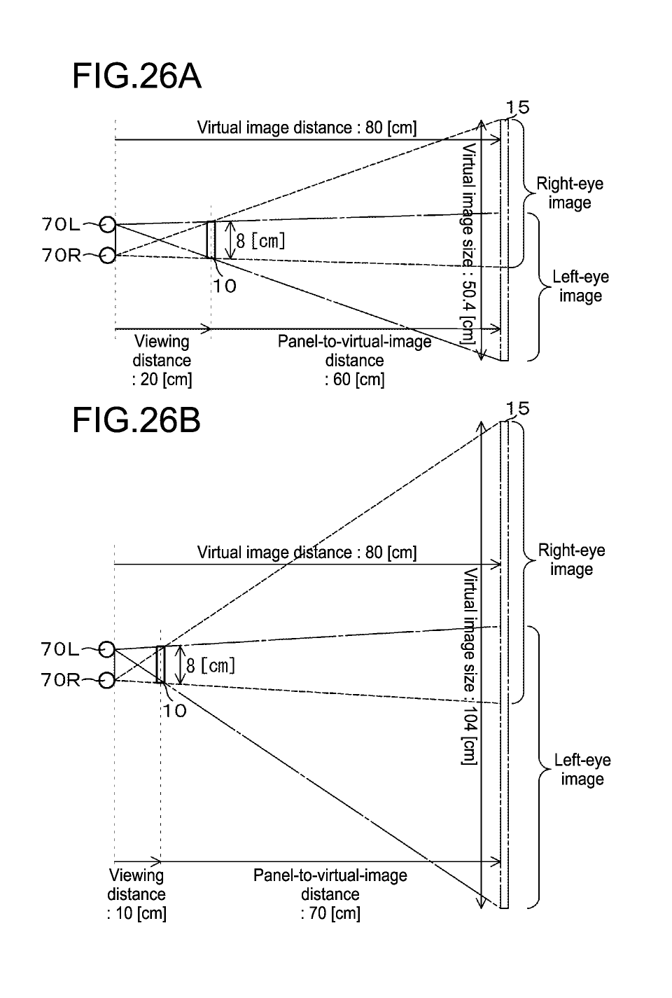

Example 16 is an example in which the distant-display optical system, which presents a virtual image at a position more distant than the display surface of the display unit 10 (refer to FIG. 5) is distant, uses a variable focus, that is, an example in which the virtual image lenses 12 are each formed of a variable focus lens. FIG. 26A and FIG. 26B are explanatory views each illustrating a virtual image presented by a display apparatus according to Example 16. FIG. 26A illustrates a case where the viewing distance is 20 [cm]. FIG. 26B illustrates a case where the viewing distance is 10 [cm].

The state of FIG. 26A is the same as the state of FIG. 23A. In other words, under the state of FIG. 26A, under the setting conditions that the viewing distance is 20 [cm] and the virtual image distance is 80 [cm], the virtual image 15 having the virtual image size of 50.4 [cm] is presented (displayed) at the presentation position at this virtual image distance under the state in which the part of the left side of the left-eye image and the part of the right side of the right-eye image overlap with each other. The presentation position at the virtual image distance of 80 [cm] is determined in accordance with the focal length of the virtual image lenses 12, that is, the focal length of the variable focus lens.

The state of FIG. 26B is a state in which the viewing distance is 10 [cm]. Adjustment of the focal length of the virtual image lenses 12, that is, the focal length of the variable focus lenses is performed such that the virtual image distance is 80 [cm], which is the same as that under the state of FIG. 26A. As shown in FIG. 13, this adjustment is performed under the control by the display control unit 50 on the basis of the instructions from the observer via the input unit 60. With this, the virtual image 15 having a virtual image size of 104 [cm] is presented at the presentation position at the virtual image distance of 80 [cm]. The panel-to-virtual-image distance at this time is 70 [cm] (=virtual image distance of 80 [cm]−viewing distance of 10 [cm]).

With the above-described display apparatus according to Example 16, it is possible to change the virtual image size from that under the state of FIG. 26A to that under the state of FIG. 26B or vice versa merely by changing the viewing distance without adjusting the image information for driving the display unit 10. Thus, when the display apparatus is used as a display apparatus of electronic apparatuses including a wristwatch-type terminal, mobile terminals such as a feature phone and a smartphone, or camera apparatuses such as a still camera and a camcorder, it is possible to change the virtual image size merely by changing the hand-holding distance of these terminals (apparatuses).

In addition, in the display apparatus according to Example 16, the distant-display optical system uses a variable focus, that is, the virtual image lenses 12 are each formed of a variable focus lens, and its focal length is adjustable. Thus, the virtual image distance determined in accordance with the focal length can be adjusted to be kept constant in accordance with the viewing distance. Thus, it is possible to display the virtual image with easy-to-view dimensions (size) while keeping constant (or under a state of keeping constant) the virtual image distance.

### Example 17

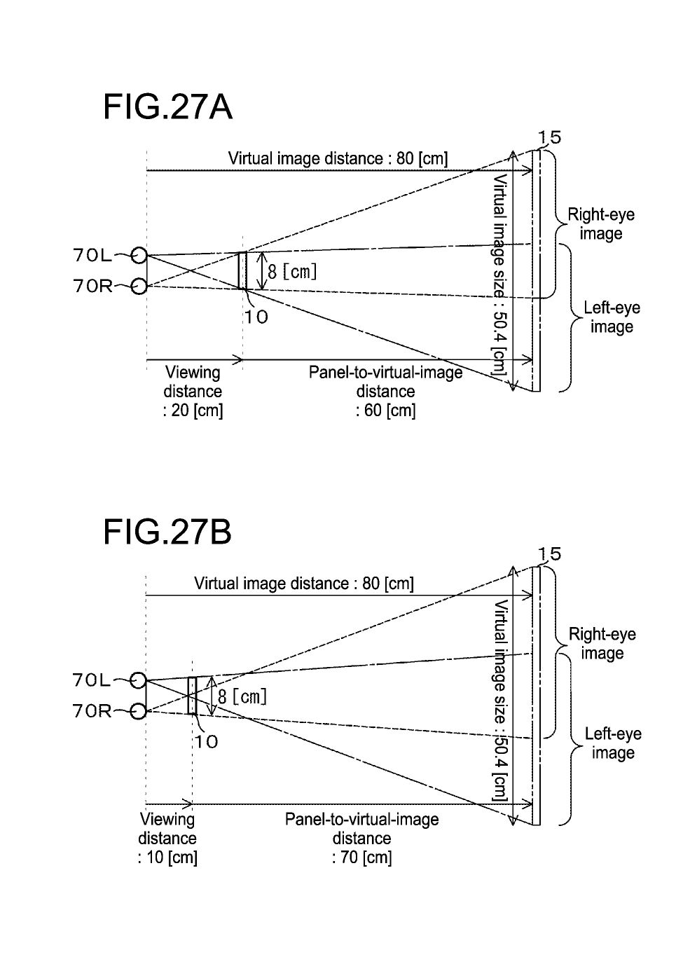

Example 17 is a modification example of Example 16, in which the distant-display optical system uses the variable focus and the virtual image size is fixed. FIG. 27A and FIG. 27B are explanatory views each illustrating a virtual image presented by a display apparatus according to Example 17. FIG. 27A illustrates a case where the viewing distance is 20 [cm]. FIG. 27B illustrates a case where the viewing distance is 10 [cm].

The state of FIG. 27A is the same as the state of FIG. 23A. In other words, under the state of FIG. 27A, under the setting conditions that the viewing distance is 20 [cm] and the virtual image distance is 80 [cm], the virtual image 15 having the virtual image size of 50.4 [cm] is presented at the presentation position at this virtual image distance under the state in which the part of the left side of the left-eye image and the part of the right side of the right-eye image overlap with each other.

In contrast, under the state of FIG. 27B, that is, even under the state in which the viewing distance is changed from 20 [cm] to 10 [cm], the virtual image 15 having the same virtual image size of 50.4 [cm] is presented at the presentation position at the virtual image distance of 80 [cm]. In order to fix the virtual image size regardless of the viewing distance in this way, it is necessary to adjust, in accordance with the viewing distance, an image display range with respect to an effective pixel region in the left-right direction on the display unit 10.

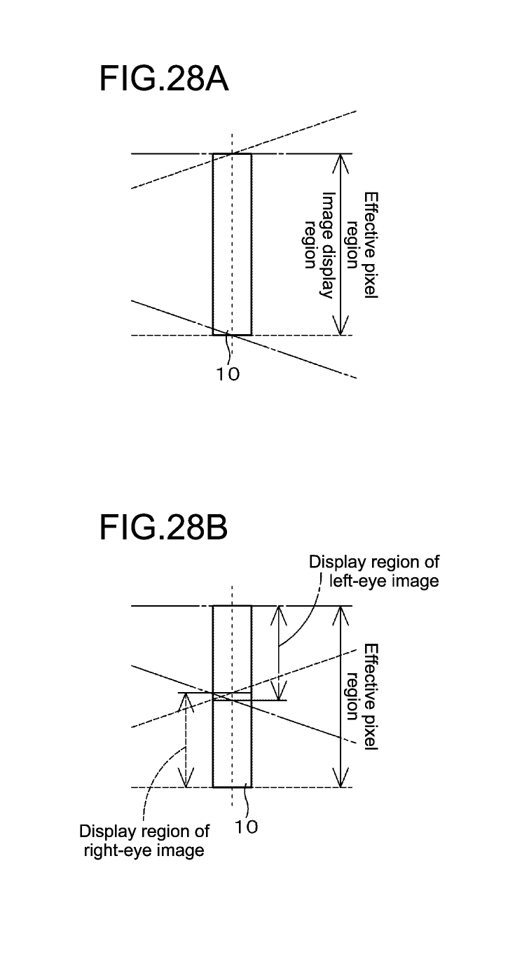

Specifically, under the state illustrated in FIG. 27A, as illustrated in FIG. 28A, the whole effective pixel region in the left-right direction on the display unit 10 is used as the image display range for both the left-eye image and the right-eye image. Under the state illustrated in FIG. 27B, as illustrated in FIG. 28B, a predetermined range from the left end of the effective pixel region on the display unit 10 is used as the image display range for the left-eye image, and a predetermined range from the right end of the effective pixel region on the display unit 10 is used as the image display range for the right-eye image. In other words, the non-image display region of the left-eye image is provided at a part on the right end side of the effective pixel region on the display unit 10, and the non-image display region of the right-eye image is provided at a part on the left end side of the effective pixel region on the display unit 10. Then, by adjusting the image display range in accordance with the viewing distance, since the distant-display optical system uses a variable focus, it is possible to fix the virtual image size while keeping (or under the state of keeping) the virtual image distance of 80 [cm].

With the above-described display apparatus according to Example 17, even when the viewing distance is changed from that under the state of FIG. 27A to that under the state of FIG. 27B or vice versa, it is possible to present the virtual image 15 under a state in which the virtual image size is fixed while keeping constant the virtual image distance. Thus, in the case where the display apparatus is used as the display apparatus of the electronic apparatuses including a wristwatch-type terminal, mobile terminals such as a feature phone and a smartphone, or camera apparatuses such as a still camera and a camcorder, even when a hand-holding distance of these terminals (apparatuses) changes, the virtual image size is not changed. As a result, it is possible to avoid the troubles such as becoming sick from blur at the hand-holding distance.

(Display Apparatus According to Embodiment B of Second Embodiment)

A display apparatus according to Embodiment B of the second embodiment is a virtual-image display apparatus that presents a virtual image at a position less distant (nearer) than the display surface of the display unit 10 is distant, and that performs the presentation of the virtual image in a manner that a right side of a left-eye image and a left side of a right-eye image are adjacent to or overlap with each other at the virtual-image presentation position. On the display apparatus according to Embodiment B of the second embodiment, the virtual image is presented (displayed) by the signal processes by the signal processing unit 40 in FIG. 13, and under the display control by the display control unit 50 in FIG. 13.

In other words, the display control unit 50 drives the left-eye pixel 13L and the right-eye pixel 13R of the display unit 10 on the basis of the image information generated by the signal processing unit 40, thereby presenting, in accordance with the focal length and the viewing distance of the virtual image lenses 12, a virtual image at a presentation position set as a position less distant than the display surface of the display unit 10 is distant. More specifically, the signal processing unit 40 generates image information that causes the left side of the left-eye image and the right side of the right-eye image to overlap with each other. The display control unit 50 drives the left-eye pixel 13L and the right-eye pixel 13R on the basis of the image information generated by the signal processing unit 40, thereby presenting the virtual image 15 at the presentation position set as the position less distant than the display surface of the display unit 10 is distant.

The display apparatus according to Embodiment B of the second embodiment includes a vicinity-display optical system that presents the virtual image 15 at a position less distant from the observer than the display surface of the display unit 10 is distant, in which the virtual image lenses 12 are arranged in the array in the units of adjacent even-number pixels including the left-eye pixel and the right-eye pixel. Further, the display apparatus enables the observer to view, with both the eyes with respect to the screen of the single display unit 10, the virtual image 15 at a position less distant (nearer) than the display surface of the display unit 10 is distant. Thus, the display apparatus according to Embodiment B of the second embodiment is useful as a virtual-image display apparatus particularly for a near-sighted observer under a naked-eye state. In other words, by virtual image viewing, that is, by shifting the presentation position to a position nearer than the display surface of the display unit 10 is near in accordance with the focus position formed by the lenses of the eyeballs, it is possible to view the display screen of the virtual image even with naked eyes of a near-sighted person who needs eyesight correction with eye glasses or contact lenses.

Also with regard to the display apparatus according to Embodiment B of the second embodiment, there is a case where the virtual image lens 12 are each formed of a fixed focus lens, and a case where the virtual image lenses 12 are each formed of a variable focus lens. Now, the case where the virtual image lenses 12 are each formed of a fixed focus lens is specifically described as Example 18, and the case where the virtual image lenses 12 are each formed of a variable focus lens is specifically described as Example 19.

### Example 18

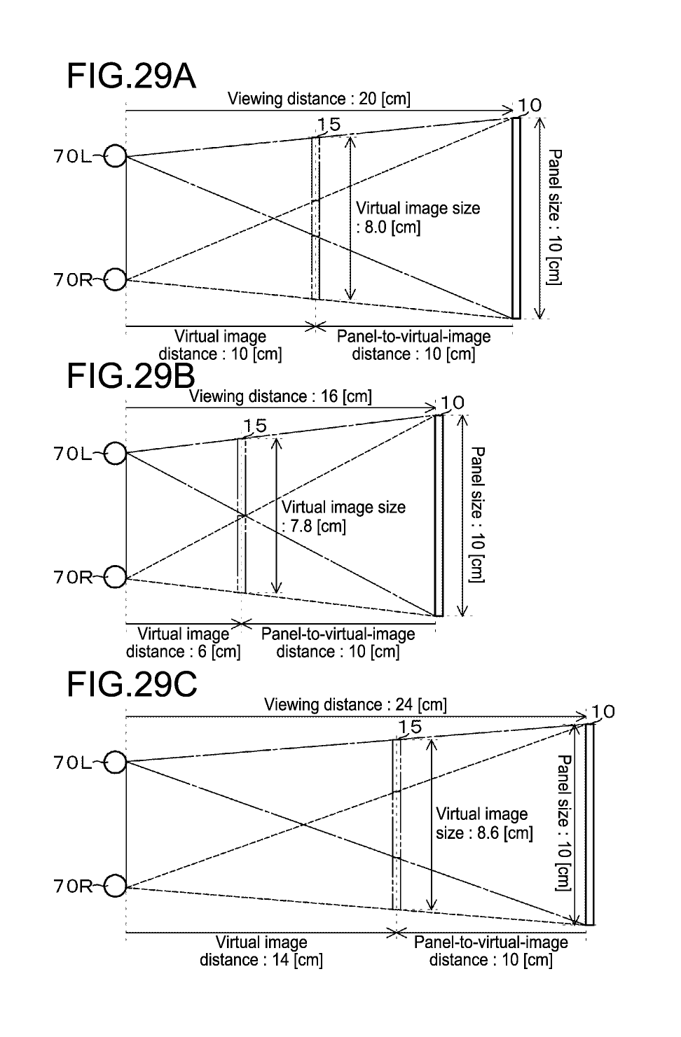

Example 18 is an example in which the vicinity-display optical system, which presents a virtual image at a position less distant than the display surface of the display unit 10 (refer to FIG. 16) is distant, uses a fixed focus, that is, an example in which the virtual image lenses 12 are each formed of a fixed focus lens. FIG. 29A, FIG. 29B, and FIG. 29C are explanatory views each illustrating a virtual image presented by a display apparatus according to Example 18. FIG. 29A illustrates a case where the viewing distance is 20 [cm], FIG. 29B illustrates a case where the viewing distance is 16 [cm], and FIG. 29C illustrates a case where the viewing distance is 24 [cm].

In FIG. 29A, FIG. 29B, and FIG. 29C, the light beam relating to the left eye 70L of the observer is indicated by one-dot chain lines, and the light beam relating to the right eye 70R of the observer is indicated by broken lines. Further, the distance between the left eye 70L and the right eye 70R of the observer (interocular) is assumed, for example, to be 65 [mm]. The same applies to Examples described below.

The size of the display surface of the display unit 10 in the horizontal direction (row direction), that is, the panel size, is assumed, for example, to be 10 [cm], and the distance between the left eye 70L and the right eye 70R of the observer (interocular) is assumed, for example, to be 65 [mm]. Further, the light beam relating to the left eye 70L of the observer is indicated by the one-dot chain lines, the light beam relating to the right eye 70R is indicated by the broken lines, and the virtual image 15 is indicated by two-dot chain lines. The same applies to Example 19 described below.

In the case illustrated in FIG. 29A where the viewing distance is 20 [cm], the virtual image 15 having a virtual image size of 8.0 [cm] is presented (displayed) at a presentation position at a virtual image distance of 10 [cm]. In the case illustrated in FIG. 29B where the viewing distance is 16 [cm], the virtual image 15 having a virtual image size of 7.8 [cm] is presented at a presentation position at a virtual image distance of 6 [cm]. In the case illustrated in FIG. 29C where the viewing distance is 24 [cm], the virtual image 15 having a virtual image size of 8.6 [cm] is presented at a presentation position at a virtual image distance of 14 [cm]. In any of the cases, the image information (display image information) for driving the display unit 10 is not adjusted.

With the above-described display apparatus according to Example 18, it is possible to perform short-distance presentation of the virtual image 15 with respect to a near-sighted observer under a naked-eye state by changing the presentation position (virtual image distance) of the virtual image 15 through changing of the viewing distance without adjusting the image information for driving the display unit 10. In this case, the observer needs to change the virtual image distance in accordance with his/her own eyesight.

Note that, in the case illustrated in FIG. 29A where the viewing distance is 20 [cm], and in the case illustrated in FIG. 29C where the viewing distance is 24 [cm], the virtual image 15 is presented under a state in which a part of the left side of the left-eye image and a part of the right side of the right-eye image overlap with each other. As in the case of Example 14, in a region where this overlapping occurs, it is preferred that either one of the left-eye image and the right-eye image be displayed, or the left-eye image and the right-eye image be displayed after being subjected to interpolation processes. With this, it is possible to suppress the occurrence of such phenomena that double images are displayed in the region where the part of the left side of the left-eye image and the part of the right side of the right-eye image overlap with each other, and that luminance becomes higher than those in other regions. The same applies to Example 10 described below.

Meanwhile, in the case illustrated in FIG. 29B where the viewing distance is 16 [cm], there is no region where the left-eye image and the right-eye image overlap with each other. In other words, the virtual image 15 is presented under a state in which the left-eye image and the right-eye image are completely separated from each other.

### Example 19

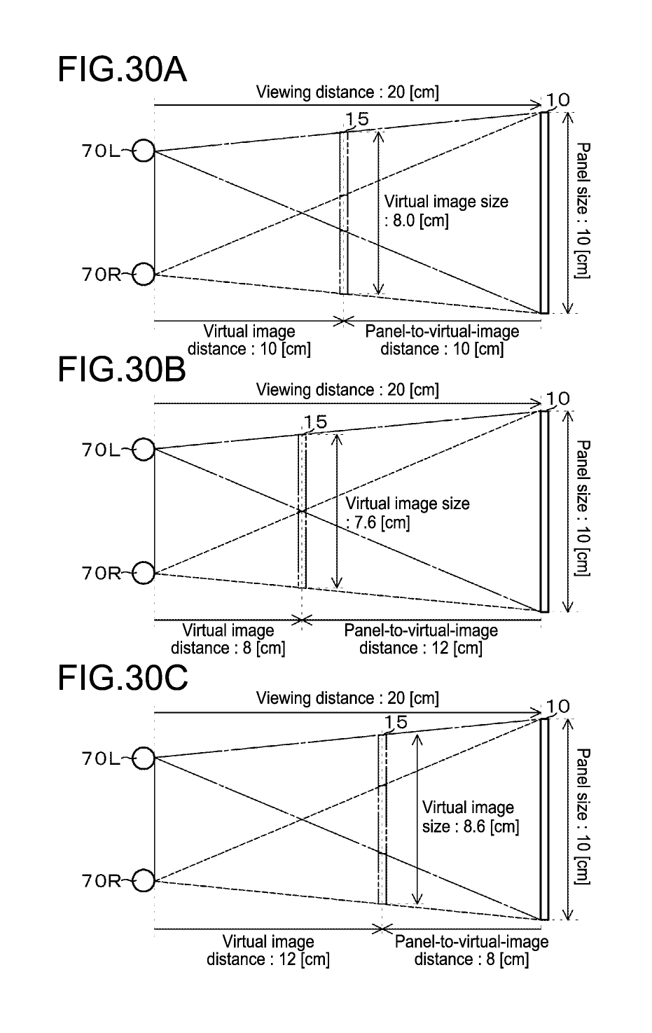

Example 19 is an example in which the vicinity-display optical system, which presents a virtual image at a position less distant than the display surface of the display unit 10 (refer to FIG. 16) is distant, uses a variable focus, that is, an example in which the virtual image lenses 12 are each formed of a variable focus lens. FIG. 30A, FIG. 30B, and FIG. 30C are explanatory views each illustrating a virtual image presented by a display apparatus according to Example 19. FIG. 30A illustrates a case where the virtual image distance is 10 [cm], FIG. 30B illustrates a case where the virtual image distance is 8 [cm], and FIG. 30C illustrates a case where the virtual image distance is 12 [cm].

On the display apparatus according to Example 19, the viewing distance being the distance from the observer to the display surface of the display unit 10 is fixed. The viewing distance is fixed, for example, to 20 [cm]. In addition, in FIG. 30A, by setting the virtual image distance determined in accordance with the focal length of the variable focus lens to 10 [cm], the virtual image 15 having the virtual image size of 8.0 [cm] is presented at a presentation position at this virtual image distance. In FIG. 30B, by setting the virtual image distance to 8 [cm], the virtual image 15 having the virtual image size of 7.6 [cm] is presented at a presentation position at this virtual image distance. In FIG. 30C, by setting the virtual image distance to 12 [cm], the virtual image 15 having the virtual image size of 8.6 [cm] is presented at a presentation position at this virtual image distance.

With the above-described display apparatus according to Example 19, it is possible to perform short-distance presentation of the virtual image 15 with respect to a near-sighted observer under a naked-eye state by changing the virtual image distance through changing of the focal length of the variable focus lens in accordance with the eyesight of the observer under the state in which the viewing distance is fixed.

<Display Apparatus According to Third Embodiment>

The technology according to the present disclosure is applicable also to what is called an electronic mirror that uses a display to which a function of a mirror is provided. The electronic mirror refers to an electronically formed mirror that includes a camera arranged in a vicinity of the display, which captures the face of an observer (user), and that performs left-right inversion (mirror-image inversion) on the taken image, and displays the image on the display as a real image. In this way, the function of the mirror provided to the display is exerted. When this electronic mirror, to which the technology according to the present disclosure is applied, is related to the system configuration of the display apparatus according to the second embodiment of the present disclosure, which is shown in FIG. 13, the display corresponds to the display unit 10, and the camera corresponds to the imaging unit 20. In the following description, a display apparatus 1 according to the present disclosure, which is applied to the electronic mirror, is referred to as a display apparatus according to a third embodiment.

The display apparatus according to the third embodiment is featured not only in merely presenting, as a real image, a left-right inverted image of the image taken by the imaging unit 20 on the display surface of the display unit 10, but also in presenting, as a virtual image, the image at a presentation position less distant from the observer than the display unit 10 is distant. In other words, the display apparatus according to the third embodiment is similar to the display apparatus according to Embodiment B of the second embodiment in presenting a virtual image at a presentation position less distant from the observer than the display unit 10 is distant.

With the display apparatus according to the third embodiment, it is possible to present a virtual image at a position less distant from the observer than the display unit 10 is distant. Thus, it is possible to provide an electronic mirror that enables even a near-sighted observer under a naked-eye state to check his/her own face without coming closer to the display surface of the display unit 10. The electronic mirror to which the display apparatus according to the third embodiment is applied is used as a naked-eye viewable mirror that enables a person with weak eyesight to view, as in looking in a mirror and even without wearing eye glasses or contact lenses, his/her own face by display of the virtual image at the presentation position nearer than the display unit 10 is near.

Further, the display apparatus according to the third embodiment enables even a person who has eyesight too weak to check his/her own face reflected on a mirror with naked eyes to apply skin treatment or makeup, or to wear contact lenses without wearing eye glasses or contact lenses. In other words, by virtual image viewing, that is, by shifting the presentation position to a position nearer than the display surface of the display unit 10 is near in accordance with a focus position formed by the lenses of the eyeballs, it is possible to view the display screen of the virtual image even with naked eyes of a near-sighted person who needs eyesight correction with eye glasses or contact lenses.

The display apparatus according to the third embodiment can use either one of the fixed focus lens and the variable focus lens as each of the virtual image lenses 12. Note that, when the variable focus lens is used as each of the virtual image lenses 12, it is possible to switch the virtual image display and the real image display to each other. In other words, when the virtual image lenses 12 are each formed of the variable focus lens, by providing a lens function to the variable focus lens, it is possible to present the left-right inverted image of the image taken by the imaging unit 20 as a virtual image at a position less distant than the display unit 10 is distant. Further, by omitting the lens function from the variable focus lens, it is possible to display, on the display surface of the display unit 10, the left-right inverted image of the image taken by the imaging unit 20 as a real image (two-dimensional image). With this, the display surface of the display unit 10 functions as an ordinary mirror.

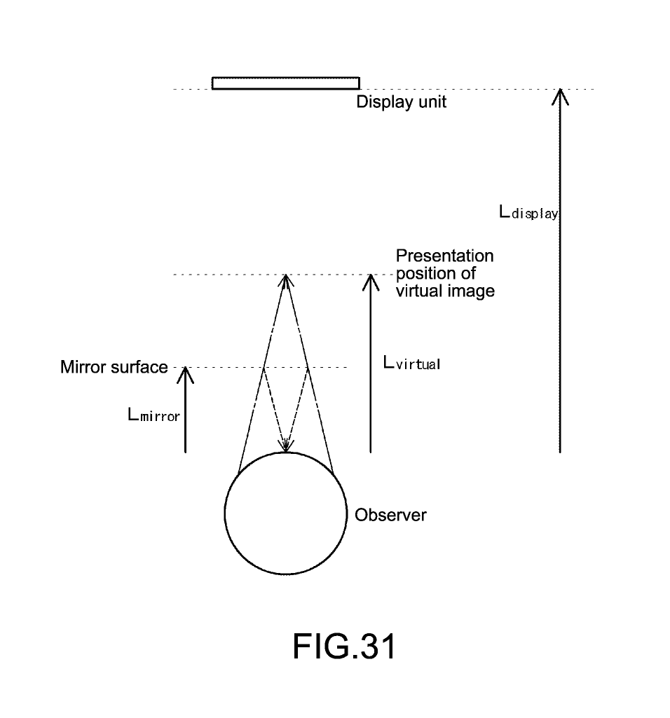

Now, a focus distance in looking in the mirror is described with reference to FIG. 31. In FIG. 31, a distance from an observer to the mirror is defined as Lₘᵢᵣᵣₒᵣ a distance from the observer to a virtual-image presentation position (virtual image distance) is defined as L_{Virtual}, and a distance from the observer to the display surface of the display unit 10 is defined as L_{display}. The focus distance in a case where one's own face is viewed via a mirror is twice as long as the distance from the face to the mirror. This is because not only the distance to the mirror but also the distance from the mirror to the face reflected thereby is needed.

For example, in order that a near-sighted observer, who cannot check (cannot view) his/her own face until coming close to a position at the viewing distance of 10 [cm], checks his/her own face, this observer needs to come close to the mirror at 5 [cm] from the display surface of the display unit 10 having the mirror function, that is, from a mirror surface. This is because, when the observer comes close to the position at 5 [cm] from the mirror surface, a light beam moves back and force 10 [cm] with respect to the mirror surface, that is, the viewing distance measures 10 [cm].

In contrast, when the virtual image is presented at the presentation position of 10 [cm] from the observer on the side nearer than the display unit 10 is near, the observer can check (view), without coming close to the display surface of the display unit 10, his/her own face at the distance of 10 [cm] from the face on the side nearer than the display unit 10 is near. In other words, when the virtual image is presented at the distance of 10 [cm] from the observer, even the near-sighted person, who cannot check his/her own face until coming close to the position at the viewing distance of 10 [cm], can check his/her own face with naked eyes.

As described above, in the case of an ordinary mirror, there is a need to make the distance between the face and the mirror close to one half of the focus distance in viewing with naked eyes. For example, a person who cannot view a thing until coming close to 10 [cm] on hand needs to bring a mirror close to a position of 5 [cm], resulting in interference of makeup tools such as mascara with the mirror. At the same time, the mirror that has come too close narrows the viewable range. With the display apparatus according to the third embodiment, it is possible to present a virtual image at any position nearer than the display surface of the display unit 10 is near, and hence to set the virtual-image presentation position at 10 [cm] from the eye. With this, the position of the display surface of the display unit 10 having the function of a real mirror is sufficiently spaced apart from the face. Thus, it is possible to avoid problems such as the interference of makeup tools with the mirror.

In the configuration of this embodiment, as in the case of Embodiment B of the second embodiment, for near-sighted eyes, a virtual image is presented at a position less distant from the observer than the display unit 10 is distant. Alternatively, for far-sighted eyes (or weak-sighted eyes from aging), it is possible to present the virtual image at a position more distant from the observer than the display unit 10 is distant (modification example of the third embodiment). Further, it is also possible to enable switching near-sighted use and far-sighted use to each other from observer to observer, specifically, to present the virtual image at a position less distant than the display unit 10 is distant in the case of the near-sighted use, and to present the virtual image at a position more distant than the display unit 10 is distant in the case of the far-sighted use. In this case, a variable focus lens is used as each of the virtual image lenses 12, and presentation positions of the virtual image are set as appropriate by changing the focal length of the variable focus lens in accordance with the switching of the near-sighted use and the far-sighted use to each other.

Further, in the third embodiment or in the modification example thereof, it is preferred that the viewing distance be calculated on the basis of the distance between the left and right eyes 70L and 70R in the camera image taken by the imaging unit 20 in FIG. 13, and that the virtual image distance to the virtual-image presentation position suited to the eyesight of the observer be calculated on the basis of the calculated viewing distance. This calculation process is executed by the signal processing unit 40 in FIG. 13. At this time, the display control unit 50 adjusts the virtual-image presentation position by controlling the focal length of the virtual image lenses 12 in accordance with the virtual image distance calculated by the signal processing unit 40. Alternatively, it is also possible to present the virtual image distance calculated by the signal processing unit 40 to the observer such that the observer adjusts, in accordance with the presented virtual image distance, the virtual-image presentation position via the input unit 60 and the display control unit 50.

Now, specific examples of the display apparatus according to the third embodiment, which is configured to present a virtual image at a position less distant from the observer side than the display unit 10 is distant, are described.

### Example 20

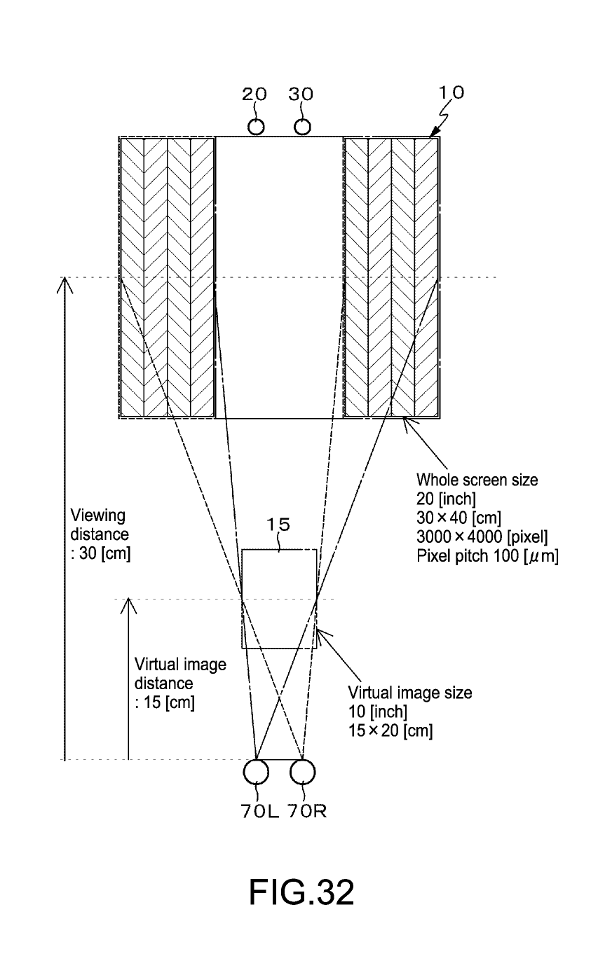

FIG. 32 is an explanatory view illustrating a virtual image presented by a display apparatus according to Example 20. In Example 20, the optical system (refer to FIG. 14) in which the apertures 91 and the virtual image lenses 12 are arranged in the array in the units of adjacent even-number pixels including the left-eye pixel and the right-eye pixel is used as an optical system that presents the virtual image 15 at a position less distant from the observer side than the display surface of the display unit 10 is distant.

In FIG. 32, the imaging unit 20 and the distance measurement unit 30 are provided integrally with the display unit 10 in the vicinity of the display unit 10, for example, on the display unit 10. Note that, although one imaging unit 20 is arranged on the display unit 10 in this example, this arrangement may be changed as appropriate. For example, when the face of the observer cannot be captured as an image opposed to the display unit 10 by the imaging unit 20 arranged on the display unit 10, by arranging the imaging units 20, for example, on upper, lower, left, and right sides of the display unit 10, and performing image processes on images taken thereby, it is possible to generate and display an image opposed to the display unit 10.

The display unit 10 to be used in Example 20 is, for example, a display having a screen size (whole screen size) of 20 [inch], with 30 [cm] in height and 40 [cm] in width, with the number of pixels being 3000 in height, 4000 [pixel] in width, and 100 [um] in pixel pitch. The distance between the observer and the display unit 10, that is, the viewing distance is set to 30 [cm]. With this, a virtual image is presented at a presentation position at a virtual image distance of 15 [cm], that is, half the viewing distance of 30 [cm]. In addition, the virtual image size is 10 [inch], with 15 [cm] in height and 20 [cm] in width. The screen size of the virtual image at this time corresponds to a projection range for one eye.

With the above-described display apparatus according to Example 20, by using the technology according to the second embodiment of the present disclosure, that is, the technology of virtual image display that enables an observer to view the virtual image with both the eyes on the screen of the single display unit 10, it is possible to present, to the observer, the virtual image at a position nearer than the display unit 10 having the function of a mirror is near. With this, it is possible for a person who needs eyesight correction to check his/her own face even without wearing eye glasses or contact lenses. Thus, it is possible to apply skin treatment with naked eyes, for example, after wake-up or before going to bed.

### Example 21

In Example 20, the function of an electronic mirror is exerted by using the technology of virtual image display that enables the observer to view the virtual image with both the eyes on the screen of the single display unit 10 with use of the virtual-image optical system according to the second embodiment. In contrast, Example 21 is featured in using a virtual-image optical system configured on the basis of what is called reconstruction of parallax rays so as exert the function of the electronic mirror.

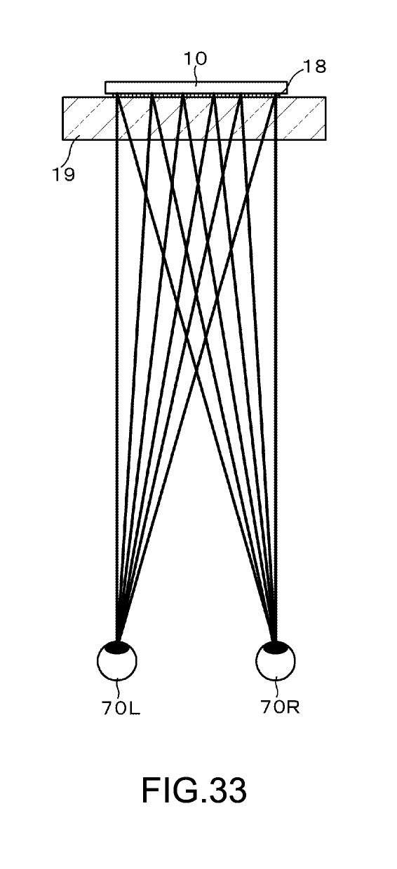

FIG. 33 is a view illustrating a configuration of an optical system of a display apparatus according to Example 21. The display apparatus according to Example 21 differs from the display apparatus according to the second embodiment shown in FIG. 13 and FIG. 14 in configuration of the optical system including the display unit 10. Other configuration features are basically the same.

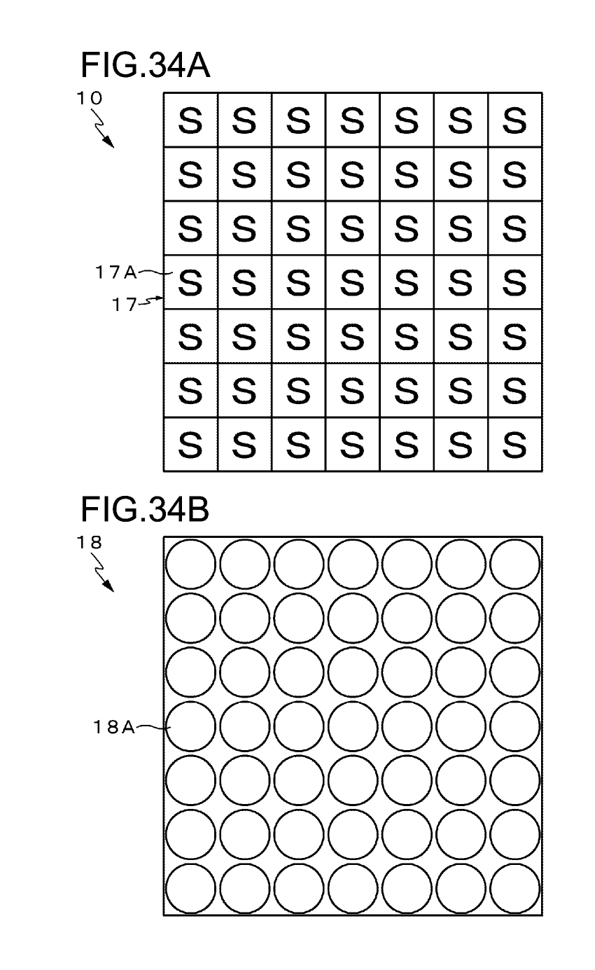

As illustrated, for example, in FIG. 34A, the display unit 10 is formed of a display element array in which a plurality of display elements 17 is arranged in matrix, and a lens array unit 18 is provided on its display surface side in proximity and in parallel to the display surface. Note that, the “parallel” herein encompasses not only a case of being strictly parallel, but also a case of being substantially parallel. Thus, presence of various types of variations generated in design or in production is allowed. In the example of FIG. 34A, the total number of forty-nine (7×7) display elements 17 are arranged along a single flat surface.

The plurality of display elements 17 each have a display region 17A having, for example, a rectangular shape, and are each configured to be capable of displaying an independent image. In other words, the plurality of display elements 17 are each formed of a plurality of pixels, and hence are each capable of displaying on its own an image recognizable by a person. In an example in FIG. 25A, the plurality of display elements 17 each display an image of a letter “S.”

As illustrated, for example, in FIG. 34B, the lens array unit 18 is formed of a plurality of lenses 18A. One of the lenses 18A is arranged in proximity to corresponding one of the display elements (display regions) 17. Thus, the lenses 18A are also arranged in matrix along a single flat surface (surface parallel to the surface along which the display elements 17 are arranged). In the example in FIG. 34B, the total number of forty-nine (7×7) lenses 18A are provided.

Note that, the surfaces on which the display elements 17 and the lenses 18A are arranged need not necessarily be flat surfaces, and may be gently curved surfaces. Further, the display element 17 and the lenses 18A are arranged at fixed pitch intervals such that a person can recognize an image as a whole (in other words, such that image is not displayed with local defects). A coverslip 19 is arranged on a front surface of the lens array unit 18. The display unit 10, the lens array unit 18, and the coverslip 19 are integrated with each other.

Light of the image displayed by each of the plurality of display elements 17 of the display unit 10 is converted into substantially parallel light beams by the lens 18A, and these light beams enter the left eye 70L and the right eye 70R of the observer (user) through the cover slip 19.

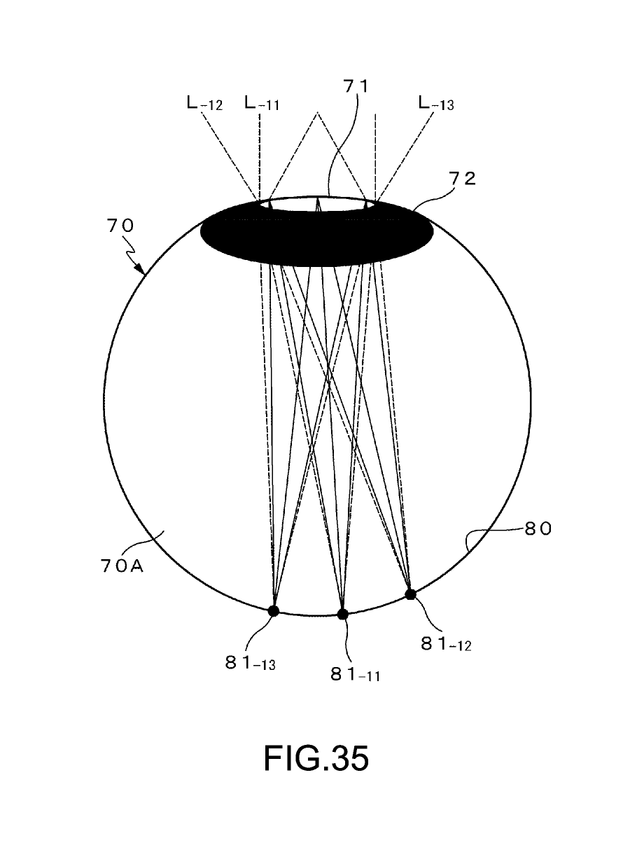

FIG. 35 is an explanatory view illustrating focusing on the retina. FIG. 35 illustrates a state in which the light beams that enter the eye 70 at individual angles are focused on a retina (left eye 70L and right eye 70R are simply referred to as the eye 70 unless it is necessary to make specific distinctions).

As illustrated in FIG. 35, an iris 72 is arranged around a pupil 71 of an eyeball 70A. The substantially parallel light beams emitted from the lens 18A enter the eyeball 70A through the pupil 71, and are focused on points 81₋₁₁ to 81₋₁₃ on a retina 80. Among the light beams that enter the eyeball 70A through the pupil 71, an image of a light beam L₋₁₁ at substantially a center in FIG. 35 is formed at the point 81₋₁₁ on the retina 80. Further, an image formed by a light beam L₋₁₂ that enters the pupil 71 from a left side with respect to the light beam L₋₁₁ in FIG. 35 is formed at a point 81₋₁₂ located on a right side with respect to the point 81₋₁₁ in FIG. 35. Conversely, an image formed by a light beam L₋₁₃ that enters from a right side with respect to the light beam L₋₁₁ in FIG. 35 is formed at a point 81₋₁₃ located on a left side with respect to the point 81₋₁₁ in FIG. 35.

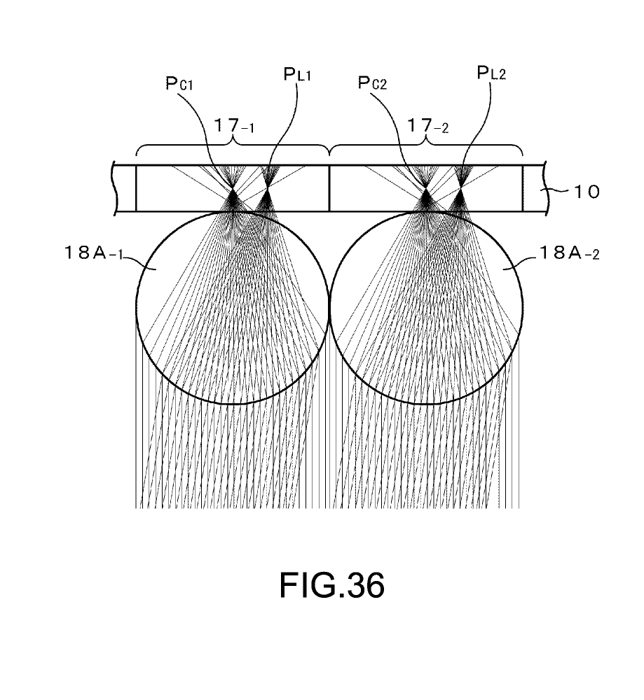

FIG. 36 illustrates a relationship between the light beams emitted from the display elements 17, and the lenses 18A. As illustrated in FIG. 36, in the case of this example, the lenses 18A are each formed of a lens having substantially a spherical shape. A lens 18A₋₁ corresponding to a display element 17₋₁, and a lens 18A₋₂ corresponding to a display element 17₋₂ are arranged adjacent to (in contact with) with each other. Although not shown, lenses are arranged also on a left side with respect to the lens 18A₋₁ in FIG. 36, and on a front side and a depth side in a direction perpendicular to the drawing sheet. Similarly, lenses are arranged on a right side with respect to the lens 18A₋₂ in FIG. 36, and on the front side and the depth side in the direction perpendicular to the drawing sheet.

The display surface of the display unit 10 is arranged in a vicinity of a focal point (focal length) obtained when the substantially parallel light beams enter the lenses 18A₋₁ and 18A₋₂. In other words, the light of the image, which is emitted from the display element 17₋₁, is emitted as substantially parallel light beams from the lens 18A₋₁. Similarly, the light of the image, which is emitted from the display element 17₋₂, is emitted as substantially parallel light beams from the lens 18A₋₂.

A light beam emitted from a point P_{L1} on a slightly right side with respect to substantially a center of the display element 17₋₁ is assumed to be converted into the substantially parallel light beams by the lens 18A₋₁, and these light beams are assumed to be focused, for example, on the point 81₋₁₃ on the retina 80. A light beam emitted from a point P_{C1} on a slightly left side with respect to the point P_{L1} in FIG. 36 (substantially the center of the display element 17₋₁) is assumed to be converted into the substantially parallel light beams by the lens 18A₋₁, and these light beams are assumed to be focused on the point 81₋₁₁ on the retina 80.

Similarly, a light beam emitted from a point P_{L2} (corresponding to the point P_{L1} of the display element 17₋₁) on a slightly right side with respect to substantially a center of the display element 17₋₂ located on a right side with respect to the display element 17₋₁ in FIG. 36 is converted into the substantially parallel light beams by the lens 18A₋₂, and these light beams are focused on the point 81₋₁₃ on the retina 80. Further, a light beam emitted from a point P_{C2} (corresponding to the point P_{L1} of the display element 17₋₁) located on a left side with respect to P_{L2} in FIG. 36 (substantially the center of the display element 17₋₁) is converted into the substantially parallel light beams by the lens 18A₋₂, and these light beams are focused on the point 81₋₁₁ on the retina 80.

In this way, the light beams emitted from the points P_{L1} and P_{L2} as corresponding pixels are focused on the same point on the retina 80. Similarly, the light beams emitted from the points P_{C1} and P_{C2} as corresponding pixels are focused on the same point on the retina 80.

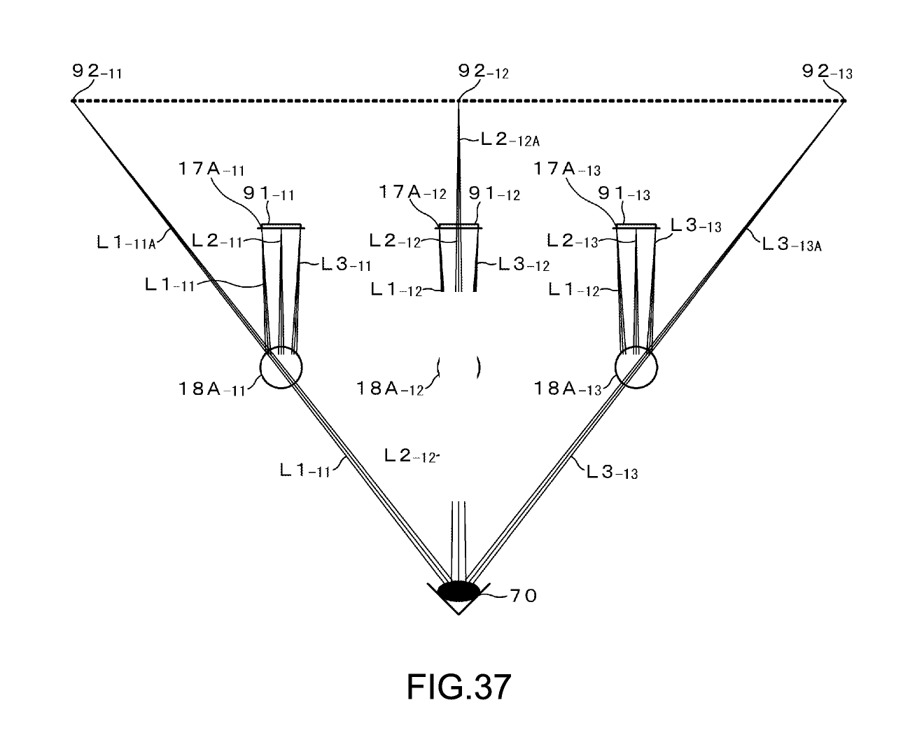

Now, the above is described in further detail with reference to FIG. 37. Specifically, as illustrated in FIG. 37, it is assumed that a display region 17A₋₁₁ of the display element 17₋₁ is located on a leftmost side in FIG. 37, a display region 17A₋₁₂ of the display element 17₋₂ is located on a right side with respect thereto (at substantially center), and a display region 17A₋₁₃ of the display element 17₋₃ is located on a further right side. A real image 91₋₁₁ is displayed in the display region 17A₋₁₁, a real image 91₋₁₂ is displayed in the display region 17A₋₁₂, and a real image 91₋₁₃ is displayed in the display region 17A₋₁₃, respectively. These real images 91₋₁₁ to 91₋₁₃ have no parallax, and are substantially the same images. With this, a two-dimensional image is visually recognized. In order that a stereoscopic image (three-dimensional image) is visually recognized, the parallax images are displayed.

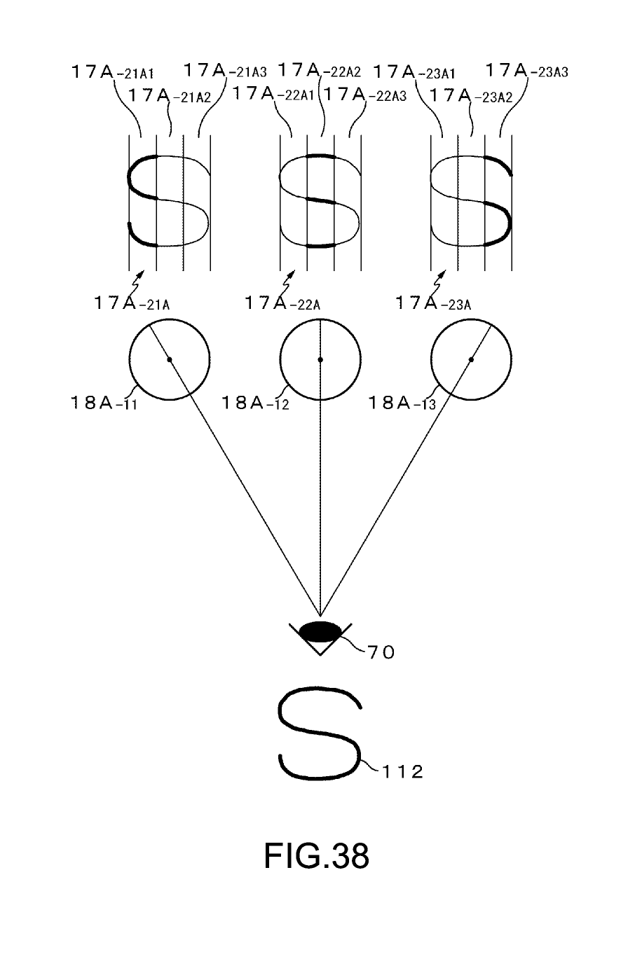

Note that, illustration of optical path refraction that occurs in practice at surfaces of the lenses is simplified in FIG. 37, and in FIG. 38 described below.

Among light beams of the real image 91₋₁₁ in the display region 17A₋₁₁, a light beam L1₋₁₁ emitted from a pixel located on the left side in FIG. 37 is converted into substantially parallel light beams by the lens 18A−u and these light beams are focused on the point 81₋₁₂ on the retina 80. However, among the light beams of the real image 91₋₁₁, a light beam L2₋₁₁ emitted from a pixel located rightward away in FIG. 37 from the pixel corresponding to the light beam L1₋₁₁ is more difficult to focus within a view range on the retina 80 through the lens 18A₋₁ than the light beam L1₋₁₁ is focused. A light beam L3₋₁₁, which is emitted from a pixel located further rightward away from the pixel corresponding to the light beam L2₋₁₁, is even more difficult to focus within the view range on the retina 80 through the lens 18A₋₁ than the light beam L2₋₁₁ is focused. In other words, among the light beams of the real image 91₋₁₁, the light beams from the pixels located leftward are dominantly focused on the point 81₋₁₁ within the view range on the retina 80.

Among light beams of the real image 91₋₁₂ in the display region 17A₋₁₂ located at substantially a center of FIG. 37, a light beam L2₋₁₂ emitted from a pixel located at substantially a center is dominant as a light beam to be focused on the point 81₋₁₁ within the view range on the retina 80 over a light beam L1₋₁₂ emitted from a pixel located away on the leftmost side in FIG. 37, and a light beam L3₋₁₂ emitted from a pixel located away on the rightmost side in FIG. 37.

In contrast, among light beams emitted from the real image 91₋₁₃ of the display region 17A₋₁₃ located on a rightmost side in FIG. 37, which are converted into substantially parallel light beams by the lens 18A₋₃, and focused on the point 81₋₁₃ within the view range on the retina 80, a light beam L3₋₁₃ emitted from a pixel located away on the rightmost side in FIG. 37 is dominant. In addition, a light beam L2₋₁₃ emitted from a pixel located away on the left side with respect thereto is secondly dominant, and a light beam L1₋₁₃ emitted from a pixel on the leftmost side is most difficult to focus on the point 81₋₁₃ within the view range on the retina 80.

In this way, the light beams, which are emitted to be a dominant component from the pixels located leftward among the pixels of the real image 91₋₁₁ displayed by the display region 17A₋₁₁ are focused on the point 81₋₁₂ within the view range on the retina 80. Further, the light beams, which are emitted to be a dominant component from the pixels located at substantially the center among the pixels of the real image 91₋₁₂ of the display region 17A₋₁₂ located at the center are focused on the point 81₋₁₁ within the view range on the retina 80. In addition, the light beams, which are emitted to be a dominant component from the rightward pixels among the pixels of the real image 91₋₁₃ of the display region 17A₋₁₃ located rightmost are focused on the point 81₋₁₃ within the view range on the retina 80.

An image on the point 81₋₁₂ is recognized as a virtual image 92₋₁₁ by a light beam L1_{-11A} that is virtually obtained by tracing back the light beam L1₋₁₁ from the lens 18A₋₁. An image on the point 81₋₁₁ is recognized as a virtual image 92₋₁₂ by a light beam L2_{-12A} that is virtually obtained by tracing back the light beam L2₋₁₂ from the lens 18A₋₂. An image on the point 81₋₁₃ is recognized as a virtual image 92₋₁₃ by a light beam L3_{-13A} that is virtually obtained by tracing back the light beam L3₋₁₃ from the lens 18A₋₃.

In practice, similar phenomena occur in all other pixels, and hence the observer (user) visually recognizes the whole of a plurality of real images displayed in the display regions 17A each including the real images 91₋₁₁ to 91₋₁₃ as a combined one virtual image through the eye 70. In other words, the virtual-image optical system is configured such that the light emitted from the display unit 10 is focused on the retina 80 on the basis of the principle of the reconstruction of parallax rays.

FIG. 38 schematically illustrates the above. As illustrated in FIG. 38, it is assumed that the same images 111₋₂₁ to 111₋₂₃ (images of letter S) are respectively displayed in display regions 17A_{-21A} to 17A_{-23A}. A light beam including, as a main component, an image of a part 17A_{-21A1} (left-side part of the letter S) located on a leftmost side in the display region 17A_{-21A} located on a leftmost side in FIG. 38 is converted into substantially parallel light beams by a lens 18A₋₂₁, and these light beams are focused on the point 81₋₁₂ within the view range on the retina 80. In contrast, light beams of an image of a part 17A_{-21A2} located at substantially a center, and of an image of a part 17A_{-21A3} on a right side with respect thereto (images of central part and right-side part of the letter S) in the display region 17A_{-21A} are not focused within the view range on the retina 80 through the lens 18A₋₂₁, or even when these light beams are focused, an amount of energy is small.

Pixels in a display region 17A-22A located at substantially a center in FIG. 38 emit light beams to be focused on the point 81₋₁₁ within the view range on the retina 80 through a lens 18A₋₂₂, and an amount of energy of these light beams to be focused thereon is distributed such that an image of a part 17A_{-22A1} located on a leftmost side, and an image of a part 17A_{-22A3} located on a rightmost side (left-side part and right-side part of letter S) have a small number of components, and that an image of a part 17A_{-22A2} located at substantially a center (central part of the letter S) has a large number of components.

Pixels in a display region 17A_{-23A} located on a rightmost side in FIG. 38 emit light beams to be focused on the point 81₋₁₃ within the view range on the retina 80 through a lens 18A₋₂₃, and an amount of energy of these light beams to be focused thereon is distributed such that components of an image of a part 17A_{-23A3} located on a rightmost side (right-side part of letter S) are dominant, and that an image of a part 17A_{-23A2} located leftward with respect to the part 17A_{-23A3}, and an image of a part 17A_{-23A1} located further leftward with respect thereto (central part and left-side part of the letter S) have a small number of components.

In this way, the same images 111₋₂₁ to 111₋₂₃ displayed on the display regions 17A_{-21A} to 17A_{-23A} are combined on the eye 70, and visually recognized by the observer (user) as a single image 112. In other words, an image including a left-side part of the image 111₋₂₁ (letter S) as a main component, an image including a central part of the image 111₋₂₂ (letter S) as a main component, and an image (virtual image) including a right-side part of an image 111₋₂₃ (letter S) as a main component are combined into the single image 112 (letter S). The above is performed not only in the left-right direction but also in the up-down direction.

The display apparatus according to Example 21 is a virtual-image display apparatus that presents, by using the virtual-image optical system configured on the basis of the principle of the above-described reconstruction of parallax rays, a virtual image at a position nearer than the display unit 10 having the function of a mirror is near. Further, also in the display apparatus according to Example 21, the same functions and the same advantages as those of the display apparatus according to Example 20 can be obtained. Specifically, it is possible to present the virtual image at a position nearer than the display unit 10 having the function of a mirror is near. With this, it is possible for a person who needs eyesight correction to check his/her own face even without wearing eye glasses or contact lenses. Thus, it is possible to apply skin treatment with naked eyes, for example, after wake-up or before going to bed.

<Aspect Ratio of Virtual Image>

As described above, either one of the display apparatus according to the second embodiment and the display apparatus according to the third embodiment is a virtual-image display apparatus that enables the observer to view a virtual image with both the eyes on the screen of the single display unit 10. Further, the virtual-image display apparatus differs from a stereoscopic-image display apparatus that displays a stereoscopic image (three-dimensional image) on the display surface of the display unit 10 with an aspect ratio equal to the aspect ratio of this display surface in presenting a virtual image at the presentation position different from the position on the display surface of the display unit 10 with an aspect ratio different from the aspect ratio of the display surface. The aspect ratio refers to a ratio (width/height) of the lengths (numbers of pixels) in the vertical direction and the horizontal direction of the display surface of the display unit 10 (screen), and of the virtual image.

Now, aspect-ratio change amounts Δ_{aspect} at the time of the presentation of the virtual image in the display apparatus according to the second embodiment and the display apparatus according to the third embodiment are described. The aspect-ratio change amounts Δ_{aspect} herein are quotients obtained by dividing the aspect ratio of a virtual image at the time of the virtual image display by the aspect ratio of the display surface of the display unit 10. The aspect ratio herein is described by way of an example of the display apparatus according to Embodiment A of the second embodiment.

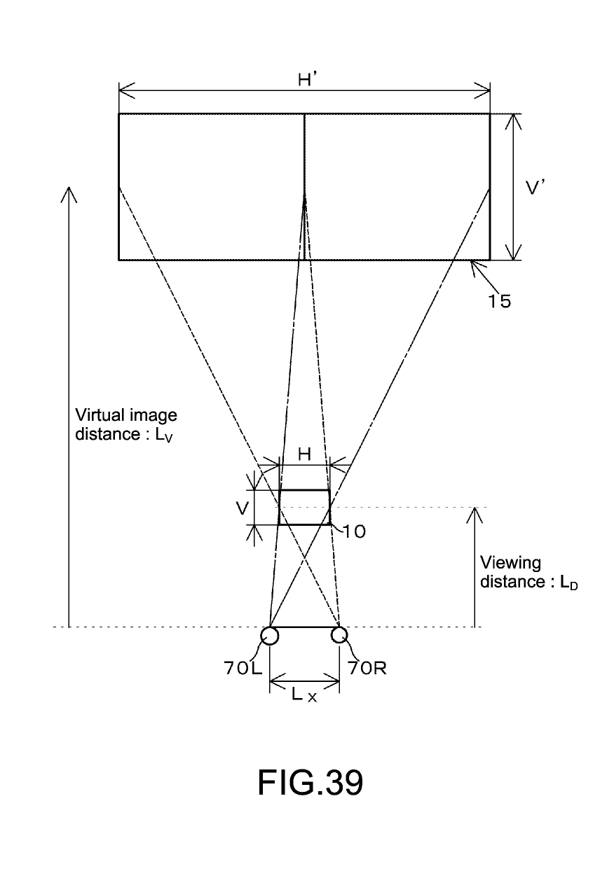

As illustrated in FIG. 39, the distance between both the eyes 70L and 70R of the observer is defined as Ex, a vertical length (height) of the display surface of the display unit 10 (screen) is defined as V, a horizontal length (horizontal width) of the display surface of the display unit 10 is defined as H. A vertical length (height) of the virtual image 15 is defined as V′, and a horizontal length (horizontal width) of the virtual image 15 is defined as H′. Thus, the aspect ratio of the display surface of the display unit 10 is determined to be H/V, and the aspect ratio of the virtual image is determined to be H′/V′. Further, the viewing distance being the distance from the observer to the display unit 10 is defined as L_{D}, and the virtual image distance being the distance from the observer to the virtual image 15 is defined as L_{V}.

In this case, the horizontal length H′ of the virtual image 15 is determined to be (Ex/2+H/2)×L_{V}/L_{D}−E_{X}/2, and the vertical length V′ of the virtual image 15 is determined to be V′=V/2×L_{V}/L_{D}. Further, the aspect-ratio change amounts Δ_{aspect} at the time when the virtual image 15 is displayed are obtained by dividing the aspect ratio of the virtual image 15 by the aspect ratio of the display surface of the display unit 10, that is, obtained by (H′/V′)/(H/V). Therefore, the following equation is established.

Δ_{aspect}=1+{E_{X}(L_{V}−L_{D})/L_{V}×H) (1)

The display apparatus according to the second embodiment and the display apparatus according to the third embodiment are featured in that the aspect-ratio change amounts Δ_{aspect} at the time when the virtual image 15 is displayed satisfy the relationship expressed by Equation (1) described above. In other words, as the horizontal width H of the display surface of the display unit 10 becomes smaller, the aspect ratio of the virtual image 15 becomes higher than the aspect ratio of the display surface. Then, when the row direction corresponds to the lateral direction, the virtual image 15 is displayed in a laterally expanded manner, that is, horizontally elongated manner. Further, the horizontal width of the virtual image 15 with respect to the horizontal width of the display surface of the display unit 10 is one or more and two or less. Note that, when the virtual image 15 is displayed on two separate screens, the horizontal width of the virtual image as a whole is more than two, but a horizontal width of the two screens is two.

When a value of Formula (1) described above is more than one, the presentation position of the virtual image 15 with respect to the observer is a position more distant than the display unit 10 is distant (L_{V}>L_{D}), in other words, the virtual image 15 is presented (displayed) at a position deeper than the display unit 10 is deep. In other words, the case where the value of Formula (1) exceeds one corresponds to the case of the display apparatus according to the first embodiment. Further, when the value of Formula (1) is less than one, the presentation position at which the virtual image 15 is presented (displayed) with respect to the observer is a position nearer than the display unit 10 is near (L_{V}<L_{D}). In other words, the case where the value of Formula (1) is less than one corresponds to the cases of the display apparatus according to Embodiment B of the second embodiment and the display apparatus according to the third embodiment.

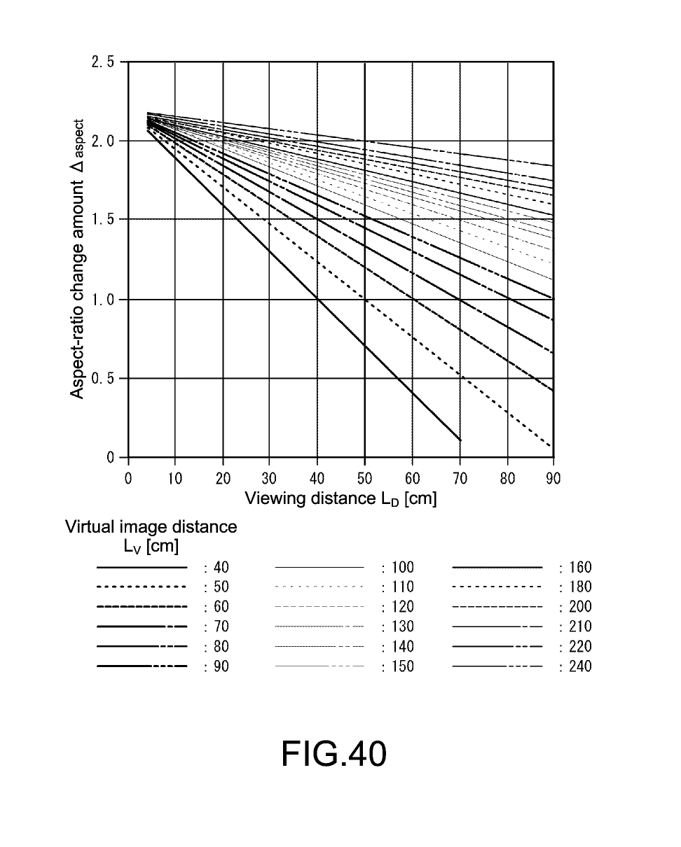

FIG. 40 shows an example of relationships between the viewing distance L_{D} and the aspect-ratio change amount Δ_{aspect} for each of the virtual image distances L_{V}. With the fixed focus lens in which the virtual image distance L_{V} is fixed, as the viewing distance L_{D} becomes shorter, the aspect-ratio change amount Δ_{aspect} of the screen becomes larger. In other words, as the viewing distance L_{D} becomes shorter, the wide display is expanded more, and the display as a whole is also expanded more. With the variable focus lens in which the virtual image distance L_{V} is adjustable, in the case where the viewing distance L_{d} is unchanged, as the virtual image distance L_{V} becomes longer, the aspect-ratio change amount Δ_{aspect} of the screen becomes larger. In other words, as the virtual image distance L_{V} becomes longer, the wide display is expanded more. Further, when the virtual image distance L_{V} is fixed, as in the case of the fixed focus lens, as the viewing distance L_{D} becomes smaller, the wide display is expanded more, and the display as a whole is also expanded more.

Further, a change in aspect-ratio change amount Δ_{aspect} at the time when the viewing distance L_{D} is changed, for example, from 10 [cm] to 60 [cm] in a case where the virtual image distance L_{V} is, for example, as long as approximately 200 [cm], and that in a case where the virtual image distance L_{V} is, for example, as short as approximately 60 [cm] differ approximately twice from each other. In other words, when the virtual image distance L_{V} is short, it is possible to greatly convert the wide display by changing the viewing distance L_{D}. For example, on a wristwatch-type display apparatus having a small screen size, it is possible to acquire information without bringing the apparatus close to one's face at the time of needing only a small amount of information, such as checking of the time. In addition, at the time of checking, for example, a map containing much information, by bringing the apparatus close to one's face, it is possible to view the map in a display range expanded wide.

### Modification Examples

The technical scope of the present disclosure is not limited to the scope of Examples described hereinabove. Specifically, various changes or improvements may be made in Examples described hereinabove without departing from the gist of the technology of the present disclosure, and embodiments with such changes or improvements are also encompassed within the technical scope of the present disclosure.

For example, the virtual image lenses 12 that determine the virtual-image presentation position are not limited to the microlenses used in Examples in the second embodiment and the third embodiment described hereinabove, which are arranged in the array in the units of the plurality of adjacent pixels including the left-eye pixel and the right-eye pixel. Alternatively, it is also possible to use, as the virtual image lenses 12, cylindrical lenses arranged in a stripe pattern in the units of the plurality of adjacent pixels including the left-eye pixel and the right-eye pixel.

Further, the left-eye pixel and the right-eye pixel in the cases exemplified in Examples in the second embodiment and the third embodiment described hereinabove, each of which are formed in the units of a single pixel being a unit at the time forming a color image, may be formed in units of the sub-pixels. In this case, the “pixel” in claims is replaced with “sub-pixel.”

In addition, also in the configurations of the display apparatus according to the second embodiment and the display apparatus according to the third embodiment, as in the configuration of the display apparatus according to the first embodiment, the image display with the aspect ratio different from the aspect ratio of the display surface of the display unit 10, and the image display with the aspect ratio equal to the aspect ratio of the display surface may be switched to each other.

Note that, the apertures 91 and the virtual image lenses 12 need not necessarily be arranged in the units of the plurality of adjacent pixels including the left-eye pixel and the right-eye pixel as in the configurations of Examples in the first embodiment to the third embodiment described hereinabove. Alternatively, the apertures 91 and the virtual image lenses 12 may be arranged in units of a single pixel.

Note that, the present disclosure may also provide the following configurations.

[1] A display apparatus, including:

a display unit in which apertures are arranged in units of a plurality of adjacent pixels including a left-eye pixel and a right-eye pixel;

a signal processing unit that generates image information items with respect to the left-eye pixel and the right-eye pixel, respectively, such that an image is presented with an aspect ratio different from an aspect ratio of a display surface of the display unit; and

a display control unit that drives the left-eye pixel and the right-eye pixel on a basis of the image information items generated by the signal processing unit.

[2] The display apparatus according to Item [1], in which
a dimension of each of the apertures is equivalent to or smaller than a dimension of each of the pixels.
   [3] The display apparatus according to Item [1] or [2], in which
the display unit includes a spacer between the apertures and the pixels.
   [4] The display apparatus according to any of Items [1] to [3], in which

the display unit includes a diffusion layer between the apertures and the pixels.

[5] The display apparatus according to Item [4], in which

the display unit includes separators provided in pixel units in the diffusion layer.

[6] The display apparatus according to Item [5], in which

the separators are made of a material that absorbs visible light.

[7] The display apparatus according to Item [5] or [6], in which
an interface between the separators and the diffusion layer is formed of an interface that reflects visible light.
   [8] The display apparatus according to any of Items [5] to [7], in which

the diffusion layer is partitioned into separate parts by the separators, and pixel-side surfaces thereof are larger than aperture-side surfaces thereof.

[9] The display apparatus according to any of Items [1] to [8], in which

the display unit includes a transparent pad on a layer in which the apertures are provided.

[10] The display apparatus according to any of Items [4] to [9], in which,

the display unit includes a diffraction grating between the pixels and the diffusion layer.

[11] The display apparatus according to any of Items [1] to [10], in which

the display unit includes a liquid-crystal layer that adjusts an intensity of light to be transmitted through the apertures.

[12] The display apparatus according to any of Items [1] to [11], in which

the display unit is capable of selectively forming the apertures with use of an element that is capable of controlling an intensity of light to be transmitted therethrough, and

the display unit
presents, when forming the apertures, an image with the aspect ratio different from the aspect ratio of the display surface of the display unit, and
presents, when not forming the apertures, an image with an aspect ratio equal to the aspect ratio of the display surface of the display unit.
   [13] The display apparatus according to any of Items [1] to [12], further including

a detection unit that detects positional information and orientation information of eyes of an observer with respect to the display surface of the display unit, in which

the signal processing unit generates the image information items with respect to the left-eye pixel and the right-eye pixel, respectively, on the basis of a result of the detection by the detection unit.

[14] The display apparatus according to Item [13], in which

the detection unit includes an imaging unit that captures an observer, and

the signal processing unit
constitutes the detection unit with the imaging unit, and
calculates the positional information and the orientation information of the eyes of the observer with respect to the display surface of the display unit on a basis of an image of the observer captured by the imaging unit.
   [15] The display apparatus according to Item [14], in which

the detection unit includes a distance measurement unit that measures a distance between the display surface of the display unit and the eyes of the observer, and

the signal processing unit uses a result of the measurement by the distance measurement unit in the calculation of the positional information of the eyes of the observer with respect to the display surface of the display unit.

[16] The display apparatus according to any of Items [1] to [12], in which

the display unit includes lenses arranged in the units of the plurality of adjacent pixels including the left-eye pixel and the right-eye pixel, and

the signal processing unit generates image information items with respect to the left-eye pixel and the right-eye pixel, respectively, such that a virtual image is presented with the aspect ratio different from the aspect ratio of the display surface of the display unit.

[17] The display apparatus according to Item [16], further including

a detection unit that detects positional information and orientation information of eyes of an observer with respect to the display surface of the display unit, in which

the signal processing unit generates the image information items with respect to the left-eye pixel and the right-eye pixel, respectively, on a basis of a result of the detection by the detection unit.

[18] The display apparatus according to Item [17], in which

the detection unit includes an imaging unit that captures an observer, and

the signal processing unit
constitutes the detection unit with the imaging unit, and
calculates the positional information and the orientation information of the eyes of the observer with respect to the display surface of the display unit on a basis of an image of the observer captured by the imaging unit.
   [19] The display apparatus according to Item [18], in which

the detection unit includes a distance measurement unit that measures a distance between the display surface of the display unit and the eyes of the observer, and

the signal processing unit uses a result of the measurement by the distance measurement unit in the calculation of the positional information of the eyes of the observer with respect to the display surface of the display unit.

[20] The display apparatus according to Item [16], in which

the lenses arranged in the units of the plurality of pixels are fixed focus lenses with a fixed focal length.

[21] The display apparatus according to Item [16], in which

the lenses arranged in the units of the plurality of pixels are variable focus lenses with variable focal lengths, and

the display control unit controls the variable focal lengths of the variable focus lenses.

[22] A method of driving a display apparatus, the display apparatus including a display unit in which apertures are arranged in units of a plurality of adjacent pixels including a left-eye pixel and a right-eye pixel, the method including:

generating image information items with respect to the left-eye pixel and the right-eye pixel, respectively, such that an image is presented with an aspect ratio different from an aspect ratio of a display surface of the display unit; and

driving the left-eye pixel and the right-eye pixel on a basis of the generated image information items.

[23] An electronic apparatus, including

a display apparatus including
a display unit in which apertures are arranged in units of a plurality of adjacent pixels including a left-eye pixel and a right-eye pixel,
a signal processing unit that generates image information items with respect to the left-eye pixel and the right-eye pixel, respectively, such that an image is presented with an aspect ratio different from an aspect ratio of a display surface of the display unit, and
a display control unit that drives the left-eye pixel and the right-eye pixel on a basis of the image information items generated by the signal processing unit.
   [A01] The display apparatus according to Item [21], in which

the variable focus lenses are formed of microlenses arranged in an array.

[A02] The display apparatus according to Item [A01], in which

the display control unit switches virtual image display and real image display to each other by collectively controlling the focal lengths of the microlenses in the display unit.

[A03] The display apparatus according to Item [A01], in which

the display control unit presents a virtual image at distances different from position to position within a display screen by individually controlling the focal lengths of the microlenses in the display unit.

[A04] The display apparatus according to any of Items [16] to [21] or [A01] to [A04], in which,

when a virtual-image presentation position with respect to the observer is more distant than the display unit is distant, the signal processing unit generates virtual-image information such that a left side of a left-eye image and a right side of a right-eye image are adjacent to or overlap with each other at the virtual-image presentation position.

[A05] The display apparatus according to Item [A04], in which,

when the virtual-image presentation position with respect to the observer is more distant than the display unit is distant, an aspect-ratio change amount of the virtual image with respect to the display surface of the display unit is more than one.

[A06] The display apparatus according to any of Items [16] to [21] or [A01] to [A03], in which,

when a virtual-image presentation position with respect to the observer is less distant than the display unit is distant, the signal processing unit generates virtual-image information such that a right side of a left-eye image and a left side of a right-eye image are adjacent to or overlap with each other at the virtual-image presentation position.

[A07] The display apparatus according to Item [A06], in which,

when the virtual-image presentation position with respect to the observer is less distant than the display unit is distant, an aspect-ratio change amount of the virtual image with respect to the display surface of the display unit is less than one.

[A08] The display apparatus according to any of Items [16] to [21] or [A01] to [A03], in which

the left-eye pixel and the right-eye pixel are provided left-right alternately in a pixel array in the display unit, and

the signal processing unit generates virtual-image information such that images that are independent of and different from each other are presented as a left-eye image and a right-eye image at a virtual-image presentation position.

[A09] The display apparatus according to Item [A08], in which

the signal processing unit generates virtual-image information items such that, with respect to each of the left eye and the right eye, the number of pixels of the virtual image in a horizontal direction is half the number of pixels of the display unit, and that the number of pixels in a vertical direction is equal to the number of pixels of the display unit.

[A10] The display apparatus according to any of Items [16] to [21] or [A01] to [A09], in which

a pixel pitch of the display unit is smaller than eyesight resolution.

[A11] The display apparatus according to Item [A10], in which

the pixel pitch of the display unit is half or less of the eyesight resolution.

[A12] The display apparatus according to Item [A11], in which

the pixel pitch of the display unit is 101.8 [um] or less.

[A13] The display apparatus according to Item [A04], in which

a size of the virtual image that is formed when the left-eye image and the right-eye image overlap with each other changes in accordance with a viewing distance from the observer to the display unit.

[A14] The display apparatus according to Item [A04], in which

a size of the virtual image that is formed when the left-eye image and the right-eye image overlap with each other is unchanged regardless of a viewing distance from the observer to the display unit.

[A15] The display apparatus according to Item [A14], in which

a predetermined range from one end of an effective pixel region on the display unit is used as an image display region for the left-eye image, and

a predetermined range from another end of the effective pixel region on the display unit is used as an image display region for the right-eye image.

[A16] The display apparatus according to Item [16], in which

the number of pixels of the virtual image in a horizontal direction is half the number of pixels of the display unit in the horizontal direction, and

the number of pixels in a vertical direction is equal to the number of pixels in a vertical direction of the display unit.

[A17] The display apparatus according to Item [A16], in which

the virtual image is formed in a pattern of intervals of one pixel in the horizontal direction.

[B01] A display apparatus, including:

a display unit in which apertures and lenses are arranged in units of a plurality of pixels;

a detection unit that detects a left eye and a right eye of an observer;

an imaging unit that captures the observer;

a signal processing unit that
generates image information for displaying a face of the observer captured by the imaging unit as a real image on the display unit, and
generates image information such that a virtual image is presented with an aspect ratio different from an aspect ratio of a display surface of the display unit on the basis of a result of the detection by the detection unit; and

a display control unit
that drives the display unit on the basis of the image information of the real image, the image information being generated by the signal processing unit, and
that drives a virtual-image optical system on the basis of the image information of the virtual image.
   [B02] The display apparatus according to Item [B01], in which

when the observer is near-sighted, the virtual image is presented at a position less distant from the observer than the display unit is distant.

[B03] The display apparatus according to Item [B01], in which

when the observer is far-sighted, the virtual image is presented at a position more distant from the observer than the display unit is distant.

[B04] The display apparatus according to any of Items [B01] to [B03], in which

the display unit of the virtual-image optical system includes a lens array unit in which the lenses are arranged in units of a plurality of adjacent pixels including a left-eye pixel and a right-eye pixel,

the signal processing unit generates virtual-image information items with respect to the left-eye pixel and the right-eye pixel, respectively, such that the virtual image is presented with the aspect ratio different from the aspect ratio of the display surface of the display unit on the basis of the result of the detection by the detection unit, and

a drive control unit drives the left-eye pixel and the right-eye pixel on the basis of the virtual-image information items generated by the signal processing unit.

[B05] The display apparatus according to any of Items [B01] to [B03], in which

the virtual-image optical system includes a lens array unit in which the lenses that emit light beams respectively from the plurality of pixels as substantially parallel light beams are each arranged correspondingly and in proximity to corresponding one of display regions each including ones of the plurality of pixels of the display unit, the lenses each emitting light beams of images from the ones of the plurality of pixels in the corresponding one of the display regions,

the lenses of the lens array unit each emit, as the substantially parallel light beams in a direction corresponding to a position within the corresponding one of the display regions, the light beams of the images from the ones of the plurality of pixels in the corresponding one of the display regions such that the light beams are focused on a retina of the observer, and visually recognized as one virtual image by the observer.

[B06] The display apparatus according to any of Items [B01] to [B05], in which

the signal processing unit calculates a viewing distance from the observer to the display unit on the basis of a distance between a left eye and a right eye of the observer in an image taken by the imaging unit, and calculates a virtual image distance to a virtual-image presentation position suited to an eyesight of the observer on the basis of the calculated viewing distance.

[B07] The display apparatus according to Item [B06], in which

the display control unit adjusts the virtual-image presentation position in accordance with the virtual image distance calculated by the signal processing unit.

[B08] The display apparatus according to Item [B06], in which

the signal processing unit presents the calculated virtual image distance to the observer, and

the observer adjusts, in accordance with the presented virtual image distance, the virtual-image presentation position via the display control unit.

### REFERENCE SIGNS LIST

1A display apparatus according to first embodiment
1B display apparatus according to second embodiment
10, 10A, 10B, 10C display unit
11 pixel
11R, 11G, 11B sub-pixel
12 virtual image lens
13L left-eye pixel
13R right-eye pixel
14 diffusion layer
15 virtual image
16L left-eye screen
16R right-eye screen
17 display element
18 lens array unit
19 coverslip
20 imaging unit
30 distance measurement unit
40 signal processing unit
50 display control unit
60 input unit
70 eye of observer
70L left eye
70R right eye
80 retina
91 aperture
92 spacer
93 light blocking layer
94 separator
95 transparent pad
96 diffraction grating
97 die
98 liquid-crystal layer
99 electrochromic element
100 wristwatch-type terminal
200 mobile terminal
300 camera apparatus

1. A display apparatus, comprising:
a display unit in which apertures are arranged in units of a plurality of adjacent pixels including a left-eye pixel and a right-eye pixel;
a signal processing unit that generates image information items with respect to the left-eye pixel and the right-eye pixel, respectively, such that an image is presented with an aspect ratio different from an aspect ratio of a display surface of the display unit; and
a display control unit that drives the left-eye pixel and the right-eye pixel on a basis of the image information items generated by the signal processing unit.

2. The display apparatus according to claim 1, wherein
a dimension of each of the apertures is equivalent to or smaller than a dimension of each of the pixels.

3. The display apparatus according to claim 1, wherein
the display unit includes a spacer between the apertures and the pixels.

4. The display apparatus according to claim 1, wherein
the display unit includes a diffusion layer between the apertures and the pixels.

5. The display apparatus according to claim 4, wherein
the display unit includes separators provided in pixel units in the diffusion layer.

6. The display apparatus according to claim 5, wherein
the separators are made of a material that absorbs visible light.

7. The display apparatus according to claim 5, wherein
an interface between the separators and the diffusion layer is formed of an interface that reflects visible light.

8. The display apparatus according to claim 5, wherein
the diffusion layer is partitioned into separate parts by the separators, and pixel-side surfaces thereof are larger than aperture-side surfaces thereof.

9. The display apparatus according to claim 1, wherein
the display unit includes a transparent pad on a layer in which the apertures are provided.

10. The display apparatus according to claim 4, wherein,
the display unit includes a diffraction grating between the pixels and the diffusion layer.

11. The display apparatus according to claim 1, wherein
the display unit includes a liquid-crystal layer that adjusts an intensity of light to be transmitted through the apertures.

12. The display apparatus according to claim 1, wherein
the display unit is capable of selectively forming the apertures with use of an element that is capable of controlling an intensity of light to be transmitted therethrough, and
the display unit
presents, when forming the apertures, an image with the aspect ratio different from the aspect ratio of the display surface of the display unit, and
presents, when not forming the apertures, an image with an aspect ratio equal to the aspect ratio of the display surface of the display unit.

13. The display apparatus according to claim 1, wherein
the display unit includes lenses arranged in the units of the plurality of adjacent pixels including the left-eye pixel and the right-eye pixel, and
the signal processing unit generates image information items with respect to the left-eye pixel and the right-eye pixel, respectively, such that a virtual image is presented with the aspect ratio different from the aspect ratio of the display surface of the display unit.

14. The display apparatus according to claim 13, further comprising
a detection unit that detects positional information and orientation information of eyes of an observer with respect to the display surface of the display unit, wherein
the signal processing unit generates the image information items with respect to the left-eye pixel and the right-eye pixel, respectively, on a basis of a result of the detection by the detection unit.

15. The display apparatus according to claim 14, wherein
the detection unit includes an imaging unit that captures an observer, and
the signal processing unit
constitutes the detection unit with the imaging unit, and
calculates the positional information and the orientation information of the eyes of the observer with respect to the display surface of the display unit on a basis of an image of the observer captured by the imaging unit.

16. The display apparatus according to claim 15, wherein
the detection unit includes a distance measurement unit that measures a distance between the display surface of the display unit and the eyes of the observer, and
the signal processing unit uses a result of the measurement by the distance measurement unit in the calculation of the positional information of the eyes of the observer with respect to the display surface of the display unit.

17. The display apparatus according to claim 13, wherein
the lenses arranged in the units of the plurality of pixels are fixed focus lenses with a fixed focal length.

18. The display apparatus according to claim 13, wherein
the lenses arranged in the units of the plurality of pixels are variable focus lenses with variable focal lengths, and
the display control unit controls the variable focal lengths of the variable focus lenses.

19. A method of driving a display apparatus, the display apparatus including a display unit in which apertures are arranged in units of a plurality of adjacent pixels including a left-eye pixel and a right-eye pixel, the method comprising:
generating image information items with respect to the left-eye pixel and the right-eye pixel, respectively, such that an image is presented with an aspect ratio different from an aspect ratio of a display surface of the display unit; and
driving the left-eye pixel and the right-eye pixel on a basis of the generated image information items.

20. An electronic apparatus, comprising
a display apparatus including
a display unit in which apertures are arranged in units of a plurality of adjacent pixels including a left-eye pixel and a right-eye pixel,
a signal processing unit that generates image information items with respect to the left-eye pixel and the right-eye pixel, respectively, such that an image is presented with an aspect ratio different from an aspect ratio of a display surface of the display unit, and
a display control unit that drives the left-eye pixel and the right-eye pixel on a basis of the image information items generated by the signal processing unit.
